(19) United States
(12) Patent Application Publication
(10) Pub. No.: US 2022/0242386 A1
(43) Pub. Date: Aug. 4, 2022

(54) Device to Increase Fuel Economy

(71) Applicant: Voyomotive, LLC, San Francisco, CA (US)

(72) Inventors: Peter Yorke, San Francisco, CA (US); George Maltezos, San Francisco, CA (US); Robert Vogt, VI, Ann Arbor, MI (US); Adam Sloan, Ann Arbor, MI (US)

(21) Appl. No.: 17/722,433

(22) Filed: Apr. 18, 2022

Related U.S. Application Data
(63) Continuation of application No. 13/713,634, filed on Dec. 13, 2012, now abandoned.
(60) Provisional application No. 61/576,003, filed on Dec. 15, 2011.
(60) Provisional application No. 61/645,204, filed on May 10, 2012.

(51) Int. Cl. B60W 10/06; B60W 10/115; B60W 30/18

(52) U.S. Cl. CPC B60W 10/06; B60W 10/115; B60W 2540/21; B60W 2540/12; B60W 2520/04; B60W 30/18018

(57) ABSTRACT

This invention provides a device for increasing fuel economy which allows manual or automatic shutoff of an automobile engine under a first set of circumstances and restarting the engine under a second set of circumstances as well as control of the gear ratio selected by an automatic transmission and the rate of fuel delivery to the engine.

### CROSS REFERENCE TO RELATED APPLICATIONS

This application is a continuation of utility application Ser. No. 13/713,634 and asserts priority from provisional application 61/576,003, filed on Dec. 15, 2011, and provisional application 61/645,204, filed May 10, 2012, both of which are incorporated herein by reference.

### FIELD OF INVENTION

The invention relates to a system for increasing fuel economy in a motor vehicle. The system gathers information on the vehicle operating parameters, relays information to the device and transmits commands from the device back to the vehicle. The device uses a computer program to process the information it receives from the communicator. The communicator can send commands to and receive data from additional components added to the system, and can optionally receive information from external sources by using its own wireless communications chipset or by tethering to communications equipment such as a Smartphone. The system, the device can control the shut-off and restart of the engine, control the gear settings of an automatic transmission and control fuel delivery to the engine.

### BACKGROUND OF THE INVENTION

US Patent Publication 2012/0010797 provides a system for controlling an engine of a vehicle. In one embodiment, the system includes at least one monitoring device mounted on the vehicle, a controller in electronic communication with the at least one monitoring device, and a computer with readable memory storing instructions executed by the controller. The instructions cause the controller to determine a current driving path of the vehicle based on data received from the at least one monitoring device, to detect a traffic congestion ahead of the vehicle in the current driving path based on data received from the at least one monitoring device, and to determine an alternative driving path of the vehicle based on data received from the at least one monitoring device. The instructions further cause the controller to calculate, using a first statistical model, a first probability that the traffic congestion will not move within a defined time period, and to stop the engine before the vehicle comes to a full stop when the first probability is greater than a first threshold.

US Patent Publication 2011/0307155 relates to a method for limiting a dynamic parameter of a vehicle, such as speed or acceleration, and to a vehicle dynamics control module (VDCM), an engine control module (ECM) and a system for carrying out the method as well as to a computer product associated thereto. The present invention allows a driver of a vehicle to be provided with an acceptable acceleration, speed and/or the like, which may be lower than the requested acceleration, speed, etc., in order to optimize energy consumption of the vehicle, typically for transportation vehicles such as trucks, buses and delivery vans. This is accomplished, by a continuously running controller, such as a PI controller and by limiting the integral term of the PI controller, to smoothen transitions when the dynamic parameter is limited and to substantially reduce overshoot with respect to the limit of the dynamic parameter.

US Patent Publication 2011/0288743 provides a system, apparatus and method for an overall power management system for powering one or more power consuming devices used in vehicles and assisting with the management of auxiliary energy storage, while ensuring that the starter battery remains charged for engine starting. The present invention may be an integrated system, and related apparatus, for managing a plurality of on-board power consuming devices and power sources. The present invention may be utilized to reduce the need for engine idling to maintain power to one or more power consuming devices. The present invention may include: a monitoring device to monitor the power consumption of one or more power consuming devices and/or the charge of one or more auxiliary energy storage devices and a starter battery; and a control device to ensure that the power consuming devices are powered while a vehicle is in a stationary position.

US Patent Publication 2011/0238284 provides a process and a corresponding system for automatically turning off and starting an internal-combustion engine in a motor vehicle via a start-stop device, which automatically turns off the internal-combustion engine if the vehicle is braked to a stop and is held in the stopped position by the operation of the brake pedal, and which, if the internal-combustion engine is automatically turned off and the operated brake pedal is released, automatically starts the internal-combustion engine. If the internal-combustion engine is automatically turned off, an automatic starting of the internal-combustion engine by releasing the brake is prevented if the brake pedal was increasingly depressed beforehand while the internal-combustion engine was turned off.

US Patent Publication 2011/0106413 provides an idling control apparatus for a vehicle includes an engine control unit for determining an idling state of the vehicle, in which the vehicle is stopped while an engine is in a turned-on state, to control the engine of the vehicle based on information of a traffic signal. The engine control unit maintains the turned-on state of the engine or turns off the engine depending on a residual time of the traffic signal when it is determined that the vehicle is in the idling state. Further, the engine control unit turns off the engine of the vehicle when a stop time of the vehicle is longer than a predetermined idling time limit, wherein the stop time is calculated by subtracting from a point in current time by a point in time at which it is determined that the vehicle is in the idling state.

US Patent Publication 2011/0054765 relates to various systems and methods for controlling an engine in a vehicle, the engine being coupled to a transmission. One example method comprises, under selected braking conditions, shutting-off the engine and spinning-down the engine to rest while the vehicle is traveling, and in response to a foot-off-brake event, restarting the engine by at least partially engaging the transmission to assist in spinning-up of the engine from rest while the vehicle is traveling.

US Patent Publication 2010/0145562 provides a start-stop or idle-stop method for a heavy-duty hybrid vehicle that turns off the fuel supply while maintaining the crankshaft rotation of the internal combustion engine when the vehicle stops or, optionally, when the vehicle travels downhill, travels in a noise sensitive location, travels in an exhaust emissions sensitive location, or operates in an emergency situation. The start-stop or idle-stop method automatically turns on the engine fuel supply to restart combustion when the vehicle starts accelerating, is no longer traveling downhill, is no longer traveling in a noise sensitive or exhaust sensitive location, is no longer in an emergency situation, or has dropped below the minimum energy storage restart level. The start-stop or idle-stop may be inhibited upon certain override conditions.

US Patent Publication 2010/0131152 provides systems, control methods and related apparatus for engine idling reduction, to decrease operating cost and pollution related to the use of an automotive vehicle, while increasing its autonomy. Integrated are an automatic start-stop device, an increased onboard energy capacity, an electric pump that circulates engine coolant to the heater radiator to extract engine thermal inertia for cabin heating and an engine electric cooling system. The system is designed to reduce fuel consumption and air pollution while maintaining auxiliary systems in function and the cabin temperature at an acceptable level when the engine is stopped. This system may be integrated aboard internal combustion engine vehicles that have important idling periods in normal conditions. Such systems can either be implemented as retrofit kits or during a vehicle's manufacturing, directly by the original equipment manufacturer (OEM).

US Patent Publication 2009/0018719 provides an idle control system for a vehicle.

US Patent Publication 2009/0015203 provides a battery charge maintenance system for a vehicle.

U.S. Pat. No. 8,078,339 B2 provides removable circuits and related mounting hardware for removably connecting circuits to a vehicle's control system. Circuits and connectors form an addressable assembly which may be enclosed in a flowable material.

U.S. Pat. No. 7,689,330 Method of Controlling Engine Start-Stop Operation for Heavy-Duty Hybrid-Electric and Hybrid-Hydraulic Vehicles turns off the internal combustion engine when the vehicle stops or, optionally, when the vehicle travels downhill.

U.S. Pat. No. 7,689,331 B2 provides a start-stop or idle-stop method for a heavy-duty hybrid vehicle that turns off the fuel supply while maintaining the crankshaft rotation of the internal combustion engine when the vehicle stops or, optionally, when the vehicle travels downhill, travels in a noise sensitive location, travels in an exhaust emissions sensitive location, or operates in an emergency situation. The start-stop or idle-stop method automatically turns on the engine fuel supply to restart combustion when the vehicle starts accelerating, is no longer traveling downhill, is no longer traveling in a noise sensitive or exhaust sensitive location, is no longer in an emergency situation, or has dropped below the minimum energy storage restart level.

U.S. Pat. No. 7,689,330 relates to a start-stop method for a heavy-duty hybrid vehicle that turns off the internal combustion engine when the vehicle stops or, optionally, when the vehicle travels downhill. The start-stop method automatically restarts the internal combustion engine when the vehicle starts accelerating or is no longer traveling downhill. The software instructions for the start-stop method reside within the programming of the hybrid vehicle control computer as a subset of the hybrid vehicle control strategy in hybrid-electric or hybrid-hydraulic heavy-duty vehicle. During the time the internal combustion engine is turned off the necessary vehicle accessories operate from the available power of the hybrid high power energy storage.

U.S. Pat. No. 7,680,568 B2 provides a start-stop or idle-stop method for a heavy-duty hybrid vehicle that turns off the fuel supply while maintaining the crankshaft rotation of the internal combustion engine when the vehicle stops or, optionally, when the vehicle travels downhill, travels in a noise sensitive location, travels in an exhaust emissions sensitive location, or operates in an emergency situation. The start-stop or idle-stop method automatically turns on the engine fuel supply to restart combustion when the vehicle starts accelerating, is no longer traveling downhill, is no longer traveling in a noise sensitive or exhaust sensitive location, is no longer in an emergency situation, or has dropped below the minimum energy storage restart level.

U.S. Pat. No. 7,657,351 relates to a start-stop or idle-stop method for a heavy-duty hybrid vehicle that turns off the fuel supply while maintaining the crankshaft rotation of the internal combustion engine when the vehicle stops or, optionally, when the vehicle travels downhill, travels in a noise sensitive location, travels in an exhaust emissions sensitive location, or operates in an emergency situation. The start-stop or idle-stop method automatically turns on the engine fuel supply to restart combustion when the vehicle starts accelerating, is no longer traveling downhill, is no longer traveling in a noise sensitive or exhaust sensitive location, is no longer in an emergency situation, or has dropped below the minimum energy storage restart level.

U.S. Pat. No. 7,657,350 relates to a start-stop method for a heavy-duty hybrid vehicle that turns off the internal combustion engine when the vehicle stops or, optionally, when the vehicle travels downhill. The start-stop method automatically restarts the internal combustion engine when the vehicle starts accelerating or is no longer traveling downhill. The software instructions for the start-stop method reside within the programming of the hybrid vehicle control computer as a subset of the hybrid vehicle control strategy in hybrid-electric or hybrid-hydraulic heavy-duty vehicle. During the time the internal combustion engine is turned off the necessary vehicle accessories operate from the available power of the hybrid high power energy storage.

U.S. Pat. No. 7,603,228 discloses an apparatus that includes a haptic actuator operatively associated with a pedal assembly of the vehicle, a human-machine interface (HMI) for enabling the driver to select between a plurality of fuel savings settings, and a controller coupled to a data interface in the vehicle and the HMI for causing the haptic actuator to provide feedback to the driver when an aspect of vehicle operation crosses at least one of a plurality of speed and acceleration thresholds responsive to the HMI setting. Additionally, a coaching method provides haptic-based feedback that will not interfere with the operation of the vehicle. This method of closed-loop feedback provides a timely signal to the driver in a way that will encourage a change in driver style over time, such as backing off the accelerator pedal to accelerate at a lower rate and braking earlier with less intensity. As not all driver preferences are the same under all conditions, the HMI selector will help coach the driver by providing feedback that best fits their driving preference at the particular time.

U.S. Pat. No. 7,558,666 relates to an idle-stop controller which connects to a vehicle computer so as to implement an idle-stop on request of the driver from a signal derived from a foot brake, a parking brake, or a voice-activated switch. It also implements an engine restart on request of the driver, and this can be done in several ways.

U.S. Pat. No. 6,947,827 relates to an engine idle-stop control system in which a vehicles engine is stopped according to conditions when a vehicle has stopped, and the engine is started by starting a motor/generator when a request to restart the engine which has stopped, is determined. Engine torque is absorbed by the motor/generator so that the starting torque according to an accelerator pedal depression after restart, is effectively the same torque for starting from the engine stop state as for starting from the engine idle state. In this way, the same starting performance is obtained when the vehicle starts from the engine stop state as when the vehicle starts from the engine idle rotation state.

U.S. Pat. No. 6,881,170 relates to a vehicle with an automatic engine stop/restart function which comprises an engine, an automatic transmission having an oil pump driven in synchronism with the engine to supply an oil pressure to the automatic transmission, an oil pressure controller to hold the oil pressure in the automatic transmission during an automatic stop of the engine, and a control system. The control system is configured to: determine whether the oil pressure in the automatic transmission becomes lower than a predetermined value during the engine automatic stop; shift the automatic transmission into a neutral state when the oil pressure in the automatic transmission becomes lower than a predetermined value during the engine automatic stop; restarts the engine; and then, shift the automatic transmission into a drive state after the oil pressure in the automatic transmission is increased to the predetermined value by the oil pump driven in synchronism with the engine.

U.S. Pat. No. 6,802,291 relates to an automatic engine stop and restart system for a vehicle which comprises a controller for controlling an automatic stop and restart of an engine in accordance with a driving condition of the vehicle. The controller includes a control section for automatically restarting the engine when an engine speed is lowered so as to be equal to or lower than a predetermined engine speed under a condition that a vehicle main switch is ON and predetermined automatic engine stop conditions are not satisfied, and a control section for inhibiting an automatic restart of the engine before a first manual engine start after the vehicle main switch has been ON is completed. A method for controlling automatic engine stop and restart in accordance with a driving condition of a vehicle is also provided.

U.S. Pat. No. 6,763,903 provides a controlling device in which the automatic stop and start-up conditions for an internal combustion engine are set to enable automatic stop/start-up control reflecting an operator's will or intention without movement of the vehicle feeling incongruous or unresponsive. The controlling device provides an automatic stop condition when all of the following conditions are satisfied (1) vehicle speed is less than a set value other than zero, (2) an idle switch is on, and (3) a gear position of the transmission is in neutral. An automatic start-up condition is satisfied when any one of the following conditions is satisfied, (1) the clutch is changed to a disengaged state from a fully or half engaged state, (2) the gear position of the transmission is in non-neutral, (3) the idle switch is off, or (4) a condition of booster negative pressure.

U.S. Pat. No. 6,535,811 provides a method and system for controlling an engine. The method and system accomplish engine control based on one or more defined relationships. The present invention permits a user to adjust the defined relationships that are used to control the engine. Those adjustments are rewritten to the controller in real-time without interrupting the control operation.

U.S. Pat. No. 6,404,072 relates to a vehicle provided with a device to automatically stops and restarts an engine, when a brake pedal depression amount decreases in a state where the engine has temporarily stopped, the engine is restarted to alert the driver. The brake pedal depression amount in this case is set to a level such that a braking force exceeds a creep force. This restarting of the engine encourages the driver to step on the brake pedal, and reinforces braking force. As a result, when the engine is restarted after temporarily stopping due to a command from a control unit regardless of the driver's intention, such as when the battery is being charged, there is less release of the brake pedal. In this way, moving-off of the vehicle regardless of the driver's intention can be prevented. When automatic stop conditions are satisfied, the engine stops, and when start conditions are satisfied, an induction motor for starting the vehicle is started to restart the engine. If the brake pedal depression amount decreases even slightly during temporary stop of the engine, when the brake is released, the engine is restarted. Due to the generation of a creep force, the driver is requested to step on the brake pedal again. As a result, when the engine restarts, for example in order to charge the battery, after temporarily stopping due to a command from the controller unrelated to the driver's intention, the vehicle can be prevented from moving off.

U.S. Pat. No. 6,093,974 relates to a control device for restarting an engine which engages a forward clutch of an automatic transmission quickly, with little shock and without involving a special cost for restarting the engine. When the engine is restarted, a way for supplying an oil is changed in accordance with a leaving amount of an oil from an oil passage with respect to the forward clutch of the automatic transmission or an oil temperature. A time for executing a quick pressure increase control and a control target pressure is changed in accordance with a leaving amount of the oil or the oil temperature. Further, the quick pressure increase control is started at a timing when an engine revolution (a rotational speed of an oil pump) is equal to or greater than a predetermined value.

U.S. Pat. No. 4,494,497 relates to an automatic engine stop-restart system which stops or restarts an engine on a basis of detecting an operational state of each component of a vehicle with the engine mounted thereon, judging as to whether first condition of setting the function of allowing the engine to automatically stop and restart, a second condition of automatically stopping the engine after the function is set and a third condition of automatically restarting the engine after the function is set are fulfilled or not. The judgment is made by “and” of a plurality of signals including at least two or more signals out of a signal indicating an engine rotational speed, a signal indicating the generating condition of an alternator and a third signal indicating readiness or unreadiness for starting of the vehicle.

U.S. Pat. No. 4,454,843 relates to an automatic engine stop and start system which determines whether the conditions for automatically stopping an engine is exists based on outputs from pluralities of sensors and switches for detecting the operating conditions of various portions of a vehicle. Even if the result of determination satisfies the conditions of automatic stop, automatic stop is not effected when the temperature of the engine cooling water exceeds predetermined temperature limits.

U.S. Pat. No. 4,453,506 relates to an automatic engine stop and start system wherein the operating conditions of various portions of a vehicle are detected and an engine is automatically stopped and started in accordance with the operating conditions thus detected, a fuel supply system is cut to prevent the run-on of the engine in addition to the cut-off of current passage to an ignition system as in the prior art. These controls are effected when any one or more of predetermined operating conditions and any one or more of conditions of precluding the automatic stop are present.

U.S. Pat. No. 4,381,042 relates to an excessive idle termination system for use in shutting down a motor vehicle engine upon elapse of selected sensed input conditions, comprises an electronic digital counter which begins counting in response to the occurrence of any of the selected input conditions. Logic gates and warning devices are also associated with the counter circuit.

When a predetermined count is reached, it is considered indicative of excessive idle, and consequently the ignition circuit is automatically interrupted to thereby shutdown the engine and conserve fuel. Prior to the actual engine shutdown the warning devices may give a pre-warning of impending shutdown.

U.S. Pat. No. 4,364,343 relates to an automatic vehicle engine stop-restart system responsive to throttle position in which the engine is shutdown by disabling the fuel supply in response to a closed throttle and restarted in response to an open throttle. During shutdown, the intake manifold is primed with an air and fuel mixture just prior to the stopping of the engine to provide an immediate restart capability.

U.S. Pat. No. 4,286,683 relates to a stop/start control system for an engine for automatically controlling the shutdown and restarting of a vehicle engine in order to conserve fuel at times when the vehicle would be otherwise stopped, with the engine running at idle speed and including in combination, an accumulator for computing and displaying the amount of fuel saved during shutdown. A central control comprised of an auto shutdown logic section and an auto start time delay logic section is connected to signal producing components on the vehicle and its engine and provides outputs to control engine shutdown and restart. The accumulating device utilizes an idle fuel flow reference with a clock input to compute the amount of fuel saved, which is indicated on the attached display. The logic functions of the accumulator are accomplished by a programmed microprocessor.

U.S. Pat. No. 4,192,279 relates to a method and apparatus for automatic engine shut-off and restart in a motor vehicle in conditions of standstill or near-standstill, for example when the motor reaches speeds at or below the stalling speed with an engaged drive line. In stop-and-go driving, the invention includes monitoring the vehicle speed, the motor speed and the state of actuation of the accelerator pedal and the clutch pedal. If a set of conditions is met, for example that the vehicle speed is below 3 kilometers per hour, and that neither the accelerator pedal nor the clutch pedal are depressed, and the engine temperature is sufficiently high, the apparatus of the invention automatically arrests the engine either by fuel shut-off or by ignition shut-off or both. A depression of the clutch pedal restarts the engine. The invention further provides for automatic fuel shut-off to the motor under the conditions of engine braking, i.e., operation with closed throttle and relatively high motor speed.

U.S. Pat. No. 4,022,164 relates to an electric idle for internal combustion engine in which an internal combustion engine is controlled by a throttle valve which can close completely to prevent fuel flow to the engine. There is no idle jet below the throttle valve. When the engine is at idle speed, the starter motor is energized to maintain engine rotation so that no fuel is consumed during engine idling.

U.S. Pat. No. 2,580,080 relates to a device for automatically stopping automobile engines after a predetermined idling period, and is particularly intended for use with an internal combustion or other type of engine having a pressure oil lubricating system, it being an object of the invention to utilize the oil pressure of the lubricating system in the automatic operation of the device.

### SUMMARY OF THE INVENTION

The invention provides for a system for increasing fuel economy in a motor vehicle. The system has three components: a communicator, a logic device (device) and a computer program. The communicator gathers information on the vehicle operating parameters which it relays to the device and transmits commands from the device back to the vehicle. The communicator is preferably attached to and exchanges information over the vehicle's computer port; however, it also communicates with other aftermarket systems that may not report data over the vehicle computer port. Further the communicator can send commands to and receive data from additional components added to the system, such as an Actuator Board or pressure accumulator. The communicator can optionally receive information from external sources by using its own wireless communications chip set or by tethering to communications equipment such as a smart phone. External data may originate from one or a combination of sources such as from other vehicles and/or from a data center. The second component is a logic device (or “the device”) that receives vehicle and other forms of information from the communicator. The device component can be attached or external to the vehicle. The third component is a computer program embodying a set of algorithms which runs on the device component, determines if the operation of the motor vehicle should be altered, and issues commands to the motor vehicle. Device commands are forwarded to the communicator, which transmits them to the vehicle using the vehicle computer port (or other appropriate connection). By working in combination, the three components of the system can control the shut-off and restart of the engine, control the gear settings of an automatic transmission and control fuel delivery to the engine.

### BRIEF DESCRIPTION OF THE DRAWINGS

FIG. 1 shows a block diagram of system hardware for start-stop and coast in a vehicle.

FIG. 2 shows a block diagram of system hardware using auxiliary electronics and optional auxiliary hardware.

FIG. 3 shows a block diagram of a switch.

FIG. 4a shows a block diagram of the system electronics.

FIG. 4b shows a block diagram of the Actuator Board electronics.

FIG. 4c shows a block diagram of the system electronics with the communicator and the device running on separate components.

FIG. 5a shows a block diagram of a routine to stop and restart an engine of a vehicle with an automatic transmission.

FIG. 5b shows a block diagram of a routine to stop and restart an engine of a vehicle with a manual transmission.

FIG. 6a shows a block diagram of a device using a routine to shut-off and restart an engine while the transmission shift lever remains in gear for a vehicle with an automatic transmission.

FIG. 6b shows a block diagram of a system using a routine to shut-off and restart an engine for a vehicle with a manual transmission.

FIG. 7a shows a block diagram of a system with a routine using the Actuator Board to shut-off and restart an engine while the transmission shift lever remains in gear for a vehicle with an automatic transmission.

FIG. 7b shows a block diagram of a system with a routine using the Actuator Board to shut-off and restart an engine for a vehicle with a manual transmission.

FIG. 8 shows a block diagram of a system engine restart routine.

FIG. 9 shows a block diagram of system engine restart subroutines.

FIG. 10 shows a block diagram of system engine restart subroutines.

FIG. 11 shows the block diagram of a routine the system uses to determine when the engine should be turned on or not turned off during coasting with an automatic transmission vehicle.

FIG. 12 shows the block diagram of a routine the system uses to determine when the engine should be turned on or not turned off during coasting with a manual transmission vehicle.

FIG. 13 shows the block diagram of an emergency Actuator Board restart.

FIG. 14 shows a block diagram of a system that checks the vehicle identification number and vehicle systems to confirm the system and the vehicle are compatible and in proper working order.

FIG. 15 shows a block diagram of a system for starting and stopping the internal combustion engine of a vehicle having an automatic transmission.

FIG. 16 shows a block diagram of a system for starting and stopping the internal combustion engine of a vehicle having an automatic transmission, which includes the option of issuing a pre-command.

FIG. 17 shows a block diagram of a system for starting and stopping a vehicle with a manual transmission.

FIG. 18 shows a block diagram of a system for starting and stopping a vehicle with a manual transmission, which includes the option of issuing a pre-command.

FIG. 19 shows a block diagram of a system that provides start and stop for a vehicle with an Automatic Engine Turn On and Shut-Off (AETSO) of the engine without driver input.

FIG. 20 shows a block diagram of a system that provides Automatic Engine Turn On and Shut-Off (AETSO) of the engine with driver input (Standby Mode A).

FIG. 21 shows a block diagram of a system that provides Automatic Engine Turn On and Shut-Off (AETSO) of the engine with driver input (Standby Mode B).

FIG. 22 shows a block diagram of a system that provides Automatic Engine Turn On and Shut-Off (AETSO) having Standby Mode B and a timer feature.

FIG. 23 shows a block diagram of a system using Automatic Engine Turn On and Shut-Off (AETSO) application module with a manual transmission.

FIG. 24 shows a block diagram of a system using a combination of coasting and automated engine turn on and shut-off application modules with next stop pre-command.

FIG. 25 shows a block diagram of a system for allowing a vehicle with an automatic transmission to coast under driver command.

FIG. 26 shows a block diagram of a system for allowing a vehicle with an automatic transmission to coast controlled with vehicle systems.

FIG. 27 shows a block diagram of a system for allowing a vehicle with an automatic transmission to coast as directed by the device.

FIG. 28 shows a block diagram of a system for allowing a vehicle with a manual transmission to coast under driver command.

FIG. 29 shows a block diagram of a system for allowing a vehicle with a manual transmission to coast controlled with vehicle systems.

FIG. 30 shows a block diagram of a system for allowing a vehicle with a manual transmission to coast as directed by the device.

FIG. 31 shows a block diagram of a system using a combination of the coast application modules with automatic Automatic Engine Turn On and Shut-Off (AETSO).

FIG. 32 shows a block diagram of a system using a combination of Coast and Stop Start Modes.

FIG. 33 shows a block diagram of a system that stops fuel use by the engine when the clutch is disengaged and can use the clutch as an input to command engine shut-off.

FIG. 34 shows a block diagram of an anti-idle system for an automatic transmission.

FIG. 35 shows a block diagram of an anti-idle system for a manual transmission.

FIG. 36 shows a block diagram of a device that uses vehicle location, mapping data and operating data to determine a vehicle's speed according to preference settings set by the driver.

FIG. 37 shows a block diagram of a transmission gear selection method in a vehicle having an automatic transmission.

FIG. 38 shows a block diagram of a transmission gear selection method using Transmission Control Mode A.

FIG. 39 shows a block diagram of a Transmission Control Mode using optional torque converter lock up.

FIG. 40 shows a block diagram of a system having a Transmission Control Mode B.

FIG. 41 shows a block diagram of a system having a Transmission Control Mode C.

FIG. 42 shows a block diagram of a system using the Accelerator Off Fuel Reduction (AOFR) application modules with deceleration fuel shut-off features.

FIG. 43 shows a block diagram of a system having accelerator override of the Transmission Control application module.

FIG. 44 shows a block diagram of a system that allows manual override of the Transmission Control application module.

FIG. 45 shows a block diagram of a system that allows manual override of the Transmission Control application modules.

FIG. 46 shows a block diagram of a system using a combination of Transmission Control Modes A and C.

FIG. 47 shows a block diagram of a System Accelerator Control Routine.

FIG. 48 shows a block diagram of a system to limit the use of fuel consumption of open-loop engine control.

FIG. 49 shows a block diagram of a Transmission and Accelerator Cruise Control Mode with coasting above a set speed.

FIG. 50 shows a block diagram of a system of the Transmission and Accelerator Cruise Control Mode with engine braking above a set speed.

FIG. 51 shows a block diagram of a Transmission and Accelerator Cruise Control Mode for pulse-and-glide driving.

FIG. 52 shows a block diagram of a Transmission and Accelerator Cruise Control Mode for engine off coast pulse-and-glide driving.

FIG. 53 shows a block diagram of a Transmission and Accelerator Off Fuel Reduction Cruise Control Mode.

FIG. 54 shows a block diagram of a system that allows pulse-and-glide driving with an automatic transmission.

FIG. 55 shows a block diagram of a system that allows pulse-and-glide-driving for a vehicle having a manual transmission.

FIG. 56 shows a block diagram of a transmission fluid pressure accumulator.

FIG. 57 shows a block diagram of an electric motor actuated transmission fluid pressure accumulator.

FIG. 58 shows a block diagram of an Accumulator Restart Routine (Part 1).

FIG. 59 shows a block diagram of an Accumulator Restart Routine (Part 2).

### DETAILED DESCRIPTION OF THE INVENTION

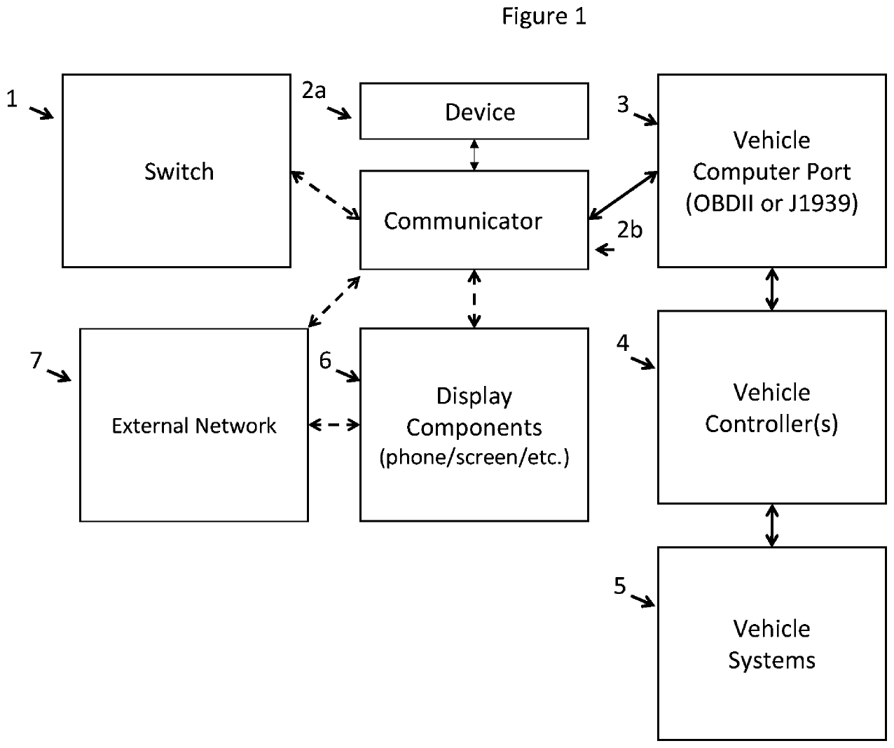

FIG. 1 illustrates a block diagram of a control system of a device for turning an engine on/off and controlling a vehicle's systems. The driver optionally inputs commands to a switch (1) that communicates with the communicator (2.b). The communicator obtains information from, and sends commands to, the vehicle computer port (3). The data retrieved over the computer port (3) by the communicator (2.b) is forwarded to the device (2.a). The device (2.a) runs the system software and uses vehicle data to issue commands to the communicator (2.b), which the communicator (2.b) forwards over the computer port (3). The computer port (3) is the data bus that allows vehicle information to be retrieved and to send commands to the vehicle controller(s) (4). The vehicle computer port (3) may be an OBDII port, a J1939 port or other connection method used to connect to the vehicle controller(s) (4) and vehicle systems (5). The vehicle controller(s) (4) connects to the communicator (5) through the vehicle computer port (10). The vehicle controller(s) (4) provides information on the vehicle systems (5) to the communicator (2.b) and forwards commands issued by the device (2.a) to the vehicle systems (5). Optionally, the device may provide an output to display components (6) such as a monitor, smart phone, smart pad, or laptop computer and receive inputs from these display components (6). The communicator (2.b) may connect to an external network (7) either by tethering to a wireless display component (6), using telecommunication circuitry included on the board of the communicator (2.b) or a vehicle system (5) that allows wireless communication.

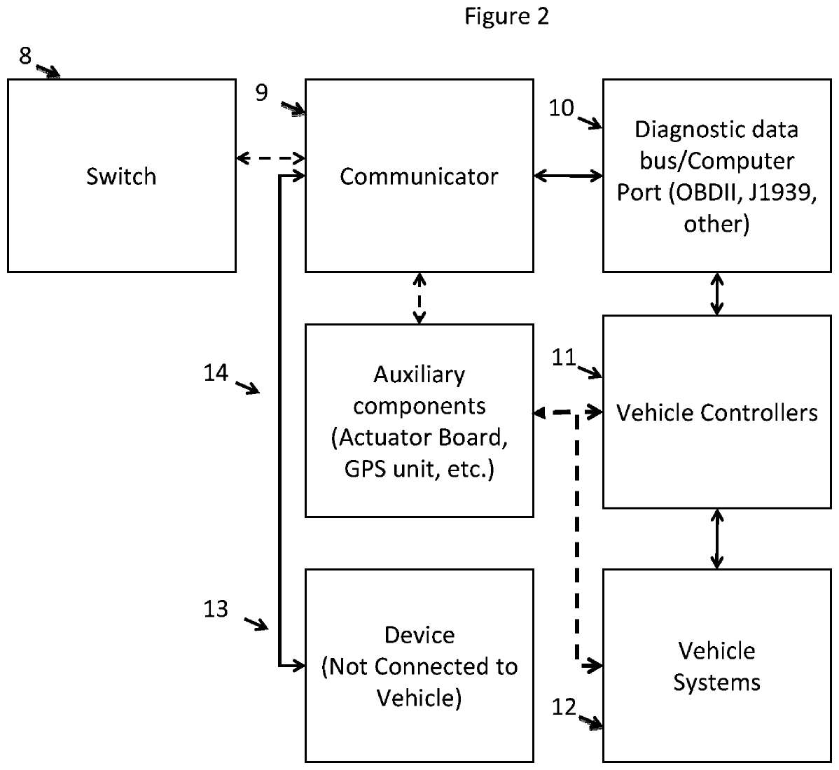

FIG. 2 illustrates a block diagram of the system using auxiliary components. The driver optionally provides input to, and receives alerts from a switch (8) that communicates with the communicator (9). The communicator (9) receives information from, and provides input to, the vehicle computer port (10). In this embodiment, the device (13) is not connected to the vehicle and wirelessly communicates with the communicator (9). The communicator (9) may also receive information from and send commands to optional auxiliary devices (14), if present. Examples of auxiliary devices (14) include a GPS unit or an Actuator Board. The vehicle computer port (10) transmits data to and from the vehicle controller (11). The communicator (9) communicates with optional auxiliary components (14) using a wireless or cable connection. The connection between the communicator (9) and auxiliary components (14) enables the device (13) to issue commands to vehicle systems (12) without having to rely on the vehicle controllers (11).

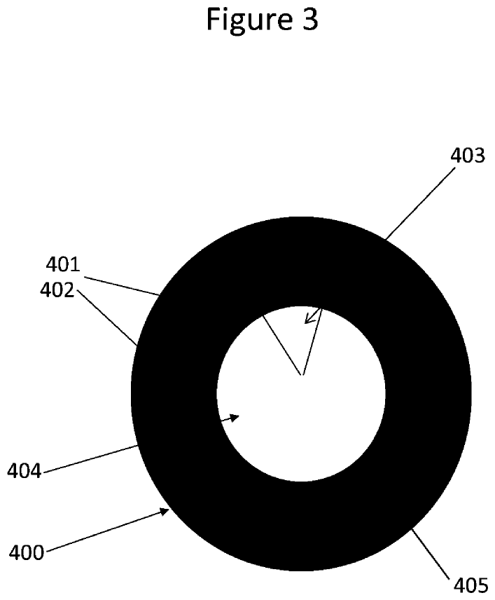

FIG. 3 illustrates a switch. The switch has a rotating dial (400). The various device application modules (401) (402) are displayed around the dial. At the center of the switch is a button (404) that the driver uses to input commands. The button has a select position marker (403) that allows a driver to select a given application. The dial is turned to the select position marker (403) and the driver presses the button (404) to turn an application on or off and select other features. The button (404) illuminates in different colors to update or alert the driver as to the device or vehicle status. Lights (not shown) illuminate each mode (401, 402) in different colors if the mode is on, off, or if there is an error in that mode. To use the applications while driving, the driver turns the dial (400) so that the “Drive” label (405) is at the select position marker (403).

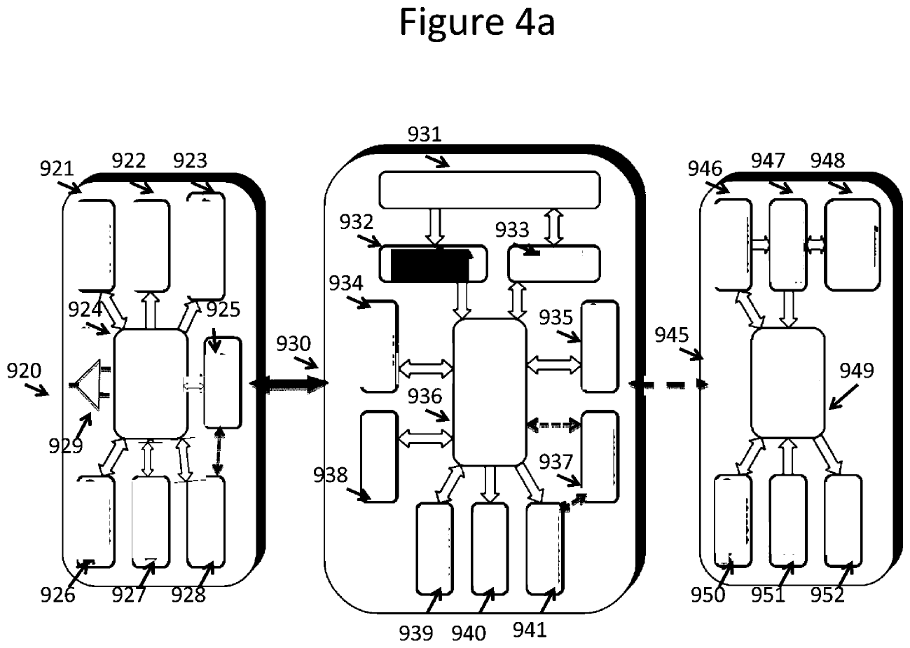

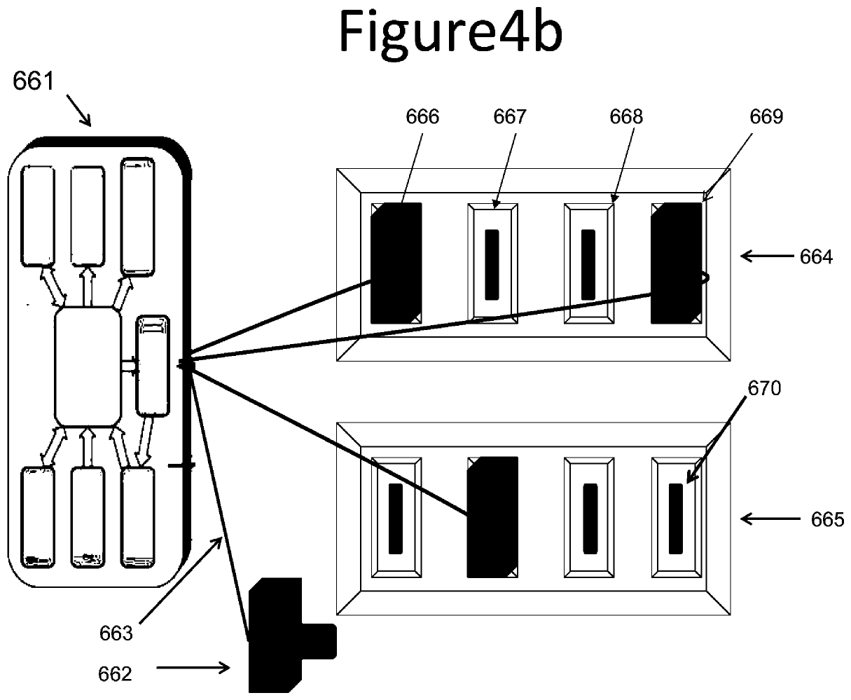

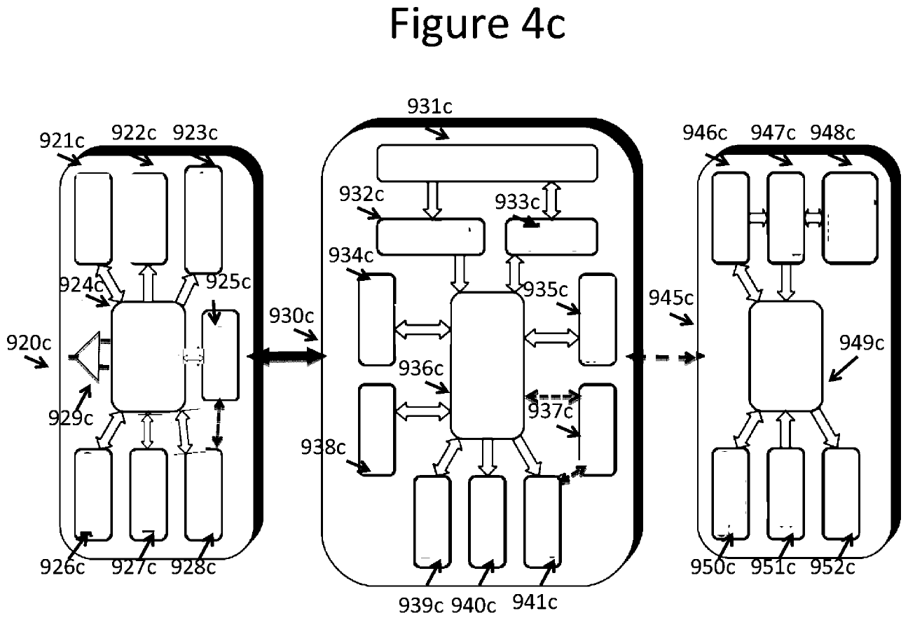

FIG. 4a shows a block diagram of the electronic components that can be used to execute the various functions of this invention. The components are: the Actuator Board (920), the device/communicator package (930) and an optional switch (945). In this embodiment, the same microprocessor (936) runs the software for the device and the communicator functions. The Actuator Board (920) is connected directly to the vehicle's circuitry preferably directly replacing existing relays or fuses and acting in their place. The Actuator Board (920) will perform all functions of the components they replace in addition to the additional features described here. The Actuator Board (920) receives commands from the microprocessor (936) running the device and communicator software. The communication between the microprocessor (936), in the device/communicator package (930), and the Actuary Board's (AB) microprocessor (924) in the Actuator Board (920) occurs via communications port (935) to the communications port (926) respectively. The Actuator Board (920) also sends and receives information to and from the microprocessor (936) running the communicator software. Information received by the Actuator Board (920) can be further processed by its own AB microprocessor (924) before sending data to the microprocessor (936) running the communicator software or before executing a command issued by the microprocessor (936) running the device software. The Actuator Board (920) may contain an input connection for programming, charging or data input/output (921). The Actuator Board (920) has a series of circuits (922, 923, 925, 927, 928) connected to various vehicle electronics that function under the control of the AB microprocessor (924), to directly send power or signals to vehicle components. The Actuator Board (920) can have components (925, 927, and 928) to create electronic signals and/or impedance loads to vehicle control circuits to mimic necessary control signals to circumvent normal vehicle operation. Using the microprocessor (936) running device software as a central processing unit and the communicator software as a communications hub, the Actuator Board (920) can communicate to a switch (945).

In FIG. 4a, the microprocessor (936), located in the device/communicator package (930), runs the device software and the communicator software. In running the communicator software, the microprocessor (936) manages communications with other components of the invention, the vehicle, auxiliary components and external networks. In running the device software, the microprocessor (936) analyzes data provided by the communicator function. The microprocessor (936) uses the communicator data to issue commands to control the system and by extension the vehicle through a port connector (931). The microprocessor (936) running the communicator software can make use of additional components located in the device/communicator package (930) such as a battery voltage sensor (932). The battery voltage sensor (932) communicates with the vehicle electronics via the port connector (931) connected to the vehicle computer port. The microprocessor (936) running the communication software communicates with the vehicle electronics via the vehicle's port connector (931) through a protocol interface (933). The device/communicator package (930) may contain an input connection for programming, charging or data input/output (939). The microprocessor (936) running communicator software may connect to circuitry (941) controlling auxiliary devices such as the transmission fluid pressure accumulator. The microprocessor (936) running the communicator software can output to the driver using a light, haptic output or sound device (940). The microprocessor (936) running the communicator software can connect to components included a USB or other computer connection (939) and make use of other optional expansion connectors (937), such as an accelerometer or temperature sensor, that add extra functionality to the system. Additionally the microprocessor (936) can interact with a temperature sensor (934) and use the information provided. Communication between the microprocessor (936) running the communicator software and the other system components can occur via wires or wirelessly via a communication port (935). The circuits that connect the AB microprocessor (924) directly to the vehicle may be aided by an amplifier (929). Additional memory for programming or data storage can be interfaced with the microprocessor (936) in the form of standard memory cards or other storage medium (938) that may allow the user to swap them as needed.

The microprocessor (936) running the communicator software optionally receives commands from the driver via the switch (such as the switch illustrated in FIG. 3) (945). The switch (945) is controlled by a microprocessor (949) and can use a communications port (952) to communicate with the microprocessor (936) using the corresponding communications port (935). The switch (945) can output to the driver via communications port (952) such as a light or sound device. The driver can issue commands using the button (951) on the switch (945) to input commands to the microprocessor (936) running the communicator software. The switch (945) may contain an input connection for programming, charging or data input/output (946). The battery (948) may be managed by circuitry and programmable software (947).

FIG. 4b shows a block diagram of an Actuator Board (661) used to connect the vehicle circuitry to control vehicle systems. The Actuator Board (661) is connected to electrical leads (663) which have lead adapters (662) attached. The lead adapters (662) are specifically designed to be connected into sockets (666) of the vehicle's systems (664, 665). The Actuator Board (661) is connected to the vehicle electric box (664) or other vehicle systems (665) by inserting the lead adapter (662) into a socket (666, 667, 668, 669) of the vehicle electric box (664) or the sockets of other vehicle circuits (670). The connected Actuator Board (661) sends and receives electrical power and electrical signals from the connected electric box (664) or other vehicle systems (665). The Actuator Board (661) acts as a switch to selectively control electrical power and electrical signals to the designated vehicle systems under the directions of the microprocessor (936) running the device and communicator software. The types of vehicle systems controlled are determined by the socket in which a designated lead adapter is inserted (666, 669) or otherwise connected to (670). The microprocessor (936) uses the device software to issue commands and forward these commands to the Actuator Board (661) using the microprocessor (936) software routines. The device software is now in control of the selected vehicle systems using the Actuator Board (661). The microprocessor (936) running the device and the communicator software can monitor the actions of the Actuator Board (661) and control the time and amount of time power the Actuator Board (661) provides the starter motor or other vehicle systems. Real time data monitoring and control by the microprocessor (936) can enable faster response times and minimizes wear on the starter motor.

FIG. 4c shows a block diagram of the electronic components that can be used to execute the various functions of this invention. The four components are: the Actuator Board (920c), the device (934c), the communicator (936c) and an optional switch (945c). The Actuator Board (920c) is connected directly to the vehicle's circuitry preferably directly replacing existing relays or fuses and acting in their place. The Actuator Board (920c) will perform all functions of the components they replace in addition to the additional features described here. The Actuator Board (920c) receives commands from the device (934c) via the communicator (936c). The Actuator Board (920c) also sends and receives information to and from the device (934c). The communication between the communicator (936c), in the device/communicator package (930c), and the AB microprocessor (924c) in the Actuator Board (920c) occurs via communications port (935c) to the communications port (926c) respectively. Information received by the Actuator Board (920c) can be further processed by its own AB microprocessor (924c) before sending data to the device (934c) or before executing a command issued by the device (934c). The Actuator Board (920c) may contain an input connection for programming, charging or data input/output (921c). The Actuator Board (920c) has a series of circuits (922c, 923c, 925c, 927c, 928c) connected to various vehicle electronics that function under the control of the AB microprocessor (924c), to directly send power or signals to vehicle components. The Actuator Board (920c) can provide electronic signals or create impedance loads (925c, 927c, 928c) to vehicle control circuits to mimic necessary control signals to circumvent normal vehicle operation. Using the device (934c) as a central processing unit, and the communicator (936c) to control communications, the Actuator Board (920c) can communicate to the switch (945c).

In FIG. 4c, the device (934c) and the communicator (936c) carry out their respective functions using different circuits (934c, 936c) that are located in a device/communicator package (930c). The communicator (936c) manages communications with other components of the invention, the vehicle, auxiliary components and external networks. The device (934c) analyzes data provided by the communicator (936c) that the device (934c) uses to issue commands to control the system and by extension the vehicle. The communicator (936c) can make use of additional components located in the device/communicator package (930c) such as a battery voltage sensor (932c). The battery voltage sensor (932c) communicates with the vehicle electronics via the vehicle's computer port that is connected to the communicator (936c) through a connector (931c). The battery voltage sensor (932c) communicates with the vehicle electronics via connector (931c) connected to the vehicle computer port. The microprocessor (936c) running the communication software communicates with the vehicle electronics via connector (931c) through a protocol interface (933c). The device/communicator package (930c) containing the communicator (936c) and the device (934c) may contain an input/output connection (939c) for programming, charging or data input/output. The communicator (936c) may connect to circuitry (941c) controlling auxiliary devices such as the transmission fluid pressure accumulator. The communicator (936c) can output to the driver using a light, haptic output or sound device (940c). The communicator (936c) can connect to components such as a USB or other computer though input/output connection (939c) or optionally make use of expansion connectors (937c), such as an accelerometer or temperature sensor, that add extra functionality to the system. Communication between the communicator (936c) and the other system components can occur via wires or wirelessly via a communication port (935c). The circuits that connect the AB microprocessor (924c) directly to the vehicle may be aided by an amplifier (929c). Additional memory for programming or data storage can be interfaced with the communicator (936c) in the form of standard memory cards (938c) or other storage medium (938c) that may allow the user to swap them as needed.

The communicator (936c) optionally receives commands from the driver via the switch (such as the switch illustrated in FIG. 3) (945c). Driver inputs to the switch (945c) are forwarded to the communicator (936c) on to the device (934c). The switch (945c) is controlled by a microprocessor (949c) and can use a communications port (952c) to communicate with the communicator (936c) using the corresponding communications port (935c). The switch (945c) can output to the driver via a communications port (952c) such as a light or sound device. The driver can issue commands using the button (951c) on the switch (945c) to input commands to the communicator (936c). The switch (945c) may contain an input connection for programming, charging or data input/output (946c). The battery (948c) may be managed by circuitry and programmable software (947c).

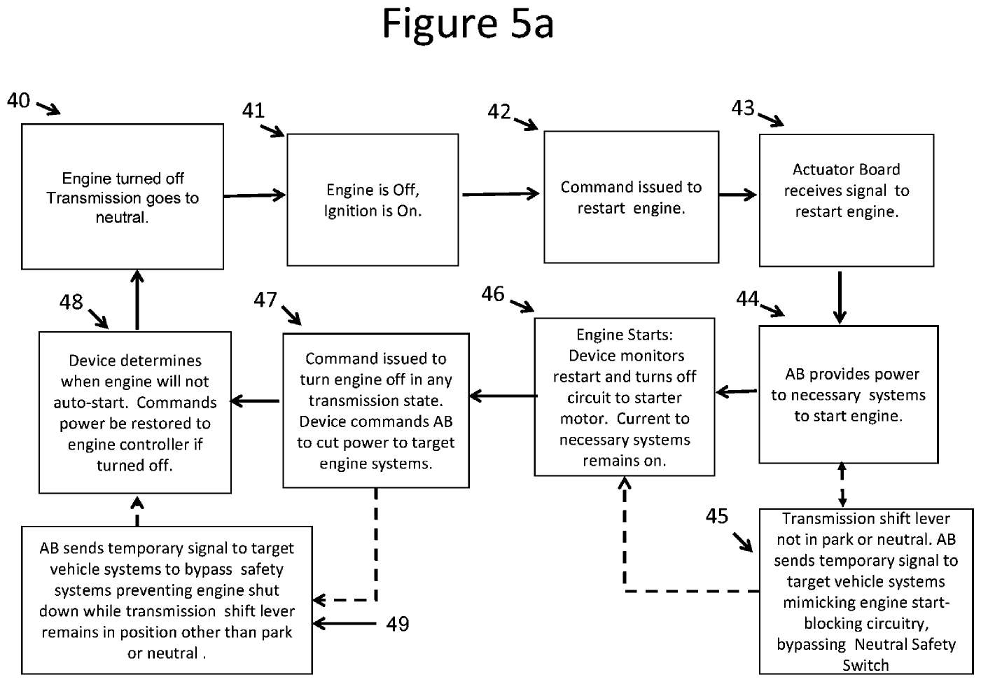

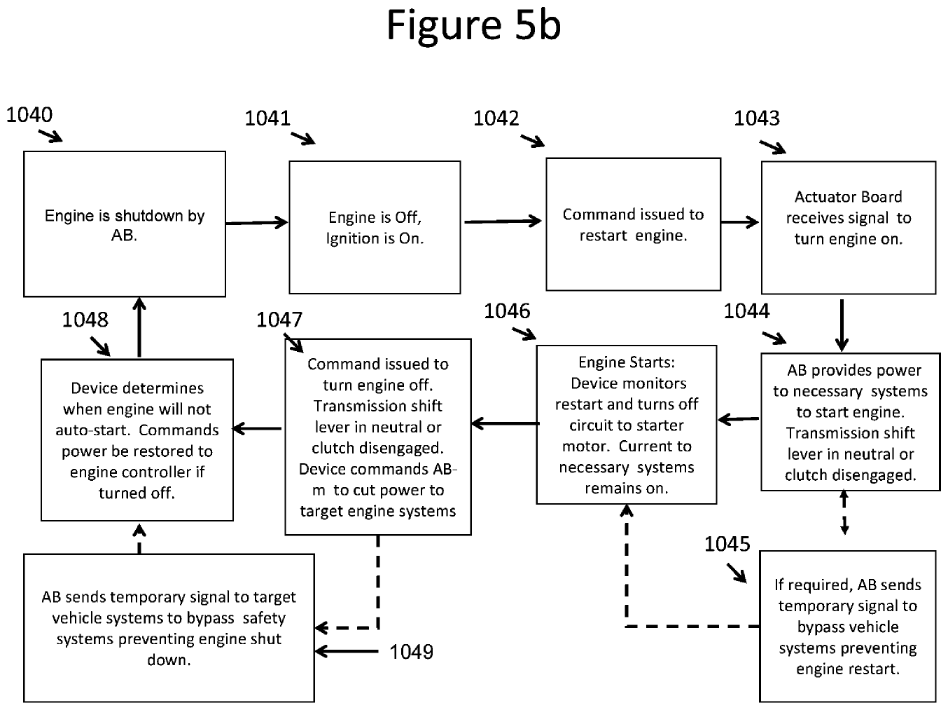

FIG. 5a shows a block diagram of a system that uses an “Actuator Board Routine” (“AB”) to turn an automatic transmission vehicle engine on and off. Under the Actuator Board Routine, a command is issued to shut-off the engine. The transmission transitions to neutral when the engine is shutdown (40). The vehicle engine is off with the ignition on (41). In the ignition on state, power is available to the vehicle systems and the engine can be on or off. A command is issued to restart the engine (42). The Actuator Board receives a signal to restart the engine (43). The Actuator Board turns on the circuits providing power to systems used to start the engine including circuits controlling the starter motor (44). If needed, the Actuator Board sends a signal to bypass any vehicle system(s) that block an engine restart (45). The Actuator Board can send a signal mimicking the signal of circuits that control the neutral safety switch (45), or it can provide a dummy impedance load to indicate that an engine restart is permitted (45). The bypass signal allows the Actuator Board to provide power to the starter motor and to restart the engine with the transmission shift lever in a position other than park or neutral. The engine starts (46). The device monitors the engine restart and commands the Actuator Board to cut power to the starter motor when the device detects that engine has restarted (46) while leaving power on to the necessary vehicle systems (46). A command is issued to turn the engine off (47) and the device commands circuits to disable power to target engine systems to shut-off the engine (47). The device collects information over the computer port to determine when the engine will not auto-restart and commands the Actuator Board to restore power to necessary systems (48), which were shut-off (47). If required, the Actuator Board sends temporary signals to vehicle circuits to bypass safety systems preventing engine shutdown while the transmission lever remains in position other than park or neutral (49). The engine is off and the ignition is on (40).

FIG. 5b shows a block diagram of a system that uses an “Actuator Board Routine” (“AB”) to turn a manual transmission vehicle engine on and off. The vehicle engine is off with the ignition on (1041). A command is issued to restart the engine (1042). The Actuator Board receives a signal to restart the engine (1043). The transmission shift lever is in neutral or the clutch is disengaged (1044) and the Actuator Board turns on the circuits providing power to required systems used to start the engine including circuits controlling the starter motor (1044). An engaged clutch can transmit engine power to the transmission. A disengaged clutch cannot transfer power to the transmission. If needed, the Actuator Board bypasses any vehicle systems preventing an engine restart by sending a signal to the vehicle mimicking the signal of circuits preventing an engine restart (such as the clutch interlock) (1045). The engine starts (1046). The device monitors the engine restart and commands the Actuator Board to cut power to the starter motor when the device detects that the engine has restarted (via computer port parameters such as engine revolutions per minute (RPM)) or after predetermined time has elapsed (1046). The power is left on to necessary vehicle systems (1046). A command is issued to turn the engine off (1047) and the device commands circuits to shut-off power to target engine system to shut-off the engine (1047). The device determines when the engine will not auto-restart using parameters read over the vehicle computer port (such as engine RPM) and commands the Actuator Board to restore power to necessary systems (1048) that were shut-off in (1047). Optionally, the Actuator Board sends temporary signals to vehicle circuits to bypass safety systems preventing engine shutdown if the vehicle is in neutral or the clutch engaged (1049). The engine is shutdown (1040) and the engine is off and the ignition is on (1040).

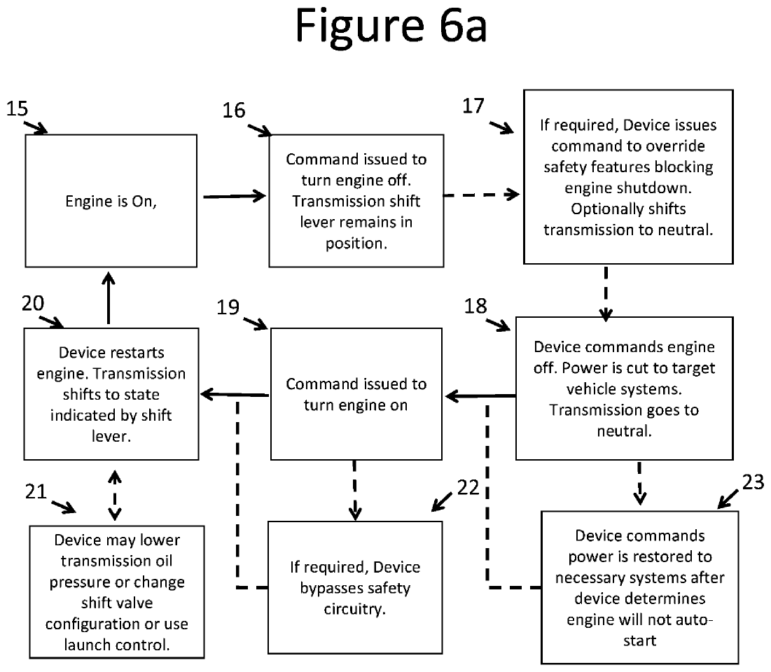

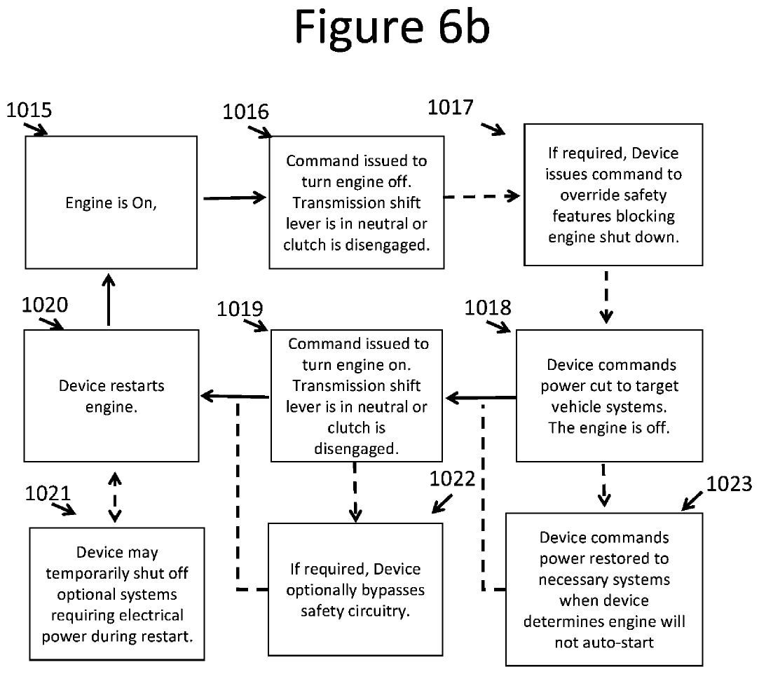

FIG. 6a shows a block diagram of a system that uses a “Device Control Routine” to turn the engine on and off while the transmission shift lever remains in gear for a vehicle with an automatic transmission. The vehicle engine is on (15). A command is issued to shut the engine off (16) by cutting power to target vehicle systems. If required, the device issues a command to bypass any vehicle safety features blocking an engine shutdown (17). Optionally, the device commands the transmission to neutral (17) while the transmission shift lever remains in position (16). The device commands the engine to shut-off and the vehicle transmission shift lever remains in the “drive” position (18). If required, the device issues a command to bypass vehicle systems preventing engine shutdown (18). If the transmission has not been already shifted to neutral by the device (17), the transmission typically shifts to neutral when the engine shuts off (18). If power to the engine controller has been cut, it is optionally restored after the device determines when the engines will not auto-restart (23). A command is issued to turn the engine on (19). If required, the device issues a signal to vehicle circuits to bypass vehicle systems preventing an engine restart (22). The engine restarts and the transmission returns to the gear selected by the transmission shift lever (20). During restart, the device may optionally issue commands to lower transmission pressure (21) and/or change the transmission shift valves to change configuration (21) and/or use launch control (21). The engine is restarted (20) and transmission shifted to the gear indicated by the transmission shift lever state (20).

FIG. 6b shows a block diagram of a system that turns the engine of a manual transmission vehicle on and off (1015) using a “Device Control Routine.” The engine is on (1015), and a command is issued to shut the engine off with the transmission shift lever in neutral or the clutch is disengaged. If required, the device issues a command to bypass any vehicle safety features blocking an engine shutdown (1017). The device commands the engine to shutdown by cutting power to target vehicle systems, and the vehicle transmission is in neutral or the clutch disengaged (1018). If power to the engine controller has been cut, it is optionally restored after the device determines when the engine will not auto-restart (via parameters read over the vehicle computer port such as engine RPM) (1023). A command is issued to turn the engine on with the transmission in neutral or the clutch disengaged (1019). If required, the device optionally bypasses safety circuitry preventing engine restart (1022). The engine restarts (1020). During restart, the device may turn off optional systems that require electrical power during restart (1021). The engine is restarted (1015).

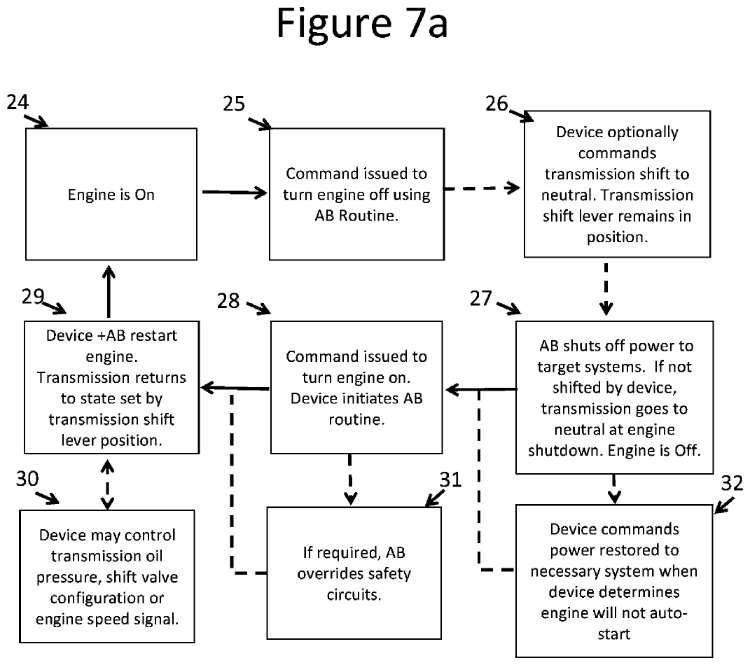

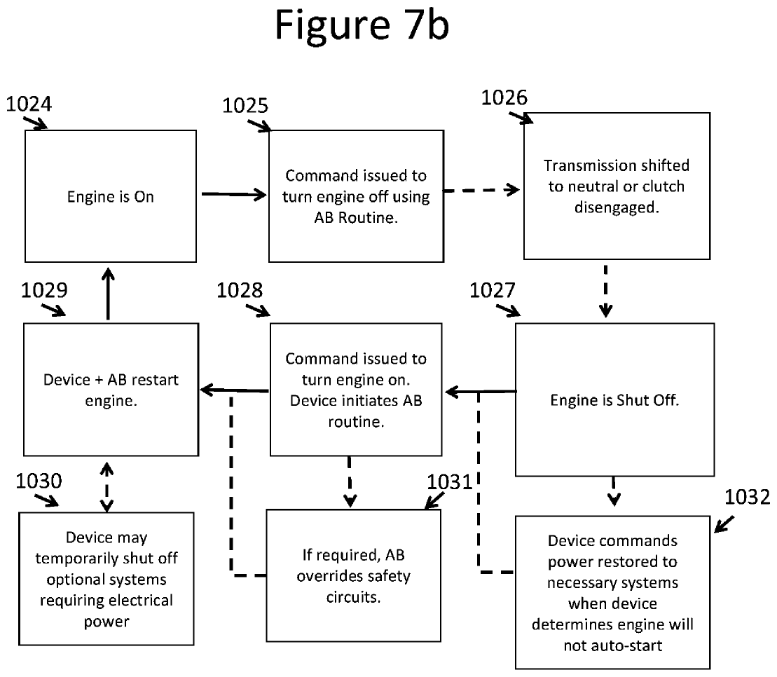

FIG. 7a shows a block diagram of a system than turns the engine of an automatic transmission vehicle on and off using an “Actuator Board Control Routine.” The engine is on (24). A command is issued to shut the engine off using the Actuator Board Routine (25). The device optionally commands the transmission to shift to neutral (26) while transmission shift lever remains in position (26). The device commands the Actuator Board to cut power to the target vehicle systems to turn off the engine (27). The engine is off (27). If the transmission has not been already shifted to neutral by the device (26), the transmission typically transitions to neutral (27). Power to any necessary vehicle systems is restored after the device determines the vehicle engines will not auto-restart (32). A command is issued to the Actuator Board to restart the engine using the Actuator Board Routine (28). If required, the device issues a signal to the vehicle's circuits to bypass vehicle systems preventing an engine restart (31). The device and the Actuator Board restart the engine (29) and the transmission returns to the gear set by the transmission shift lever (29). During restart, the device may optionally issue commands to ensure a smoother engagement of the transmission by lowering transmission pressure (30), changing the configuration of the transmission shift valves (30), sending a false engine speed signal to the transmission control unit (30), and/or use launch control (30).

FIG. 7b shows a block diagram of a system that turns the engine of a manual transmission vehicle on and off using an “Actuator Board Control Routine.” The engine is on (1024). A command is issued to shut the engine off using the Actuator Board Routine (1025). The device optionally checks if the transmission shift lever is in neutral or the clutch is disengaged (1026). The device commands the Actuator Board to cut power to the target vehicle systems to turn off the engine (1027). The engine is off (1027). The Actuator Board restores power to any necessary vehicle systems after the device determines the vehicle engine will not auto-restart (1032). A command is issued to the Actuator Board to restart the engine using the Actuator Board Routine (1028). The Actuator Board optionally sends a signal to override the circuits that block the engine from starting (such as a clutch interlock) and bypass these systems (1031). The engine restarts (1029). Optionally, during restart, the device may turn off optional systems that require electrical power (1030).

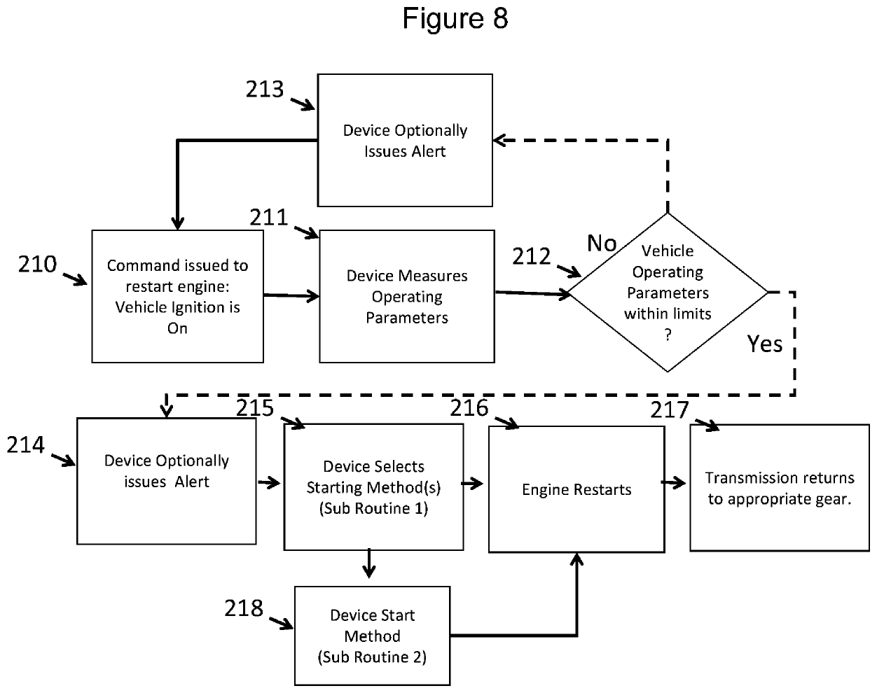

FIG. 8 illustrates the “Master Restart Routine” to restart the engine of an automatic transmission vehicle that can be used to select the method of engine restart. The device sends a command to the computer port or to auxiliary electronic devices to start the engine (210). The device gathers information from the computer port and optional auxiliary equipment (211). The device determines if the operating parameters are within limits (212). If the operating parameters are not within limits (212), the device may optionally issue an alert (213). If the operating parameters are within limits (212), the device may optionally issue an alert (214) and select a starting method using subroutine 1, subroutine 2 or both (215, 218). After selecting the starting method (215, 218) the engine restarts (216). Once the engine is restarted (216), the device selects the appropriate gear (217) and the vehicle is driving with the engine on. The device may optionally alert the driver if operating parameters are out of limits (213, 214).

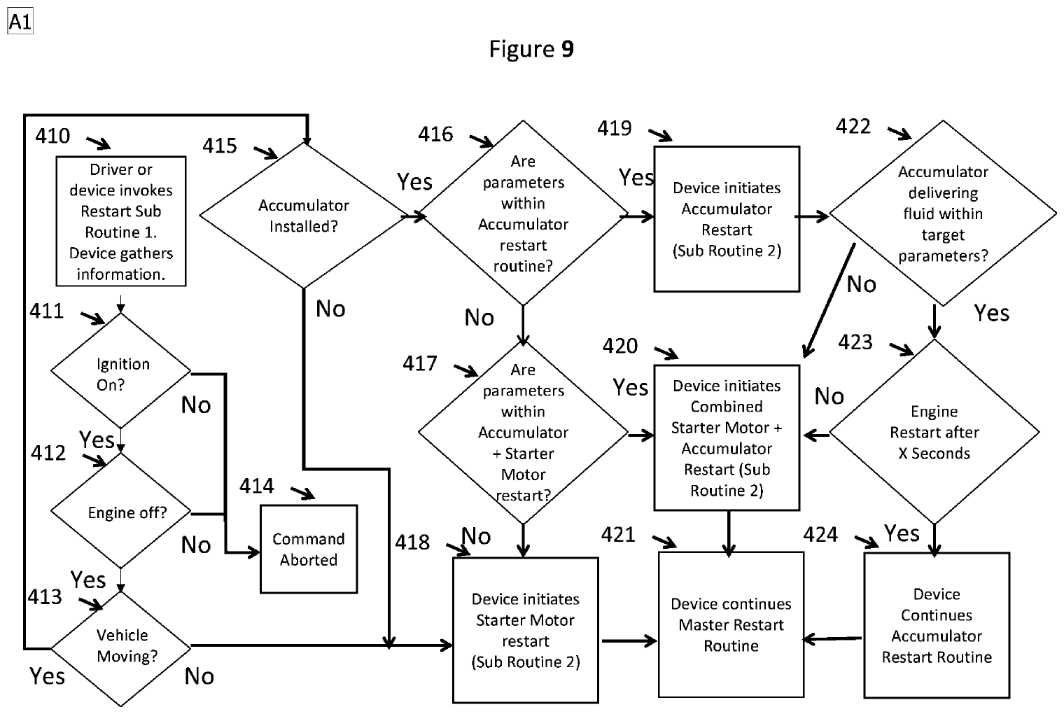

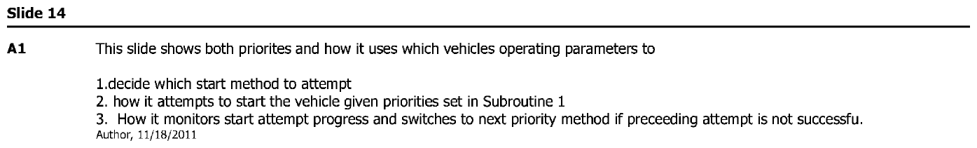

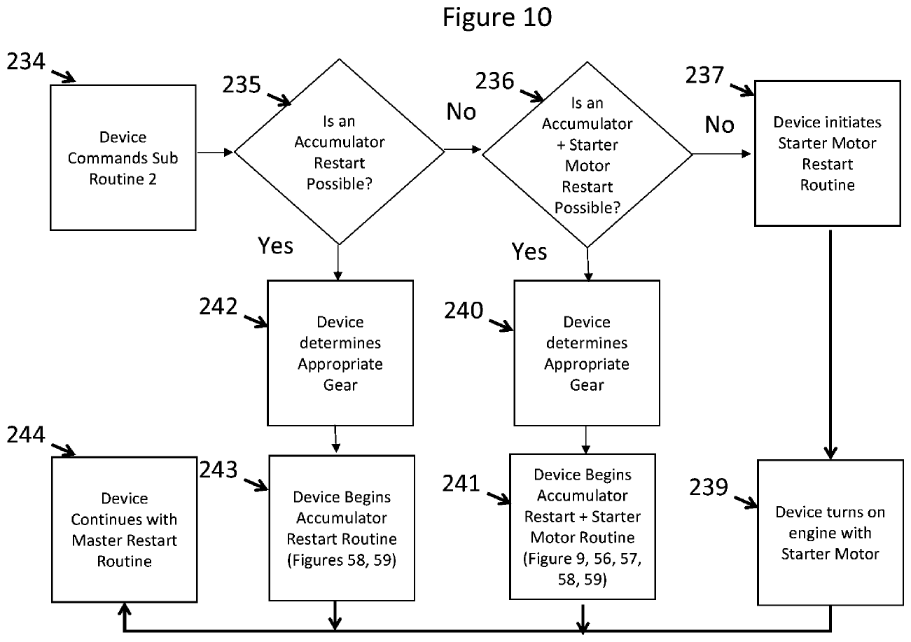

FIG. 9 illustrates the “Engine Restart Subroutine 1” (410) illustrated in (215) in FIG. 8. The device gathers information to determine if the ignition is on (411). If it is not on (411), the command is aborted (414). If the ignition is on (411), the device gathers information to determine if the engine is off (412). If the engine is on (412), the command is aborted (414). If the engine is off (412), the device gathers information to determine if the vehicle is moving (413). If the vehicle is not moving (413), the device initiates a starter motor restart (418) (Subroutine 2). If the vehicle is moving (413), the device gathers information to determine if there is an accumulator (415). If there is no accumulator (415), the device initiates a starter motor restart (418) (Subroutine 2). If the vehicle is equipped with an accumulator (415), the device gathers information to determine if the parameters are appropriate for an accumulator restart (416). If the parameters are proper for an accumulator restart (416), the device initiates the accumulator restart (419). If the initial conditions are not correct for an accumulator restart (416), the device evaluates conditions for a combined accumulator restart with an assist from the starter motor (417). If the initial conditions are not correct for a combined restart (417), the device starts the motor with the starter motor (418). In the Accumulator Restart Routine (419), the device monitors accumulator pressure and fluid level to determine if accumulator is delivering fluid within target parameters (for instance flow rate and pressure) (422). If the requirements are not met (422), the device initiates a combined starter motor and accumulator restart start (420) (Subroutine 2) and continues the Master Restart Routine (421). If the requirements are met (422) the device gathers information at time X seconds after restart initiation (419) to determine if the restart was successful (423). X is a variable of time that may be set by the driver or device. It is generally between 0.1 seconds and 15 seconds. If the restart was successful (423), the device continues with the Accumulator Restart Routine (424) and transfers to the Master Restart Routine (421). If the restart was not successful (423), the device initiates an accumulator and starter motor restart (420) (Subroutine 2).

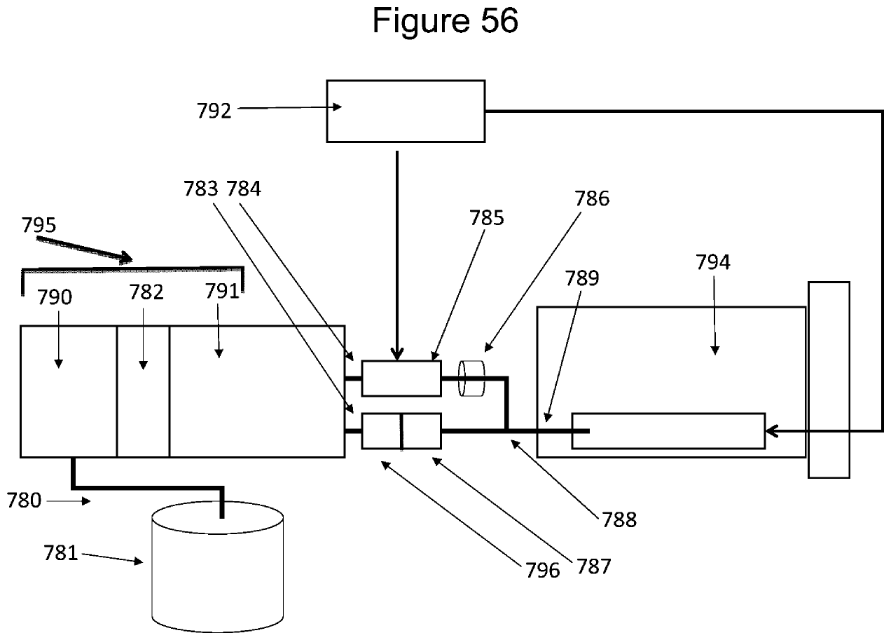

FIG. 10 illustrates “Engine Restart Subroutine 2” illustrated in (218) in FIG. 8. The device commands Subroutine 2 (234). The device gathers information to determine if an accumulator restart is possible (235). In attempting an accumulator restart (235), the device determines the appropriate gear to use for engine restart (242), and begins the Accumulator Restart Routine (243) illustrated in FIGS. 56, 57, 58, and 59. The device continues the restart using the Master Restart Routine (244). If an accumulator restart is not possible (235), the device gathers information to determine if a combined accumulator and starter motor restart (236) is possible. If an accumulator with starter restart routine is possible (236), the device determines the appropriate gear for engine restart (240) prior to attempting the engine restart. The device next begins a combined Accumulator with Starter Restart Routine (241) and continues with the Master Restart Routine (244). If an Accumulator with Starter Restart Routine is not possible (236), the device initiates a Starter Motor Start Routine (237), and the starter motor restarts the engine (239). The device transfers to the Master Restart Routine (244).

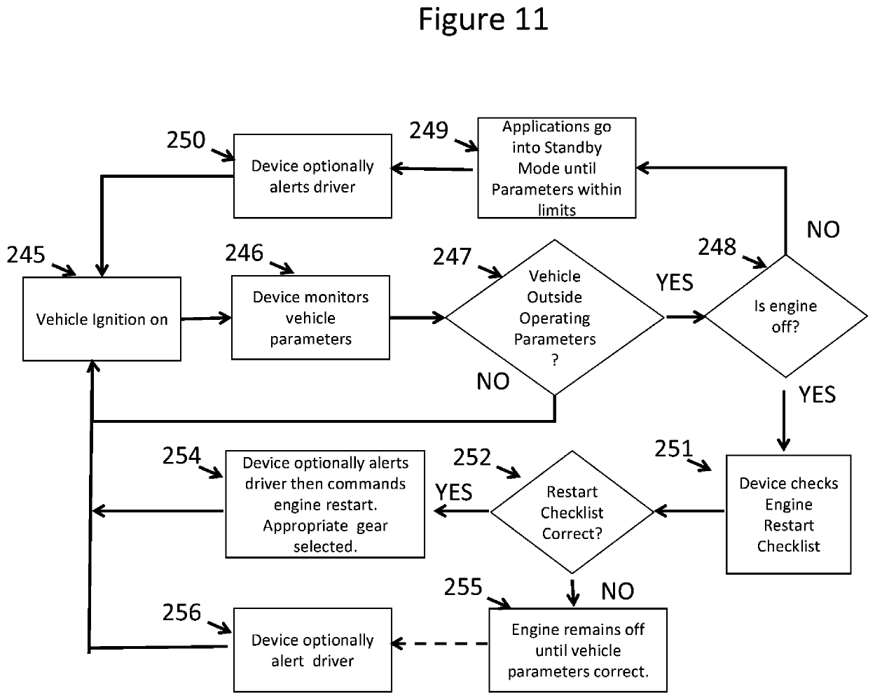

FIG. 11 illustrates the block diagram of a routine for an automatic transmission vehicle to determine when the engine should be turned on and an engine shutdown prohibited. The vehicle ignition is on (245), and the device monitors vehicle parameters (246) to determine if the vehicle is operating outside the proper parameters (247). If the vehicle is operating within proper parameters (247), the device takes no action and the ignition remains on (245). If the vehicle is operating outside of proper parameters (247), the device gathers information to determine if the engine is off (248). If it is on (248), the device places any application commanding an Engine Shutdown Routine into Standby Mode until operating parameters return within limits (249). Optionally, the device alerts the driver (250). If the engine is off (248), the device gathers information to determine if the vehicle's operating parameters meet the requirements of the Engine Restart Checklist (251, 252). If the requirements are met (251, 252), the device optionally alerts the driver prior to the engine restart (254), and the device commands an engine restart (254), following which the appropriate gear is selected (254). If the requirements are not met (251, 252), the engine remains off until vehicles parameters are appropriate (255). The device optionally alerts the driver on device status (256). The appropriate gear is selected by the vehicle transmission controller or, if required, by the device (254).

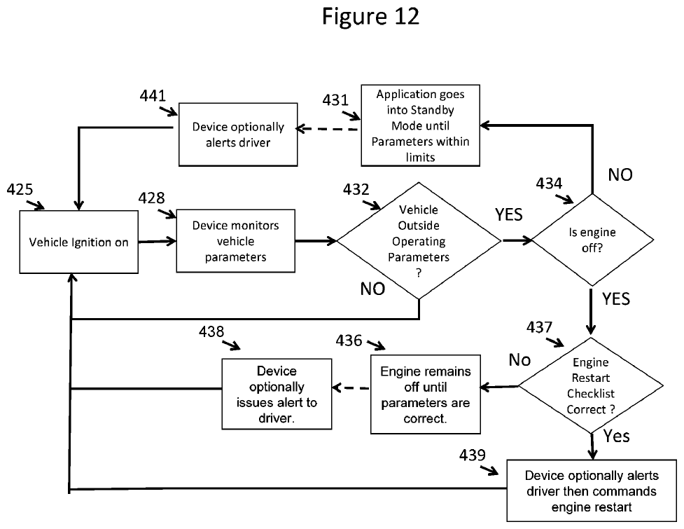

FIG. 12 illustrates the block diagram of a routine the device uses with a manual transmission vehicle to determine when the engine should be turned on or an engine shutdown prohibited. The vehicle ignition is on (425), and the device monitors vehicle (428) to determine if the vehicle is operating outside the proper parameters (432). If the vehicle is operating within proper parameters (432), the device takes no action and the ignition remains on (425). If the vehicle is operating outside of proper parameters (432), the device gathers information to determine if the engine is off (434). If the engine is on (434), the device places any application invoking Engine Shutdown Routines into Standby Mode until operating parameters return within limits (431) and optionally alerts the driver (441). If the engine is off (434), the device gathers information to determine if the vehicle's operating parameters meet the requirements as defined by the Engine Restart Checklist (437) (see FIG. 11). If the requirements are met (437), the device optionally issues an alert to the driver and then commands an engine restart (439). If the requirements are not met (437), the engine remains off until vehicle parameters are correct (436) and the device optionally issues an alert to the driver (438).

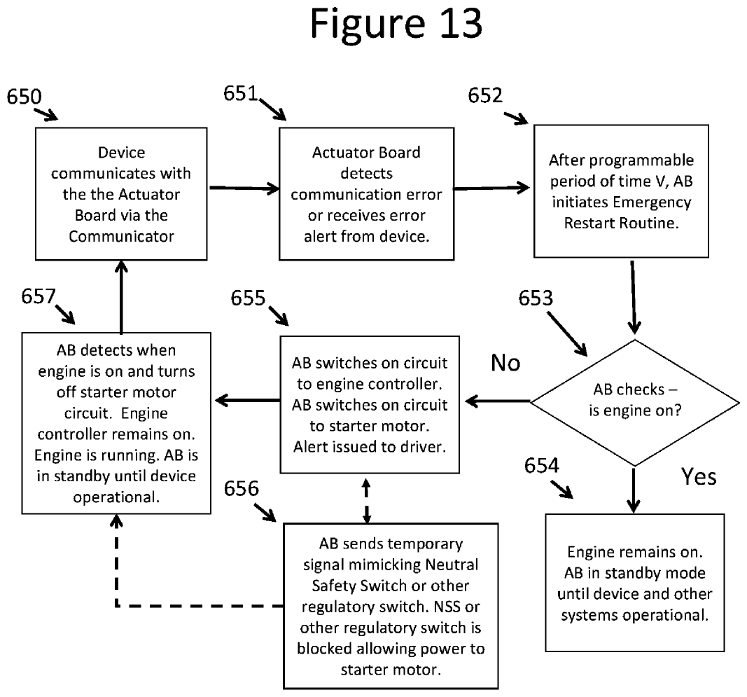

FIG. 13 is a block diagram of a system that allows the Actuator Board to restart the vehicle when it detects a communication error with the device. The device is attached to the computer port with ignition on (650). The Actuator Board detects an error with the device or receives an error alert from the device (651). After a programmable period of time V, the Actuator Board initiates the Emergency Restart Routine (652). The Actuator Board checks if the engine is on (653). If the engine is on (653), the engine remains on and the Actuator Board goes into Standby Mode until the device is operational (654). If the engine is not on (653), the Actuator Board switches on the circuits to the engine controller and the starter motor circuit (655) and an alert is issued to the driver (655). If required for the vehicle, the Actuator Board sends a signal to the starter motor mimicking signal sent from the neutral safety switch, or other such circuit preventing engine restart (656). The neutral safety switch is overridden (656). The engine turns on (657). The Actuator Board detects the engine is on (657) and turns off the starter motor circuit turning off the starter motor (657). The engine controller is on and the engine is running (657).

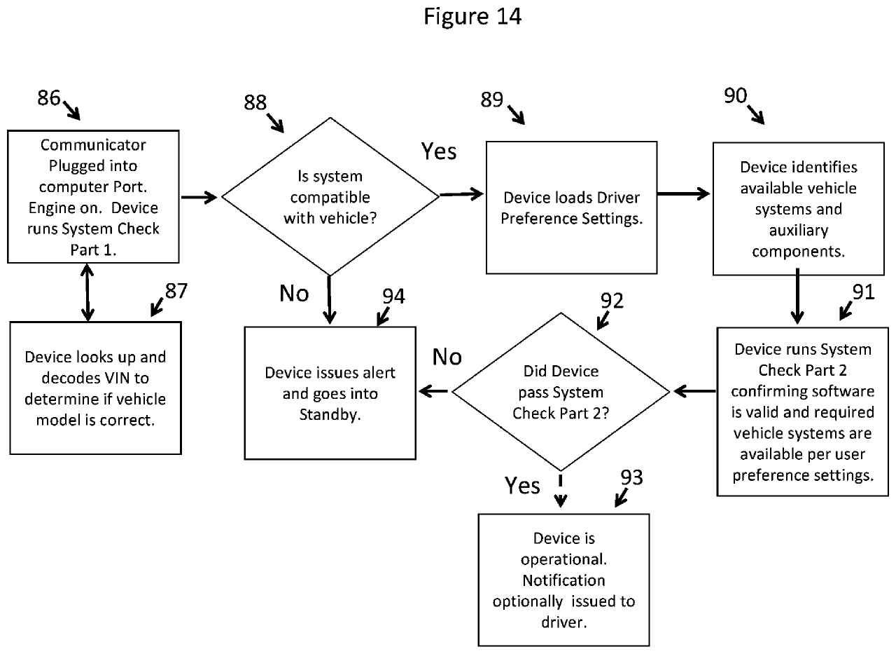

FIG. 14 shows a block diagram of a system that verifies the vehicle model and checks to determine which systems are available and functional. The device is connected to a computer port of a vehicle with the ignition turned on (86). The device begins System Check Part 1 (86). In System Check Part 1, the device looks up the Vehicle Identification Number (VIN) and decodes the VIN to identify the vehicle manufacturer, model, year of vehicle (87). The device then checks if the device and the vehicle are compatible (88). If the vehicle is not compatible with the device (88), an alert is issued and the device goes into Standby Mode (94). If the device and vehicle are compatible (88), the device loads the driver preference settings (89). Next, the device takes an inventory of the available vehicle systems and auxiliary components (90). The device then runs System Check Part 2 to check if the software on the device is valid and approved by the system manufacturer (91, 92). The device also checks to confirm the required vehicle systems, and components that work with the device, are available and functioning (91, 92). If the vehicle does not pass System Check Part 2 (92), an error alert is issued to the driver and the device goes into Standby Mode (94). If the vehicle passes System Check Part 2 (92), the device optionally issues a notification to the driver and the device is operational (93).

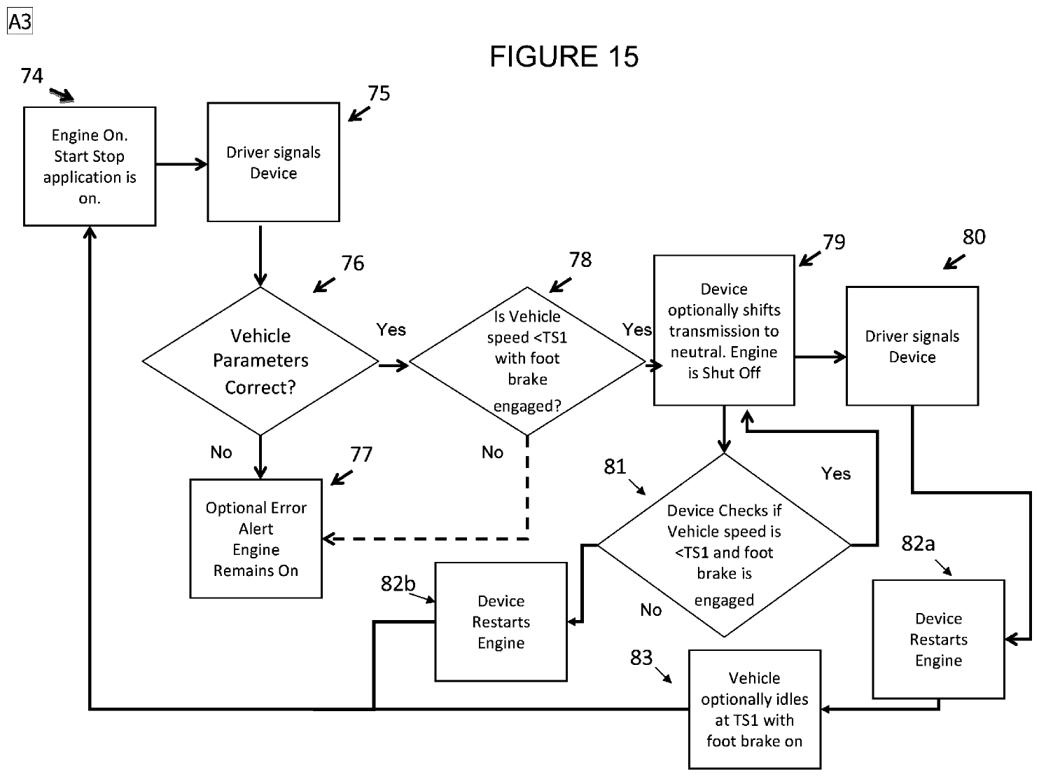

FIG. 15 illustrates a block diagram of a system for a driver controlled “Start Stop” Application that controls the internal combustion engine of an automatic transmission. The vehicle engine and the device's Start Stop Application are on (74). The driver signals the device (75). The device gathers information from the vehicle computer port and determines if the vehicle parameters are appropriate for engine shutdown or restart (76). If the parameters are not appropriate (76), the command is aborted and the device optionally alerts the driver (77). The engine remains on (77). If the parameters are appropriate (76), the device gathers information from the vehicle computer port and determines if the vehicle speed is less than TS1 (78) and the foot brake is depressed (78). TS1 is a variable of speed, which may be set by the driver or device. It is generally between 1 mph and 5 mph. The device uses the device control routine or the Actuator Board Routine to shut-off the engine. Optionally the device commands the transmission to shift to neutral (79) and then shuts off the engine (79). The device continues to gather information from the computer port and determines if both the vehicle speed remains less than TS1 (81) and that the foot brake remains engaged (81). If the vehicle speed is not less than TS1 (81), the device restarts the engine (82b). If the vehicle foot brake is not engaged (81), the device restarts the engine (82b). If both the vehicle speed is less than TS1 and the foot brake are engaged (81), the engine remains off (79). The driver signals the device (80) and the device restarts the engine (82a) using the Device Control Routine or the Actuator Board Routine. The Start Stop Application is placed into Standby Mode allowing the vehicle to idle at a speed less than TS1 with the foot brake engaged (83). The engine is on and the Start Stop Application is active (74). The driver signals the device to begin the engine shutdown sequence again (75).

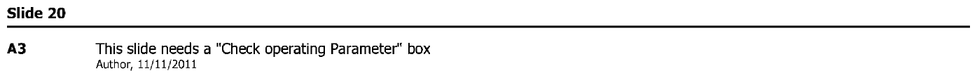

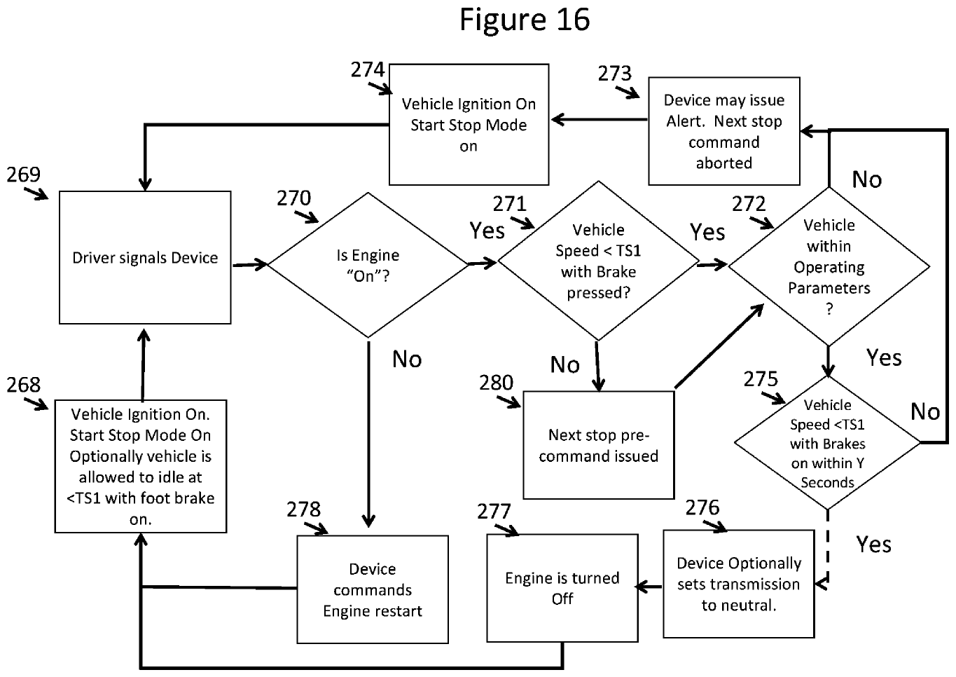

FIG. 16 illustrates a block diagram of a system with a “Start Stop—Next Stop Pre-Command” for an automatic transmission vehicle. With the “Next Stop Pre-Command,” the device performs an engine shut-off the next time, within a defined time interval, the vehicle speed is less than TS1 with the foot brake applied. The vehicle ignition is on and Start Stop Mode is on (268). The driver signals the device (269). The device gathers information from the vehicle computer port and determines if the engine is on (270). If the engine is not on (270), the device commands an engine restart (278) and the engine is optionally allowed to idle at <TS1 with the foot brake on (268). If the engine is on (270), the device gathers information from the vehicle computer port and determines if the vehicle speed is less than TS1 and the foot brake is engaged (271). If the vehicle speed is not less than TS1, or the foot brake is not engaged (271), the device issues a Next Stop” Pre-Command (280). The device checks if the vehicle is operating within appropriate parameters (272). If the vehicle is not operating within appropriate parameters (272), the device aborts the pre-command and may optionally issue an alert (273). The vehicle continues with the ignition on (274). If the vehicle operating parameters are correct (272), the vehicle speed is less than TS1 and the foot brake is engaged within Y seconds where Y is a programmable period of time (275), the device optionally commands the transmission to neutral (276) and commands an engine shutdown (277). Y is a variable of time that may be set by the driver or device. It is generally between 1.0 second and 2 minutes. The vehicle continues with ignition on (274). If the vehicle speed is not less than TS1 with the foot brake engaged within Y seconds (275), the device aborts the pre-command and an alert may be issued (273). The vehicle continues with the ignition on (274).

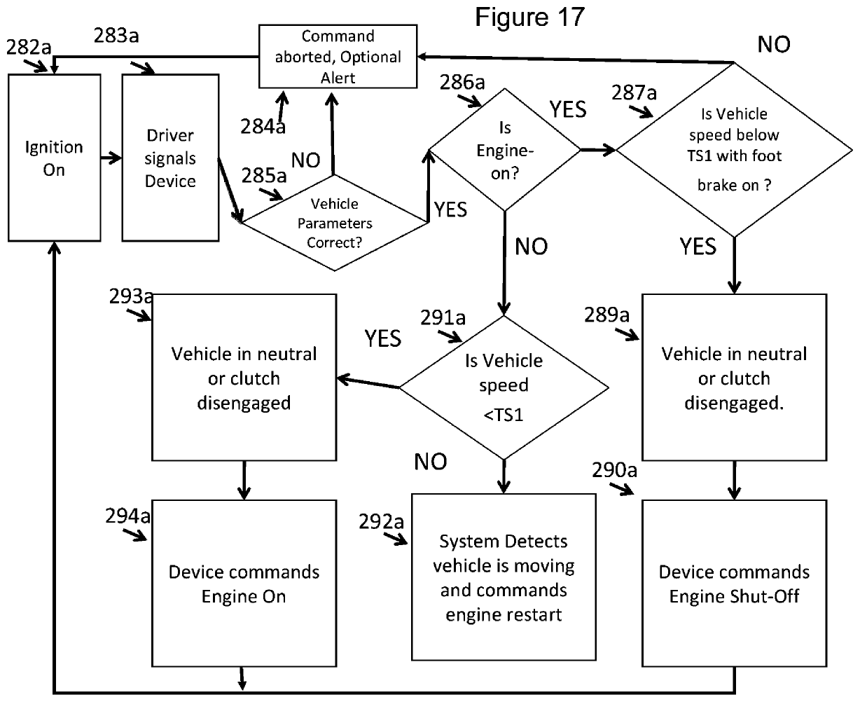

FIG. 17 illustrates a block diagram of a system for starting and stopping a vehicle with a manual transmission, so that the device, when signaled, performs an engine shut-off the next time the vehicle speed is less than TS1 with the foot brake pressed. The vehicle ignition is on (282a). The driver signals the device (283a). The device gathers information from the vehicle computer port and determines if the vehicle parameters are appropriate for engine turn on or shut-off (285a). If the parameters are not appropriate (285a), the command is aborted (284a). If the parameters are appropriate (285a), the device gathers information from the vehicle computer port and determines if the engine is running (286a). If the engine is not running (286a), the device gathers information from the vehicle computer port (291a), and determines if the vehicle speed is less than TS1 (291a). If the vehicle speed is not less than TS1 (291a), the device determines the vehicle is moving and restarts the engine (292a). If the vehicle speed is less than TS1 (291a) and the driver has the gear in neutral or the clutch disengaged (293a), the device commands engine turn on (294a). The vehicle continues with the ignition on (282a). If the engine is running (286a), the device gathers information from the vehicle computer port (287a) and determines if the vehicle speed is less than TS1 (287a). If the vehicle speed is less than TS1 (287a), and the driver has the gear in neutral or the clutch disengaged (289a) the device commands engine shut-off (290a). If the vehicle speed is not less than TS1 (287a), the device optionally issues an alert (284a) and the engine shutdown command is aborted (284a). If conditions for preparing for engine shutdown are met (288), the device commands engine shut-off (290a).

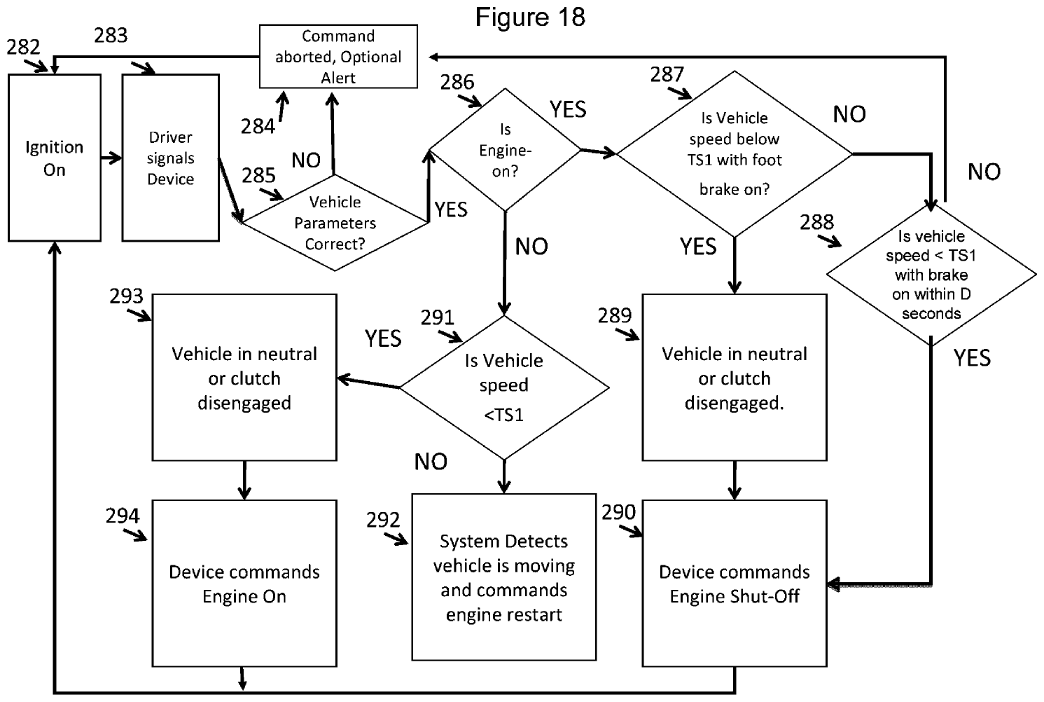

FIG. 18 illustrates a block diagram of a system for starting and stopping a vehicle with a manual transmission, which includes the option of issuing a pre-command so that the device performs an engine shut-off the next time the vehicle speed is less than TS1 with the foot brake pressed. The vehicle ignition is on (282). The driver signals the device (283). The device gathers information from the vehicle computer port and determines if the vehicle parameters are appropriate for engine turn on or shut-off (285). If the parameters are not appropriate (285), the command is aborted (284). If the parameters are appropriate (285), the device gathers information from the vehicle computer port and determines if the engine is running (286). If the engine is not running (286), the device gathers information from the vehicle computer port (291), and determines if the vehicle speed is less than TS1 (291). If the vehicle speed is not less than TS1 (291), the device determines the vehicle is moving and restarts the engine (292). If the vehicle speed is less than TS1 (291) and the driver has the gear in neutral or the clutch disengaged (293), the device commands engine turn on (294). The vehicle continues with the ignition on (282). If the engine is running (286), the device gathers information from the vehicle computer port (287) and determines if the vehicle speed is less than TS1 (287). If the vehicle speed is less than TS1 (287), and the driver has the gear in neutral or the clutch disengaged (289), the device commands engine shut-off (290). If the vehicle speed is not less than TS1 (287), the devices issues a pre-command to prepare for engine shutdown if the vehicle speed is less than TS1 with the foot brake depressed within a programmable period of time D (288). If conditions for preparing for engine shutdown are met (288), the device commands engine shut-off (290). If the conditions for engine shutdown are not met within D seconds (288, 289) the pre-command is aborted (284) and optionally an alert is issued (284). D is a variable of time, which may be set by the driver or device. It is generally between 1.0 second and 2 minutes. The vehicle continues with the ignition on (282).

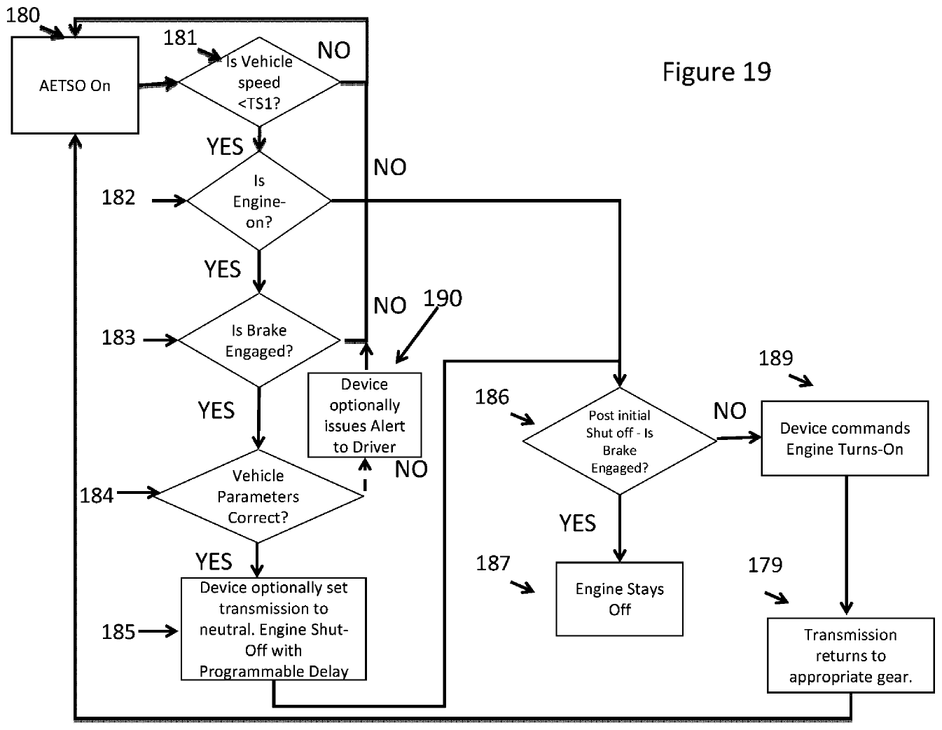

FIG. 19 illustrates a block diagram of a system, which provides “Automatic Engine Turn On and Shut-off” (AETSO) of the engine without driver input. AETSO is enabled (180). The device gathers information from the vehicle computer port to determine if the vehicle speed is less than TS1 (181). If the vehicle speed is not less than TS1 (181), the vehicle continues driving with AETSO enabled (180). If the vehicle speed is less than TS1 (181), the device gathers information from the vehicle computer port to determine if the engine is on (182). If the engine is not on (182), the device gathers information from the vehicle computer port to determine if the foot brake is engaged (186). If the foot brake is engaged (186), the engine stays off (187). If the foot brake is not engaged (186), the device commands an engine restart (189) and the transmission returns to appropriate gear (179). If the engine is on (182), the device gathers information from the vehicle computer port to determine if the foot brake is engaged (183). If the foot brake is not engaged (183), the vehicle continues driving with AETSO enabled (180). If the foot brake is engaged (183), the device gathers information from the vehicle computer port to determine if the vehicle parameters are appropriate for an engine shut-off (184). If the parameters are not appropriate for engine shut-off (184), the device may issue an error alert (190), and the vehicle continues driving with AETSO enabled (180). If the parameters are appropriate for engine shut-off (184), the device optionally commands the transmission to neutral (185) and then commands the engine to shut-down (185) after an optional programmable time delay (185). After the engine has been shut-off (185), the device gathers information from the vehicle computer port to determine if the foot brake is engaged (186). If the foot brake is engaged (186), the engine stays off (187). If the foot brake is not engaged (186), the device commands an engine restart (189) and the transmission is returned to appropriate gear (191).

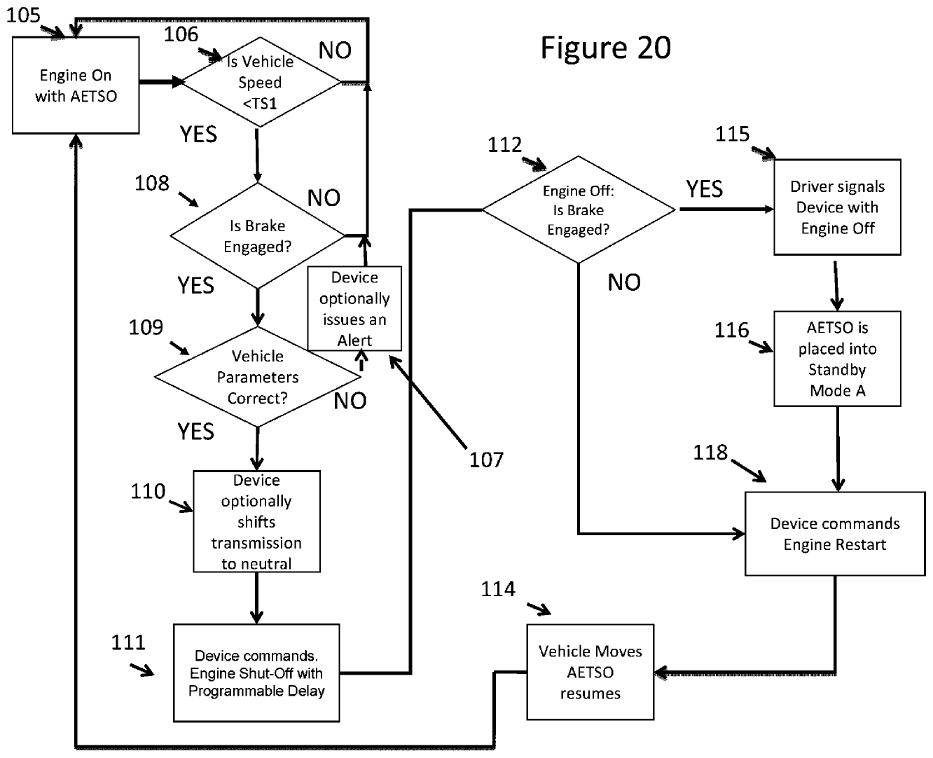

FIG. 20 illustrates a block diagram of a system which provides automatic engine turn-on and shut-off of the engine with driver input (Standby Mode A). The “Automatic Engine Turn On and Shut Off” (AETSO) enabled with the engine on (105). The device gathers information from the vehicle computer port to determine if the vehicle speed is less than TS1 (106). If the vehicle speed is not less than TS1 (106), the vehicle continues with AETSO enabled (105). If the vehicle speed is less than TS1 (106), the device gathers information from the vehicle computer port to determine if the foot brake is engaged (108). If the foot brake is not engaged (108), the vehicle continues with AETSO enabled (105). If the foot brake is engaged (108), the device gathers information from the vehicle computer port to determine if the vehicle parameters are appropriate for engine shut-off (109). If the vehicle parameters are not appropriate for engine shut-off (109), the device may issue an alert (107), and the vehicle continues with AETSO enabled (105). If the vehicle parameters are appropriate for engine shut-off (109), the device optionally commands the transmission to neutral (110) and commands engine shut-off (111) after a programmable delay (111). After the engine has been shut-off (111), the device gathers information from the vehicle computer port to determine if the foot brake is engaged (112). If the foot brake is engaged (112), the device waits for a signal from the driver with the engine off (115). If the driver signals the device (115), AETSO is placed in Standby Mode (116), and the device commands an engine restart (118). The vehicle moves (114), and AETSO resumes (114). If the foot brake is not engaged (112), the device commands an engine restart (118) and an appropriate gear is selected (118).

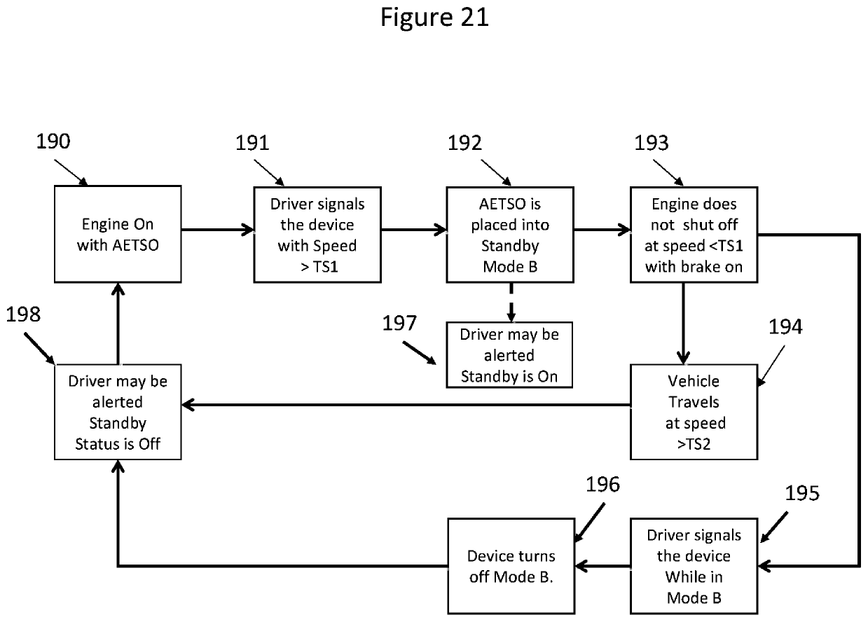

FIG. 21 illustrates a block diagram of a system for an automatic transmission vehicle that provides “Automatic Engine Turn On and Shut Off” (AETSO) having Standby Mode B. The vehicle is operating in the AETSO (190). The driver signals the device while the vehicle is traveling at a speed greater than TS1 (191). AETSO is placed in Standby Mode B (192), and an alert may be issued (197). In Standby Mode (B), the engine does not shut-off if the foot brake is on and the vehicle speed is less than TS1 (193). When normal driving is resumed and the vehicle speed is greater than TS2 (194), AETSO is restored (190). TS2 is a variable of speed that may be set by the driver or device. It is generally between 2.0 mph and 30 mph. The driver may receive a status alert (198). If the driver signals the device while in Standby Mode B (195), AETSO resumes and the device, via the communicator, turns off Standby Mode B (196). The driver may receive an alert of the status (198).

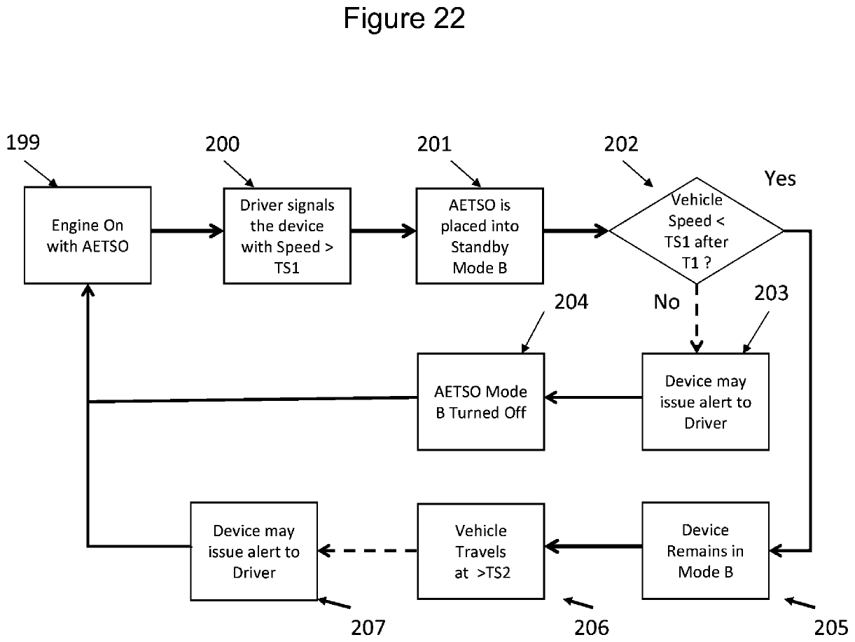

FIG. 22 illustrates a block diagram of a system used in an automatic transmission vehicle that provides “Automatic Engine Turn On and Shut Off” (AETSO) having Standby Mode B and a timer feature. The vehicle is operating in AETSO Standby Mode B (199). The driver signals the device while the vehicle is traveling at a speed greater than TS1 (200). AETSO is placed in Standby Mode B (201). In Standby Mode (B), the engine does not shut-off if the foot brake is on and the vehicle speed is less than TS1. The device gathers information from the computer port and determines if the vehicle speed has dropped below TS1 within a predetermined time T1 (202). T1 is a variable of time which may be set by the driver or device. It is generally between 2.0 seconds and 2 minutes. If the vehicle speed drops below TS1 within the predetermined time T1 (202), the vehicle remains in Standby Mode B (205). When normal driving is resumed and the vehicle speed is greater than TS2 (206), AETSO is restored (199). The driver may receive a status alert (207). If the vehicle speed does not drop below TS1 within the predetermined time T1 (202) the Standby Mode B is turned off (204) AETSO is restored (199). The driver may receive an alert of the status (203).

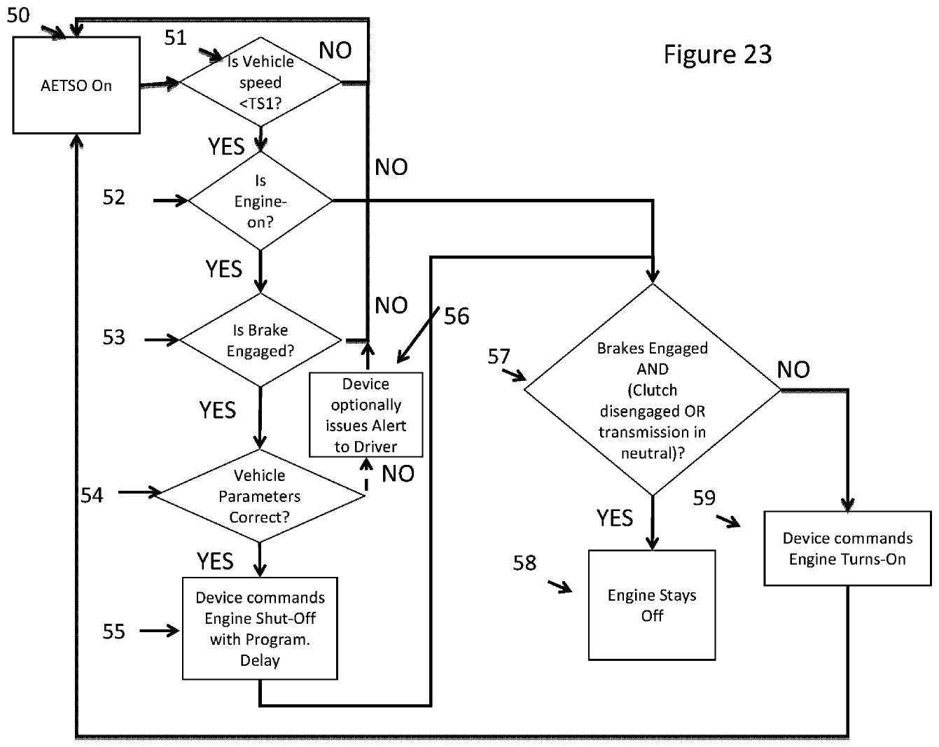

FIG. 23 shows a block diagram of a system that provides “Automatic Engine Turn On and Shut Off” (AETSO) of the engine without driver input in a vehicle with a manual transmission. AETSO is enabled (50). The device gathers information from the vehicle computer port to determine if the vehicle speed is less than TS1 (51). If the vehicle speed is not less than TS1 (51), the vehicle continues driving with AETSO enabled (50). If the vehicle speed is less than TS1 (51), the device gathers information from the vehicle computer port to determine if the engine is on (52). If the engine is not on (52), the device gathers information from the vehicle computer port to determine if the foot brake is engaged and if the clutch is disengaged or the transmission in neutral (57). If the foot brake or transmission is engaged (57), the engine stays off (58). If the foot brake is not engaged (57), the device commands engine turn-on (59) when the transmission is not engaged. If the engine is on (52), the device gathers information from the vehicle computer port to determine if the foot brake is engaged (53). If the foot brake is not engaged (53), the vehicle continues driving with AETSO enabled (50). If the foot brake is engaged (53), the device gathers information from the vehicle computer port to determine if the vehicle parameters, including the clutch being disengaged or transmission in neutral, are appropriate for an engine turn-off (54). If the parameters are not appropriate for engine shut-off (54), the device may issue an error alert (56), and the vehicle continues driving with AETSO enabled (50). If the parameters are appropriate for engine shut-off (54), the device commands engine shut-off after an optional programmable delay (55). After the engine has been shut-off (55), the device gathers information from the vehicle computer port to determine if the foot brake or transmission is engaged (57). If the foot brake and transmission are engaged the engine stays off (58). If the foot brake is not engaged (57), the device commands engine turn on the next time the transmission is not engaged (59).

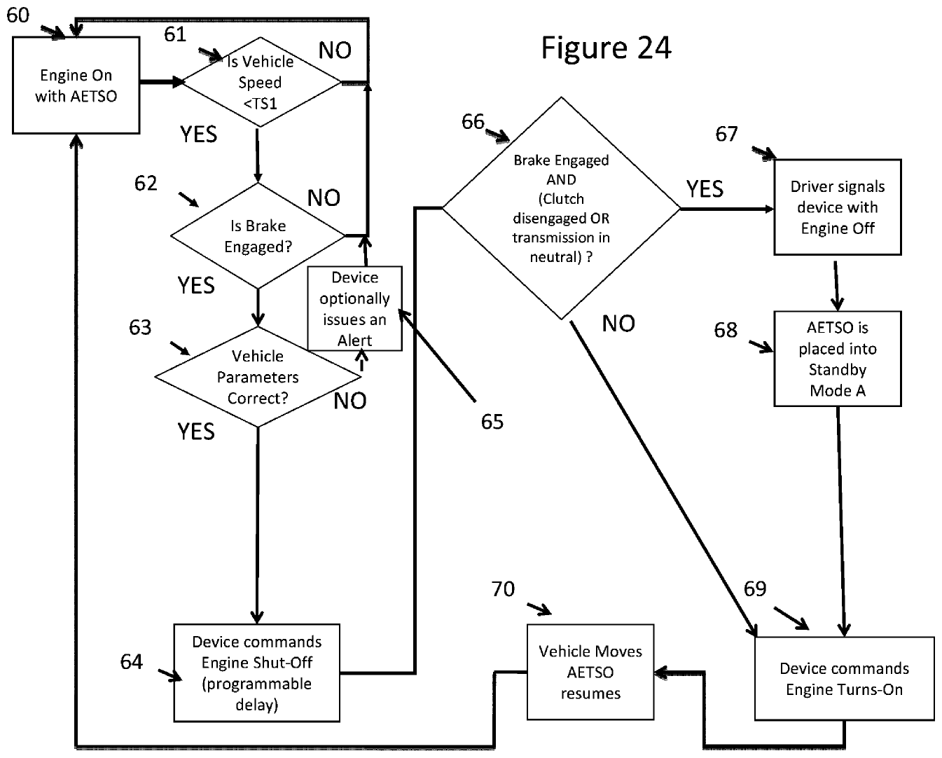

FIG. 24 shows a block diagram of a system that provides “Automatic Engine Turn On and Shut Off” (AETSO) of the engine with driver input (Standby Mode A) for a vehicle with a manual transmission. AETSO is enabled with the engine on (60). The device gathers information from the vehicle computer port to determine if the vehicle speed is less than TS1 (61). If the vehicle speed is not less than TS1 (61), the vehicle continues with AETSO enabled (60). If the vehicle speed is less than TS1 (61), the device gathers information from the vehicle computer port to determine if the foot brake is engaged (62). If the foot brake is not engaged (62), the vehicle continues with AETSO enabled (60). If the foot brake is engaged (62), the device gathers information from the vehicle computer port to determine if the vehicle parameters are appropriate (63) including if the clutch is disengaged or transmission is in neutral (63). If the vehicle parameters are not appropriate for engine shut-off (63), the device may issue an alert (65), and the vehicle continues with AETSO enabled (60). If the vehicle parameters are appropriate for engine shut-off (63), the device commands engine shut-off (64) after a programmable delay (64). After the engine has been shut-off (64), the device gathers information from the vehicle computer port to determine if the foot brake is engaged and the clutch is deployed or transmission is neutral (66). If the foot brake is engaged (66), the device optionally waits for an input from the driver with the engine off (66). If the driver signals the device with the engine off (67), AETSO is placed in Standby Mode A (68). When the transmission is not engaged (66), the device then commands the engine to turn on (69). The vehicle moves and AETSO resumes (70). If the foot brake is released while the transmission or clutch is disengaged (66), the device commands an engine restart, and AETSO resumes when the vehicle moves (70).

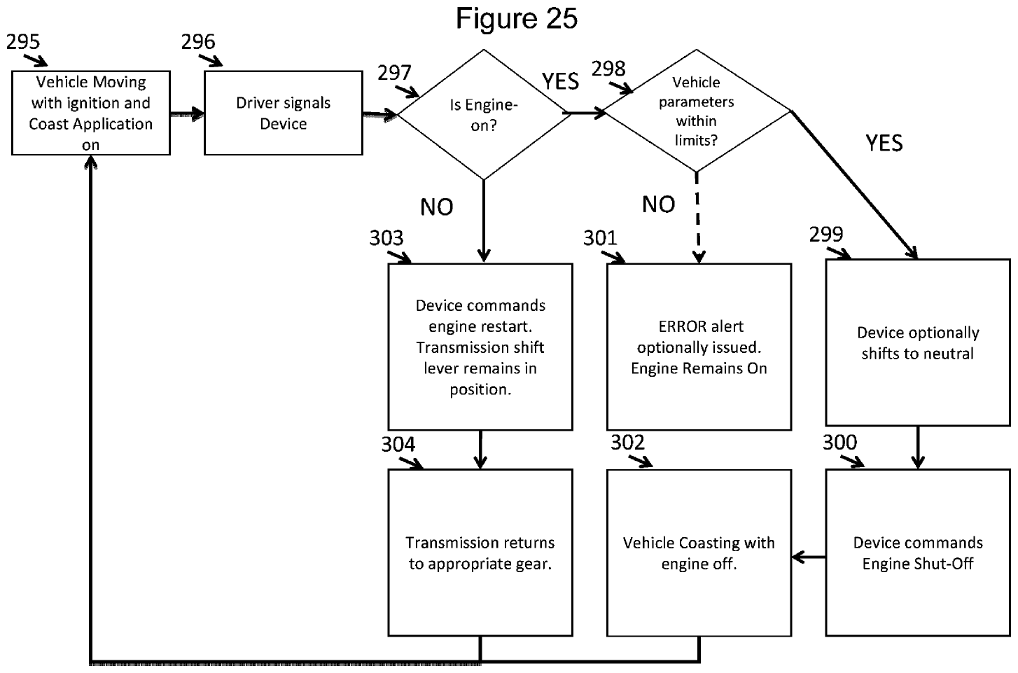

FIG. 25 shows a block diagram of a system for allowing a vehicle with an automatic transmission to coast. Initially, the vehicle is moving with ignition on (295). The driver signals the device (296). The device gathers information from the vehicle computer port and determines if the engine is on (297). If the engine is off (297), the device commands an engine restart (303) and the transmission returns to appropriate gear (304). If engine is running (297), the device gathers information from the vehicle computer port and determines if the vehicle parameters are within limits (298). If the vehicle parameters are not within limits (298), the device optionally generates an error message (301), and the engine remains on (301). If the vehicle parameters are within limits (298), the device commands the device optionally changes the transmission to neutral (299) and commands the engine to shut-off (300). The vehicle is coasting (302) and moving with ignition on (295).

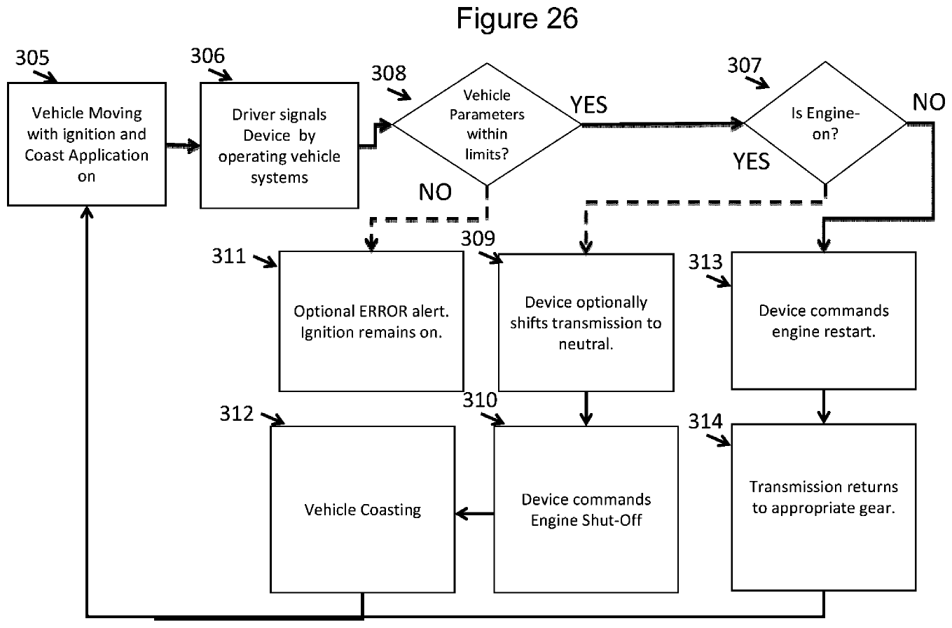

FIG. 26 shows a block diagram of a system for allowing a vehicle with an automatic transmission to coast. Initially, the vehicle is moving (305). The driver signals the device by operating the vehicle systems (306). The device gathers information from the vehicle computer port and determines if the vehicle parameters are within limits (308). If the vehicle parameters are not within limits (308), the device optionally generates an error message (311), and the ignition remains on (311). If the parameters are within limits (308), the device gathers information from the vehicle computer port and determines if the engine is running (307). If the engine is not running (307), the device commands an engine restart (313). The transmission returns to the appropriate gear (314). If the engine is running (307), the device optionally commands the transmission to neutral (309) and the engine to shut-off (310). The vehicle is coasting (312) with ignition on (305).

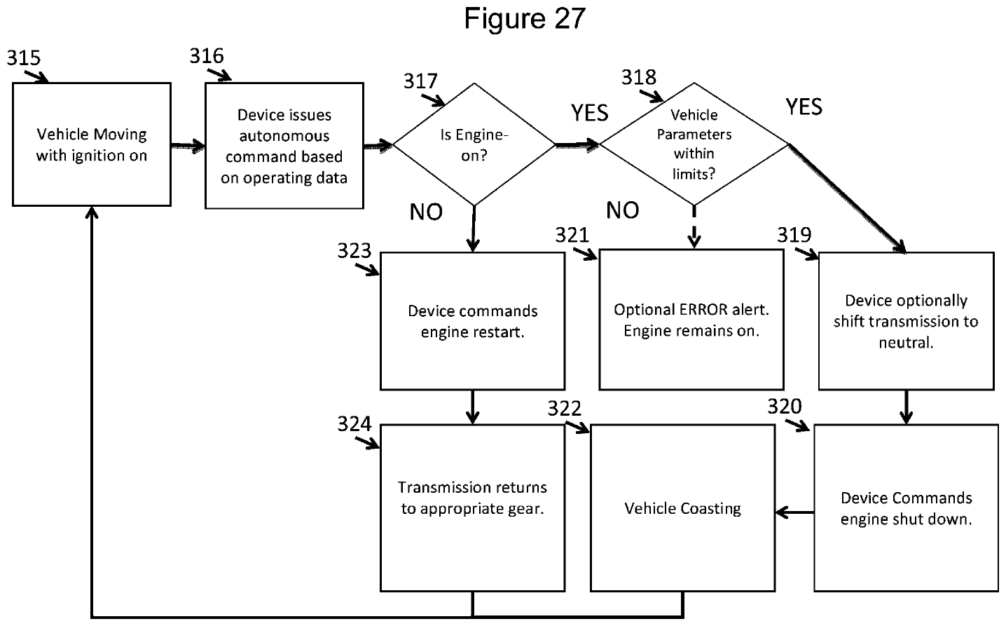

FIG. 27 illustrates a block diagram of a system for allowing a vehicle with an automatic transmission to coast as directed by the device. Initially, the vehicle is moving (315). The device monitors vehicle operating parameters and receives data requiring a change of engine state (316). The device gathers information from the vehicle computer port and determines if the engine is running (317). If the engine is not running (317), the device commands an engine restart (323) and the transmission returns to appropriate gear (324). If engine is running (317), the device gathers information from the vehicle computer port and determines if the vehicle parameters are within limits (318). If the vehicle parameters are not within limits (318), the device generates an optional error message (321), and the engine remains on (321). If the vehicle parameters are within limits (318), the device optionally shifts the transmission to neutral (319) and commands the engine shut-off (320). The vehicle is coasting (322).

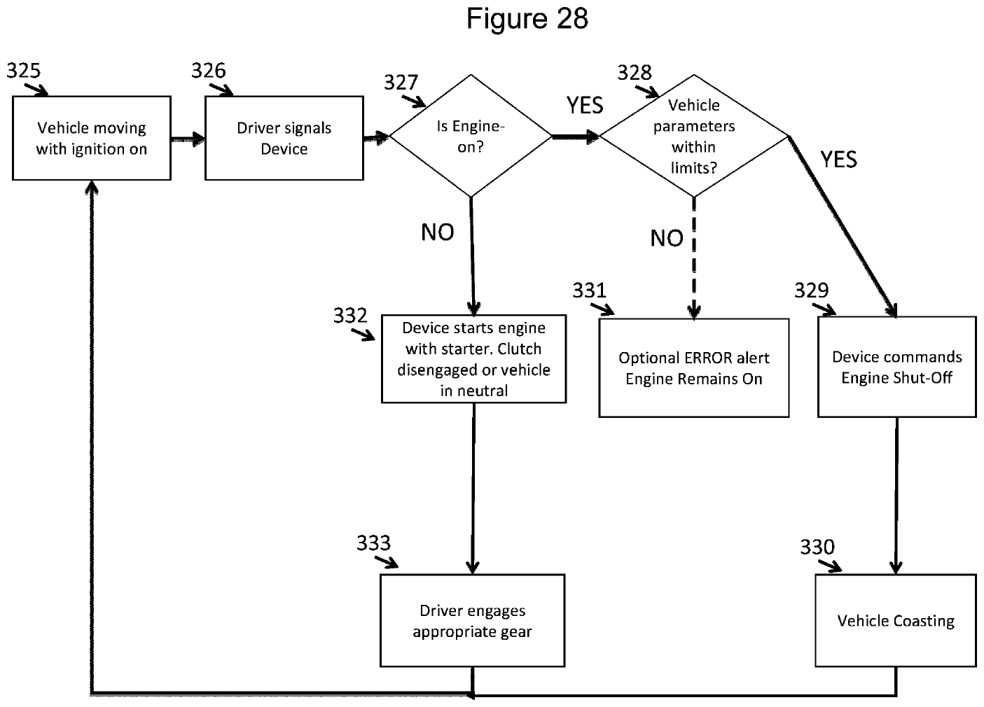

FIG. 28 illustrates a block diagram of a system for allowing a vehicle with a manual transmission to coast. The vehicle is moving with ignition on (325). The driver signals the device (326). The device gathers information from the vehicle computer port and determines if the engine is running (327). If the engine is not running (327), and the clutch is not engaged or the vehicle is in neutral, the system starts the engine with the electric starter (332). The driver engages the appropriate gear (333) and the vehicle continues moving (325). If the engine is running (327), the device gathers information from computer port and determines if the vehicle parameters are within limits (328). If the vehicle parameters are not within limits (328), the device generates an optional error message, and the engine does not shut-off (331). If the vehicle parameters are within limits (328), including the clutch deployed or the vehicle in neutral, the device commands engine shut-off (329). The vehicle is coasting (330).

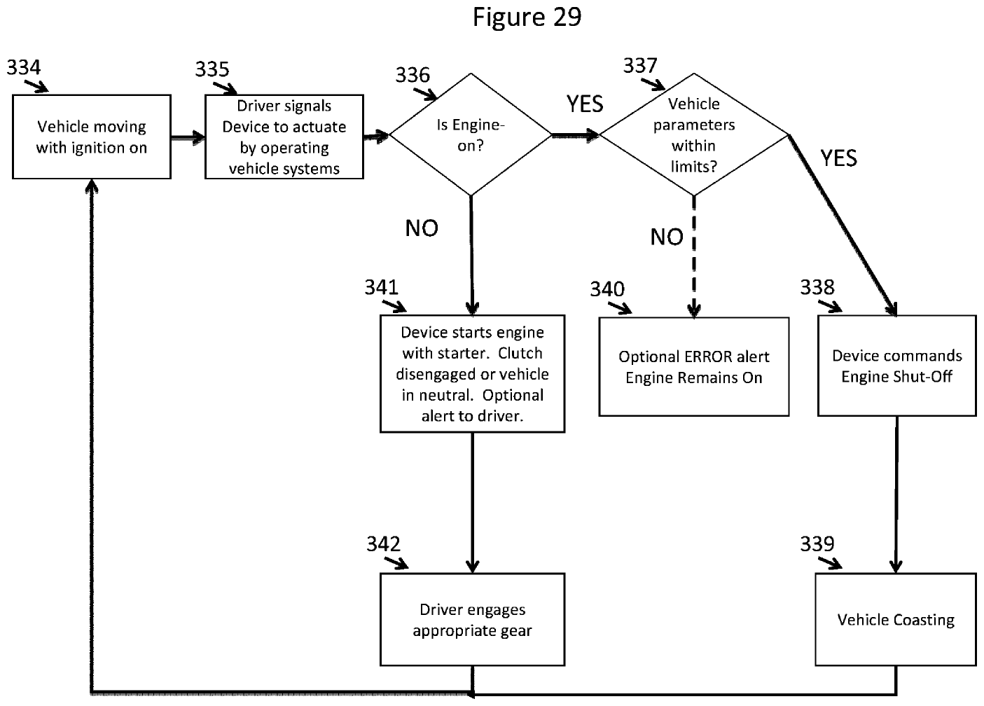

FIG. 29 illustrates a block diagram of a system for allowing a vehicle with a manual transmission to coast. The vehicle is moving with ignition on (334). The driver operates vehicle systems that the device interprets as a signal (335). The device gathers information from the vehicle computer port and determines if the engine is running (336). If the engine is not running (336), the driver disengages the clutch or places the vehicle in neutral (341), and the device restarts the motor with the starter motor (341). The driver engages the appropriate gear (342), and the vehicle continues driving (334). If the engine is running (336), the device gathers information from the computer port and determines if the vehicle parameters are within limits (337). If the vehicle parameters are not within limits (337), the device generates an optional error message and the engine does not shut-off (340). If the vehicle parameters are within limits (337) and the clutch is disengaged or transmission is in neutral (341), the device commands engine shut-off (338). The vehicle is coasting (339).

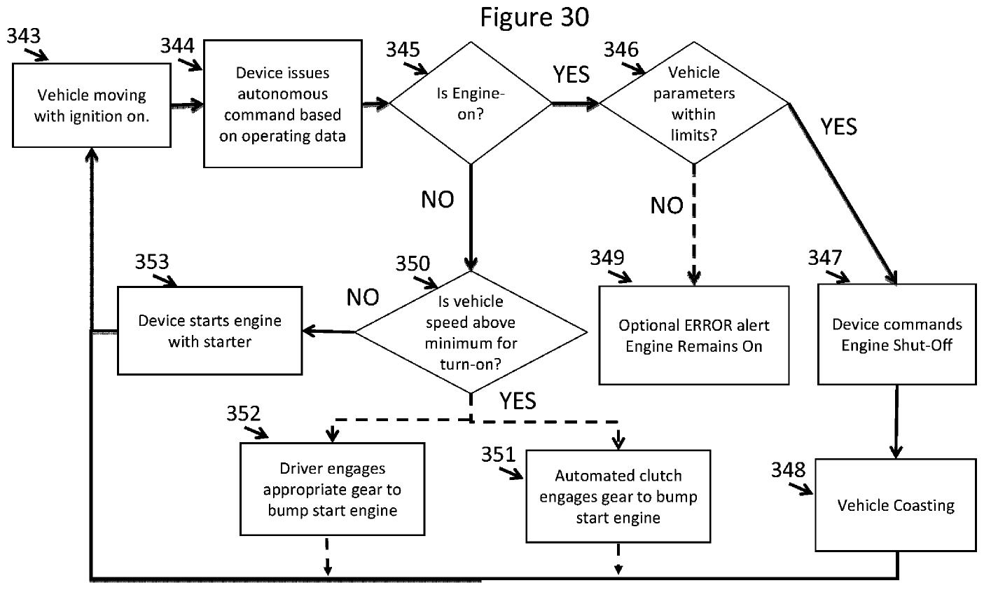

FIG. 30 illustrates a block diagram of a system for allowing a vehicle with a manual transmission to coast. The vehicle is moving (343). The device monitors vehicle operating parameters and receives data necessitating a change in engine state (344). The device gathers information from the vehicle computer port and determines if the engine is running (345). If the engine is not running (345), the device gathers information from the vehicle computer port and determines if the vehicle speed is above the minimum speed required for engine restart by the motion of the vehicle (350). If the vehicle speed is below the minimum needed to restart the engine (350), the system starts the engine with the electric starter (353). The vehicle continues driving (343). If the vehicle speed is above that required for starting due to vehicle motion (350), either the driver engages the appropriate gear to start the engine (352) or an automated clutch engages the appropriate gear to start the engine (351). The vehicle continues driving (343). If the engine is running (345), the device gathers information from the computer port and determines if the vehicle parameters are within limits (346). If the vehicle parameters are not within limits (346), the device generates an optional error message and the engine remains on (349). If the vehicle parameters are within limits (346), the device commands engine shut-off (347). The vehicle is coasting (348).

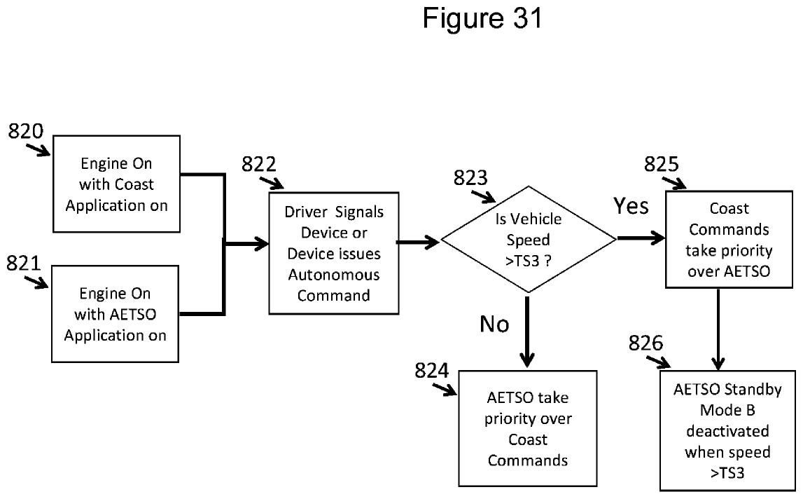

FIG. 31 shows a block diagram of the “Automatic Engine Turn On and Shut-off (AETSO) combined with the Coast Mode. The engine is on with both the coast (820) and the AETSO engaged (821). The driver signals the device (822) or the device issues an autonomous command using the communicator in both circumstances (822). The device gathers information from the vehicle computer port to determine if the speed of the vehicle is greater than a set speed TS3 (823). TS3 is a variable of speed which may be set by the driver or device. It is generally between 1.0 mph and 10.0 mph. If the vehicle speed is greater than TS3 (825), the coast mode takes priority over the AETSO (825), and the AETSO is deactivated (826). If the vehicle speed is not greater than TS3 (825), the AETSO commands take priority over the Coast Mode (824).

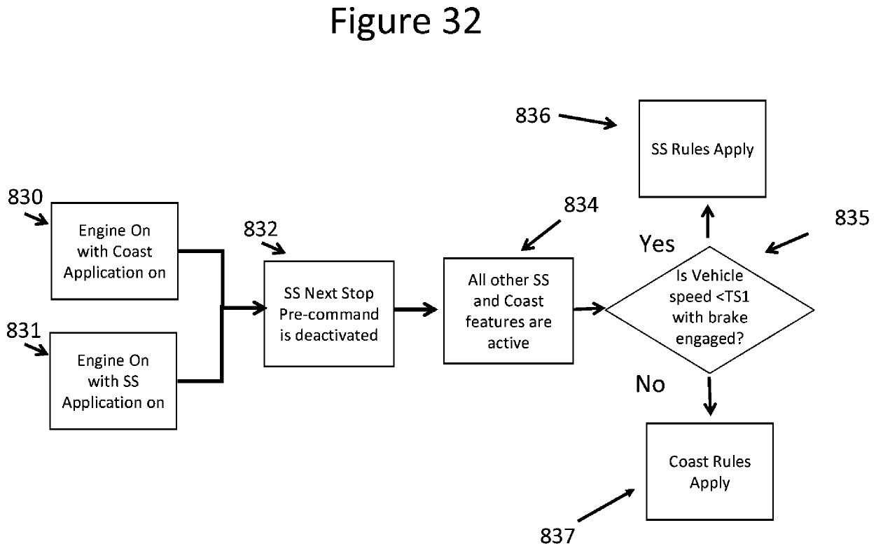

FIG. 32 shows a block diagram of a system combining the Start Stop Application combined with the Coast Application. The engine is on with both the Coast Application (830) and the Start Stop (SS) Applications (831) on. In this case, the start stop's feature for next stop pre-command is deactivated (832). All other start stop and coast commands remain active (834). The device gathers information to determine if the vehicle speed is less than TS1 (835) and if the foot brake is engaged (835). If the vehicle is at speed less than TS1 with the foot brake applied (835), then the SS commands apply (836). If the vehicle speed is above TS1 or at TS1 without the foot brake applied (835), then coast rules apply (837).

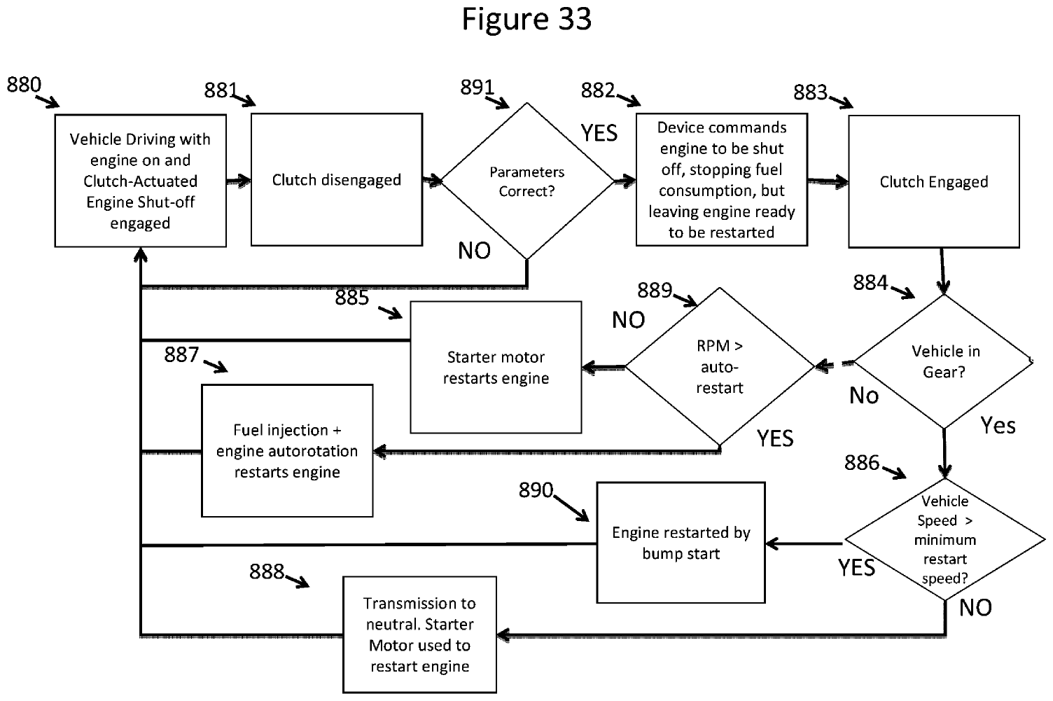

FIG. 33 shows a block diagram of a system that stops fuel use by the engine when the clutch is disengaged and can use the clutch as an input to command engine shut-off. The vehicle is driving with engine on and “Clutch Actuated Engine Shut-off” (CAESO) engaged (880). The driver or automatic clutch actuator disengages the clutch to actuate CAESO (881). The clutch is disengaged (881). The device checks appropriate parameters to determine if the parameters are appropriate for engine shut-off (891). If the parameters are not appropriate for engine shut-off (891), the vehicle continues driving with engine on and CAESO engaged (880). If the parameters are appropriate for engine shut-off (891), the engine is stopped but is ready to be restarted (882). If the engine is shut-off (882) and the driver engages the clutch (883), the device determines if the vehicle is in gear (884). If the vehicle is not in gear (884), the device determines if the engine speed is higher than the speed needed for an auto start (889). If the engine speed is not higher than the speed needed for an auto start (889), according to driver preference settings, the starter motor is used to restart engine (885) and the vehicle continues driving with engine on and CAESO engaged (880). If the engine speed is higher than the speed needed for an auto start (889), the fuel injection is turned on and engine autorotation restarts engine (887). The vehicle continues driving with engine on and CAESO engaged (880). If the vehicle is in gear (884), the device determines if the vehicle speed is greater than the minimum restart or bump start speed (886). If the vehicle speed is greater than the minimum restart or bump start speed (886), the engine is restarted by bump start (890), and the vehicle continues driving with engine on and CAESO engaged (880). If the vehicle speed is not greater than the minimum restart or bump start speed (886), the transmission is placed in neutral by the driver (888), and the engine is restarted by the starter motor by the driver (888) signaling the device. The vehicle continues driving with engine on and CAESO engaged (880).

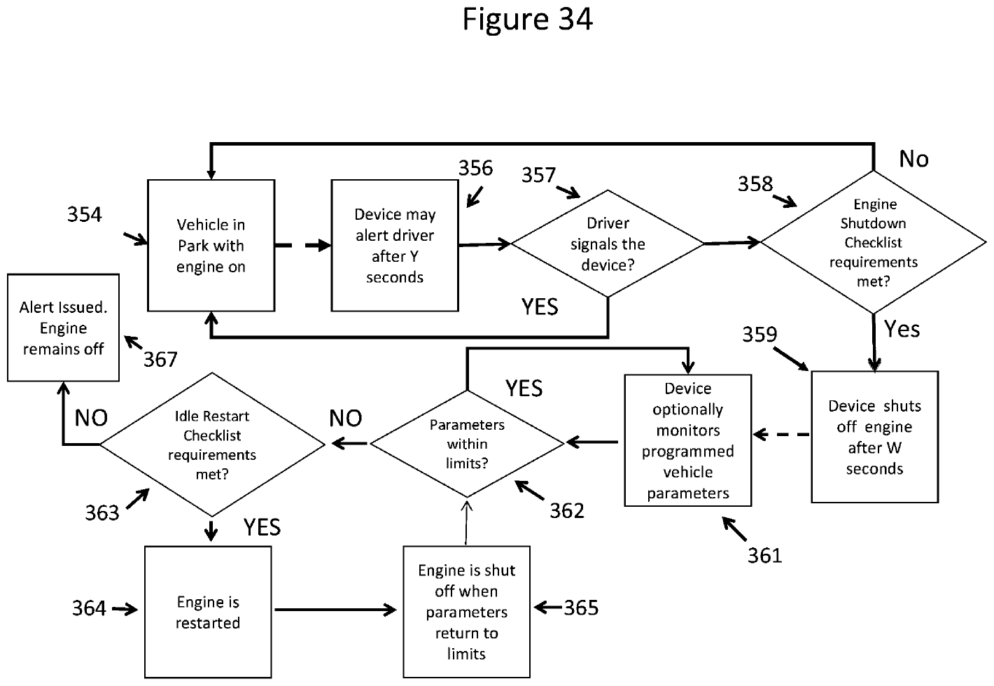

FIG. 34 illustrates a block diagram of an anti-idle system for an automatic transmission vehicle. The vehicle is in park with the engine on (354). The device issues an alert to the driver in Y seconds (356). If the driver signals the device prior to engine shut-off (357), the vehicle continues to idle in park (354). If the driver does not signal the device (357), the device checks the vehicle parameters as defined by the Engine Shutdown Checklist (358). If the parameters are met (358), the engine is shut-off after W seconds (359). W is a variable of time that may be set by the driver or device. It is generally between 3 seconds and 10 minutes. If the parameters are not within limits (358), the engine remains on (354). If the engine is shut-off (359) the device monitors vehicle parameters (361). If the parameters are within limits (362), the device continues monitoring the parameters (361). If the parameters are not within limits (362), the device determines if the Engine Restart Checklist requirements are met (363). If the Idle Restart Checklist requirements are not met (363), the device issues an alert and the engine remains off (367). If the Idle Restart Checklist parameters are met (363) the engine is restarted (364). The engine is shut-off when the parameters return to within limits (365), and the device continues to monitor vehicle parameters (362).

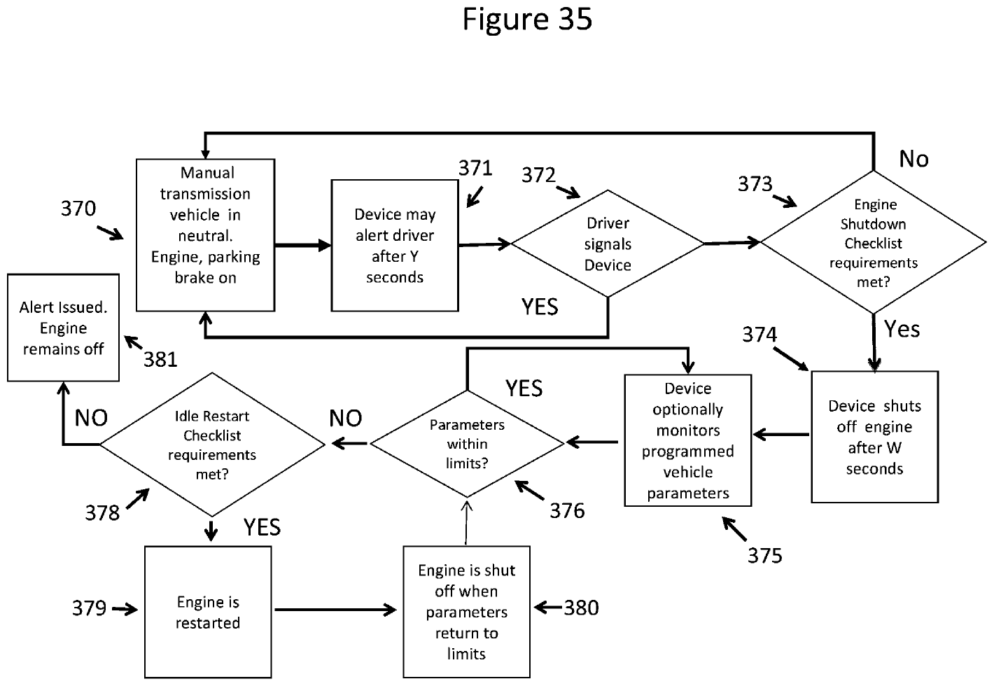

FIG. 35 illustrates a block diagram of an anti-idle system for a manual transmission vehicle. The vehicle is in neutral with the engine and parking brake on (370). The device issues an alert to the driver in Y seconds (371). If the driver signals the device (372) prior to engine shut-off, the vehicle continues to idle in park (370). If the driver does not signal the device (372), the device checks the vehicle parameters as defined by the Engine Shutdown Checklist (373). If the Engine Shutdown Checklist parameters are met, the engine is shut-off after W seconds (374). If the parameters are not within limits (373), the engine remains on (370). If the engine is shut-off (374), the device monitors vehicle parameters (375). If the parameters are within limits (376), the device continues monitoring the parameters (375). If the parameters are not within limits (376), the device determines if the Engine Restart Checklist requirements are met (363). If the Engine Restart Checklist requirements are not met (378), the device issues an alert and the engine remains off (381). If the Engine Restart Checklist parameters are met (378), the engine is restarted (379). The engine is shut-off when the parameters return to limits (380).

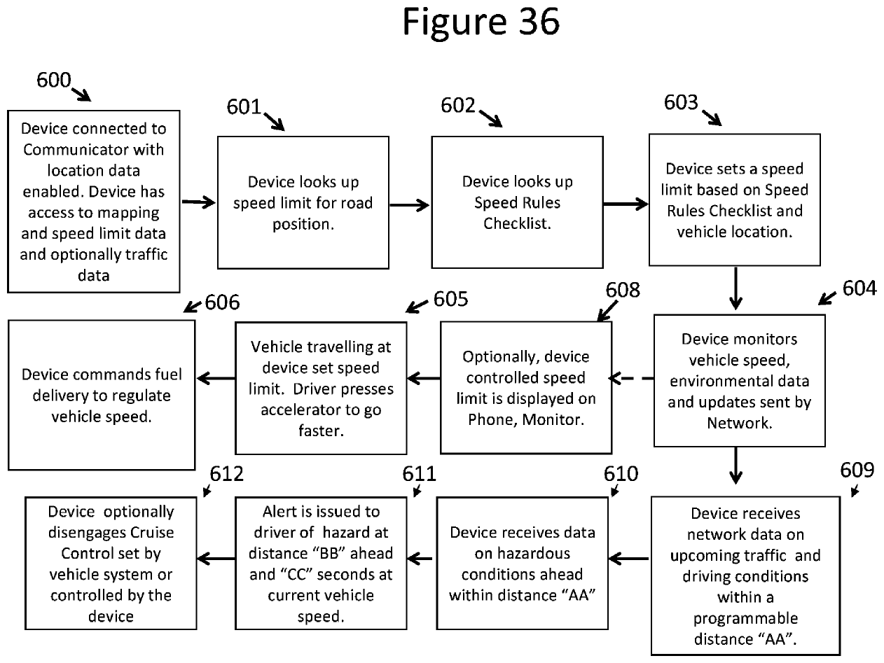

FIG. 36 shows a block diagram of a system that can act as a governor to limit the vehicle's speed and automatically disengage cruise control based on location on other forms of data. The device has access to the vehicle's location and to data that provides speed limit based on vehicle location (600). The device determines the speed limit for the vehicle's given location (601). The device looks up the Speed Rules Checklist (602) (see FIG. 11). The device then sets a speed limit for the vehicle based on both the road location and the Speed Rules Checklist parameters (603). The device monitors the vehicle speed and for any updated data sent by an external network (604) or derived from environmental or traffic conditions (604). Optionally, the maximum speed limit allowed by the device is displayed on a display device such as a monitor, or smart phone (608). The vehicle is travelling at the maximum speed limit allowed by the device (605). The driver presses accelerator commanding greater vehicle speed (605). The device limits vehicle speed to the maximum by commanding the vehicle controller to limit the speed of the vehicle (606). The device receives network data on upcoming traffic and driving conditions within a programmable distance “AA” (609). The device receives information that hazardous conditions are ahead within the distance defined by parameter “AA” (610). AA is a variable of distance, which may be set by the driver or device. It is generally between 0.1 miles and 10 miles. The device issues an alert to driver that the vehicle is approaching a hazard (611). Device informs driver of distance to hazard “BB” (611) and time to hazard at current vehicle speed “CC” (611). The device optionally disengages Cruise Control set by the vehicle system or controlled by the device (612).

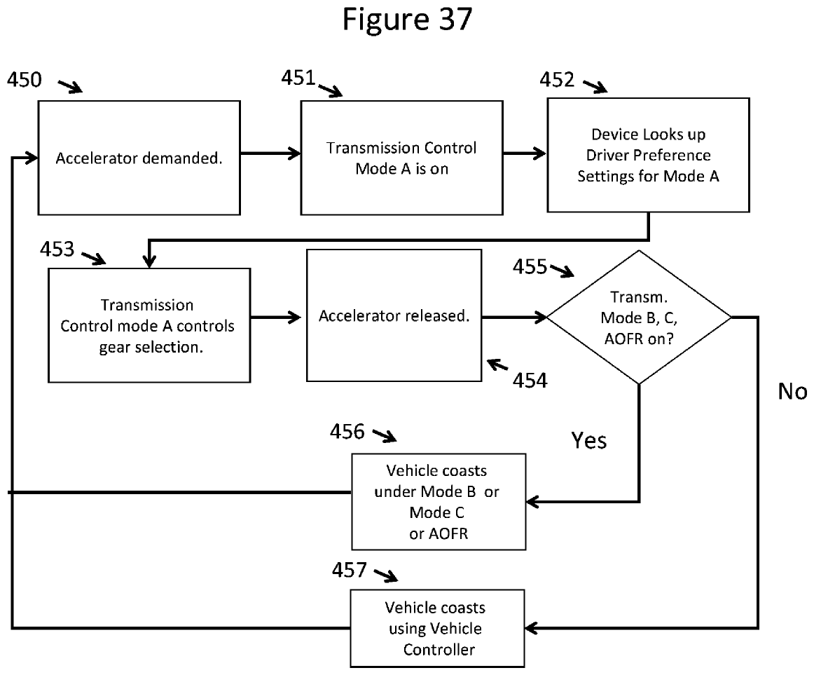

FIG. 37 shows a block diagram of an embodiment of the system switching between Transmission Control Mode A, Transmission Control Mode B, Transmission Control Mode C or “Accelerator Off Fuel Reduction” (AOFR). The accelerator is demanded (450) with Transmission Control Mode A turned on (451). The device looks up the driver preference settings (452) and then runs Transmission Control Mode A application module to select the appropriate gear (453). The accelerator is released (454) and the device checks if Transmission Control Mode B, Transmission Control Mode C, or AOFR has been selected as “on” by the driver (455). If “yes” (455), the proper application module is selected (456). If no application mode is selected as “on” (455), the vehicle coasts under the control of the vehicle controller (457). The accelerator is demanded again (450) and Transmission Control Mode A is reinstated (451).

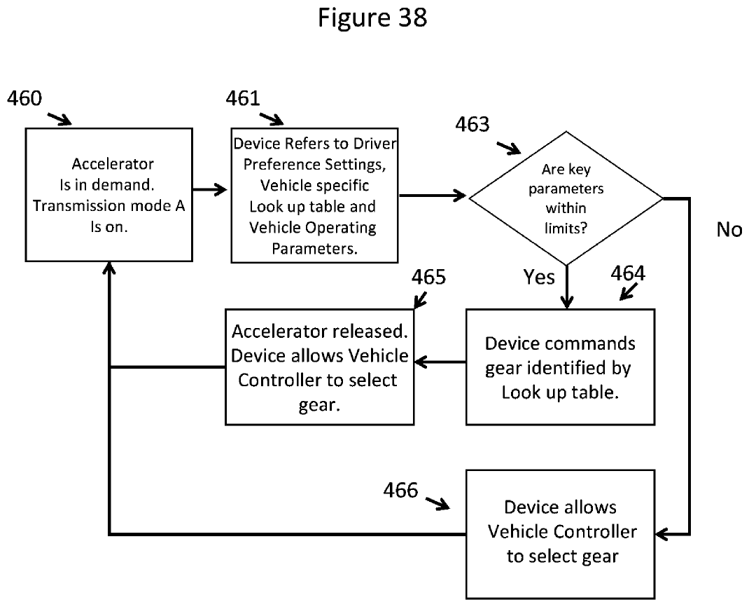

FIG. 38 illustrates the “Transmission Control Mode A” application module for an automatic transmission vehicle. Transmission Control Mode A application module is active when the accelerator is demanded (460). When the accelerator is used, the device selects the appropriate gear by making calculations based on driver preference settings for Transmission Control Mode A (461), the vehicle operating parameters (461) and a vehicle specific look up table (461). The device next checks the vehicle operating parameters to determine if they are within limits (463). If “no” (466), the device allows the vehicle controller to select the appropriate gear (466). If “yes” (464), the device commands a gear (464) based on driver preference settings, operating parameters and vehicle specific look up table (464). When the accelerator is released (465), the device allows vehicle controller to select appropriate gear (465).

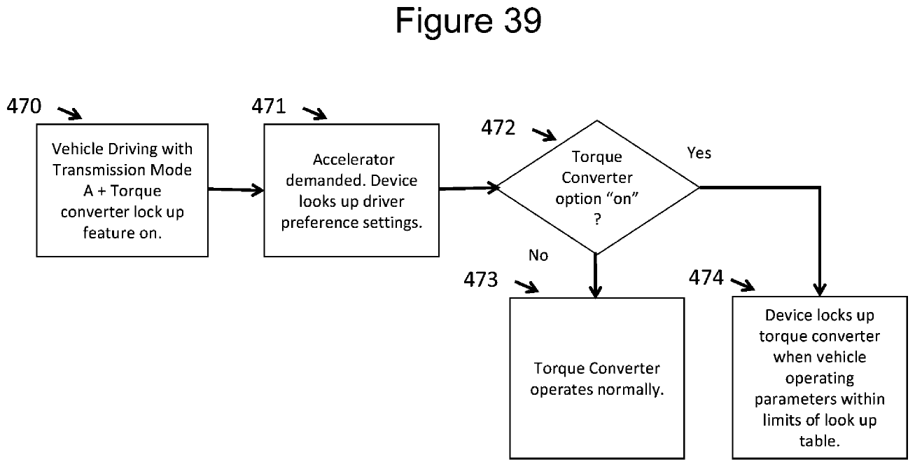

FIG. 39 illustrates the “Transmission Control Mode A” selected with the torque converter lock up option. The vehicle is driving with Transmission Control Mode A on (470). The accelerator is demanded and device looks up driver preference settings (471). If driver preference requests the torque converter lock up option (472), torque converter lockup is used during acceleration if vehicle operating parameters within specifications defined by a vehicle specific look up table (474). If torque converter preference setting is not requested (472), the device does not command torque converter lock up when accelerator is in demand (473).

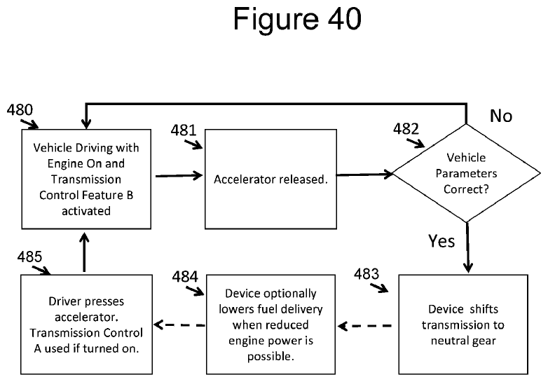

FIG. 40 illustrates a block diagram of a system having “Transmission Control Feature (Mode) B” application module for use in an automatic transmission vehicle. The vehicle is driving with the engine on and Transmission Control Feature B activated (480). If the accelerator is released (481), the device gathers information to determine if the vehicle operating parameters are within limits (482). If the vehicle operating parameters are not within limits (482), the vehicle continues driving with Transmission Control Feature B activated (480). If the operating parameters are within limits (482), the device selects neutral gear (485). Optionally, the device may lower fuel delivery to the engine (484). If the driver presses the accelerator or vehicle operating parameters exceeded, the vehicle returns to normal driving with Transmission Control Feature B activated (483).

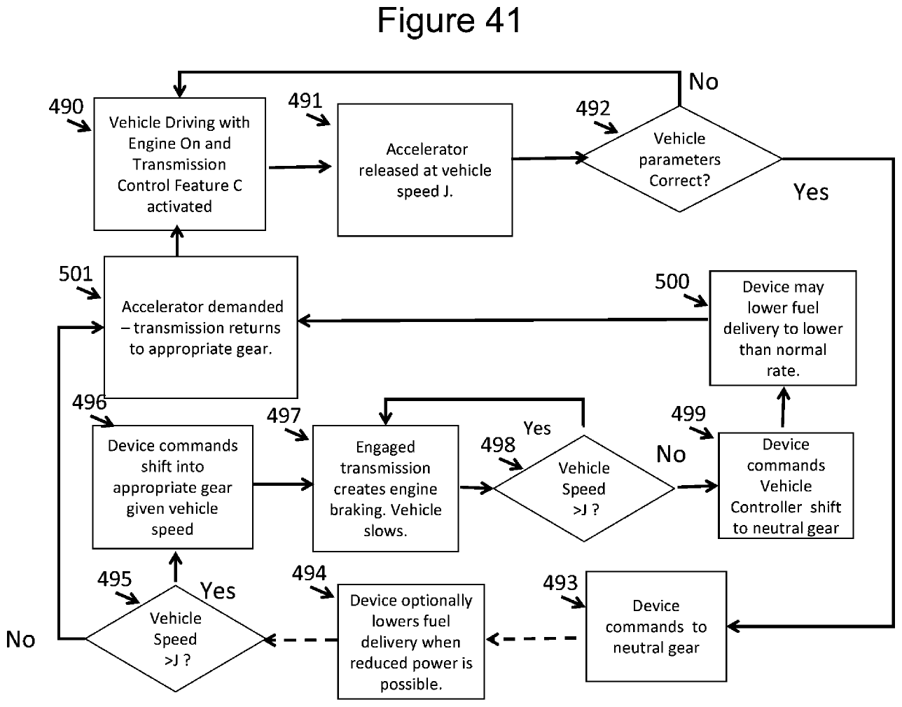

FIG. 41 illustrates “Transmission Control Feature (Mode) C” for use in an automatic transmission vehicle. The vehicle is driving with engine on and Transmission Control Feature C activated (490). The accelerator is released at speed J (491). J is defined at a speed typically between 1 mph-90 mph. The device gathers information from the vehicle computer port to determine if the vehicle operating parameters are within limits (492). If the operating parameters are not within limits (492), the device takes no action (490). If the parameters are within limits (492), the device commands a shift to neutral (493). The device may lower fuel delivery to lower than the vehicle's normal rate (494). The device gathers information from the vehicle computer port to determine if the vehicle speed is greater than J, that is, the vehicle has accelerated while coasting (495). If the vehicle speed is not greater than J (495), the vehicle coasts until the accelerator is demanded (501). If the vehicle speed is greater than J (495), the device selects an appropriate gear and engages the transmission (496) creating engine braking if the driver does not wish to faster than J during vehicle coast (497). The device gathers information from the vehicle computer port to determine if the vehicle speed is greater than J (498). If the vehicle speed is not greater than J (498), the device commands a shift to neutral (499). The device may lower fuel delivery to a lower than normal rate (500). The accelerator is engaged and device selects an appropriate gear (501).

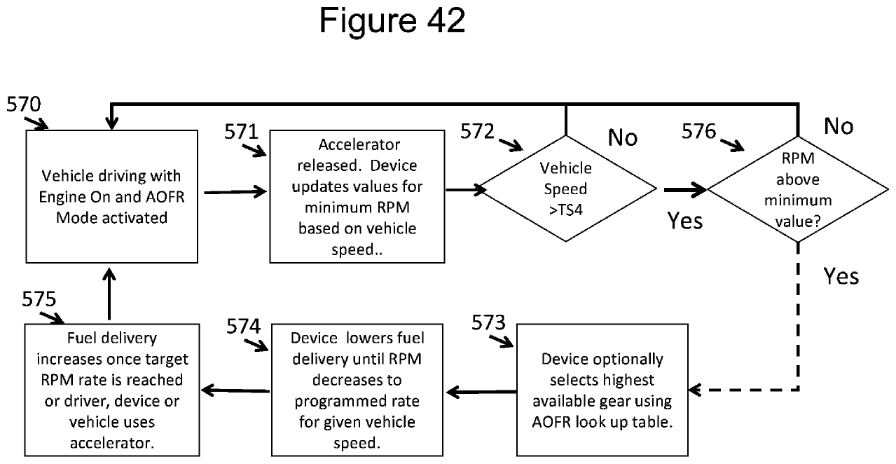

FIG. 42 shows a block diagram of a system that decreases fuel delivery to the engine when the accelerator is released and the transmission remains in gear. The vehicle, using either an automatic or a manual transmission, is driving with Accelerator Off Fuel Reduction (AOFR) application module turned on (570). The accelerator is released (571). The device makes calculation for threshold values for RPM based on vehicle speed using a look-up-table (571). The device determines if the vehicle speed is above the minimum speed requirement defined as variable TS4 (572). TS4 is a variable of speed that may be set by the driver or device. It is generally between 2 mph and 90 mph. If the vehicle speed is not greater than TS4 (572), the vehicle continues driving with AOFR application module activated (570). If the vehicle speed is above TS4 (572), the device checks if the RPMs are above the minimum value (576). If the RPMs are not above the minimum value (576), the vehicle continues driving with AOFR application module activated (570). If the RPMs are above the minimum value (576), the device optionally selects the highest available gear for the vehicle speed based on AOFR look up table (573). The device lowers the fuel rate delivery until the vehicle RPMs decrease to a programmable threshold level for a given vehicle speed (574). Fuel delivery is increased once the driver, the device or the vehicle systems demand the accelerator or the threshold level of RPMs is reached (575). The vehicle continues driving with AOFR activated (570).

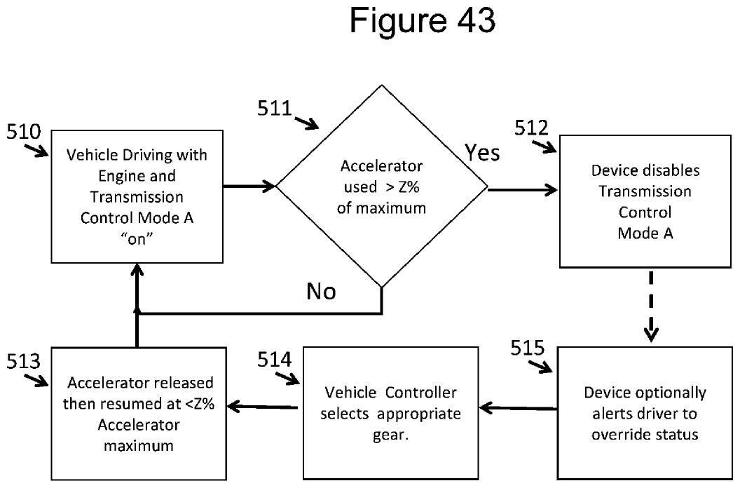

FIG. 43 illustrates a block diagram of a system having accelerator override of the Transmission Control Mode A. The vehicle is moving with the Transmission Control Mode engaged (510). The device monitors the accelerator to assess if accelerator demand is greater than Z % of maximum (511). It is generally between 20%-100% of maximum full pedal accelerator deflection. If the accelerator demand is not greater than Z % of maximum (511), the vehicle continues driving with Transmission Control Mode A on (510). If the accelerator is greater less than Z % of maximum (511), the device places Transmission Control Mode A into Standby Mode (512). The device alerts the driver as to Standby Mode status (513). The device allows the vehicle controller to set appropriate gear (514). The device monitors vehicle for accelerator position less than Z % of maximum (511). When the Accelerator position is less than Z % of maximum (511), the device gathers information from the computer port and commands the highest appropriate gear (514). Vehicle continues driving with Transmission Control application modules on (510).

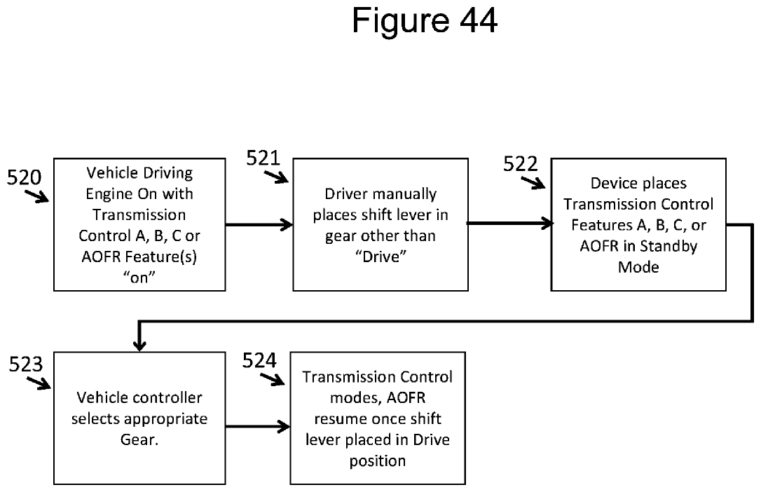

FIG. 44 illustrates a block diagram of a system that allows manual override of the Transmission Control Modes and Accelerator Off Fuel Reduction (AOFR). The vehicle is driving with an application associated with a Transmission Control Modes or AOFR engaged (520). The driver manually places shift lever in gear other than “Drive” (521). The device places Transmission Control Mode(s) and AOFR in Standby Mode (522). The vehicle controller shifts to appropriate gear (523). The Transmission Control Mode and AOFR may resume once shift lever is returned to the drive position (524).

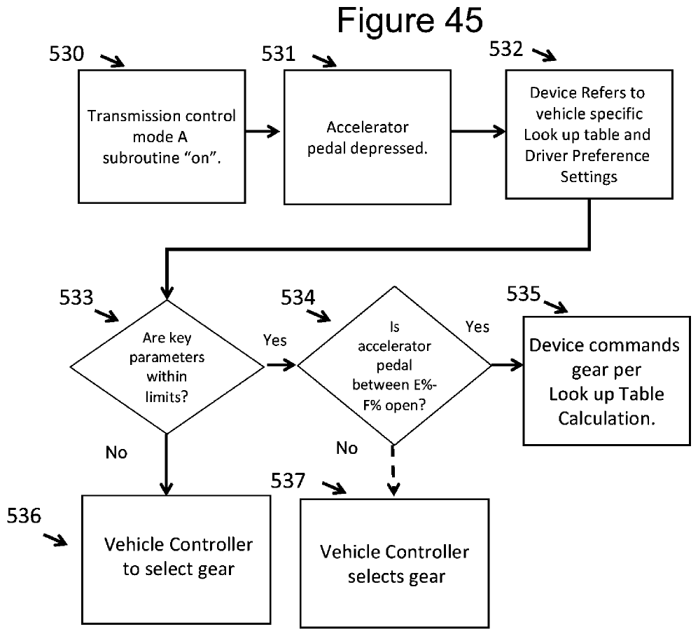

FIG. 45 illustrates a block diagram of Transmission Mode A Subroutine 1 that uses the accelerator pedal position to turn on Transmission Control Mode A. The Transmission Control Mode A application module is on (530) and the accelerator is demanded (531). To calculate appropriate gear, the device looks up driver preference settings for Transmission Control Mode A (532), the vehicle operating parameters (532) and a vehicle specific look-up table (532). The device next checks the vehicle operating parameters to determine if they are within limits (533). If “no” (533), the device allows the vehicle computer to select the appropriate gear (536). If “yes” (533), the device checks if the accelerator pedal position is between E % and F % deployed (534). If “yes” (534), the device commands gear selected by look-up table calculations (535). If “no” (534), the vehicle computer selects appropriate gear (537).

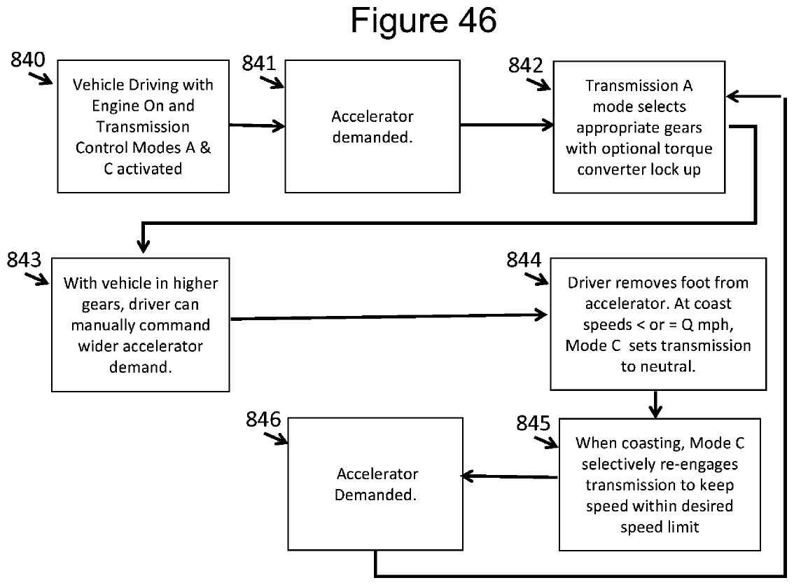

FIG. 46 illustrates a block diagram of Transmission Control Mode A combined with Transmission Control Mode C. The vehicle is driving with Transmission Control Modes A and C engaged (840). The accelerator is demanded (841). Transmission Control Mode A selects the appropriate available gear (842). Optionally, torque converter lockup may be used to increase efficiency (842). A higher gear ratio enables the use of greater accelerator demand at a given speed (843). The device or driver releases the accelerator at speed Q and the vehicle coasts with the device using Transmission Control Mode C allowing the vehicle to coast in neutral (844). Speed Q is a variable with values between 10 mph and 90 mph. Optionally, the device may adjust fuel delivered to the engine when coasting (844). If the vehicle speed increases to greater than Q, the device uses Mode C to reengage the transmission to create engine braking and keep vehicle within target speed limits (845). When the accelerator is again demanded (846), Transmission Control Mode A is engaged (842).

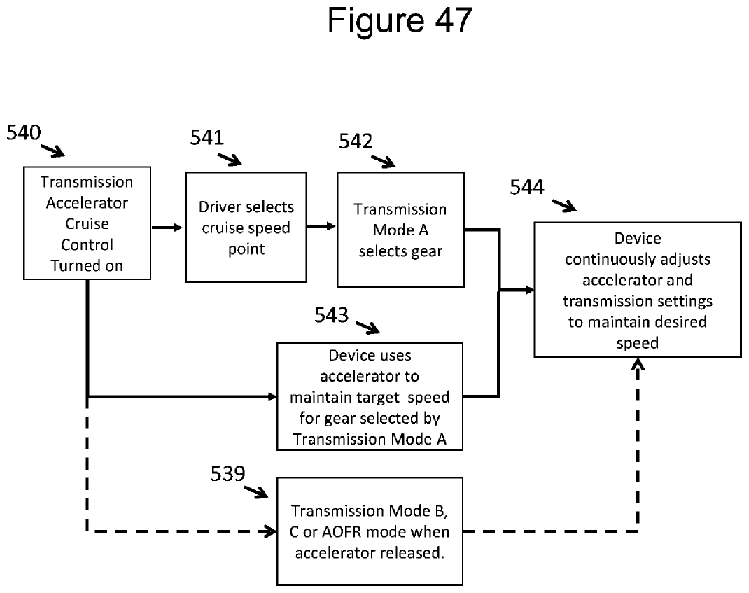

FIG. 47 illustrates an overview of the “Accelerator Control Routine.” The driver sets the cruise control feature to “on” (540). Driver selects vehicle speed set point (541). Transmission Control Mode A selects gear (542). The device adjusts accelerator demand to maintain desired speed (543). When accelerator is not required, Transmission Control Mode B, C or Accelerator Off Fuel Reduction (AOFR) are optionally used depending on driver preference settings (539). The device continuously monitors vehicle operating parameters and adjust gear and accelerator settings to maintain set vehicle speed (544).

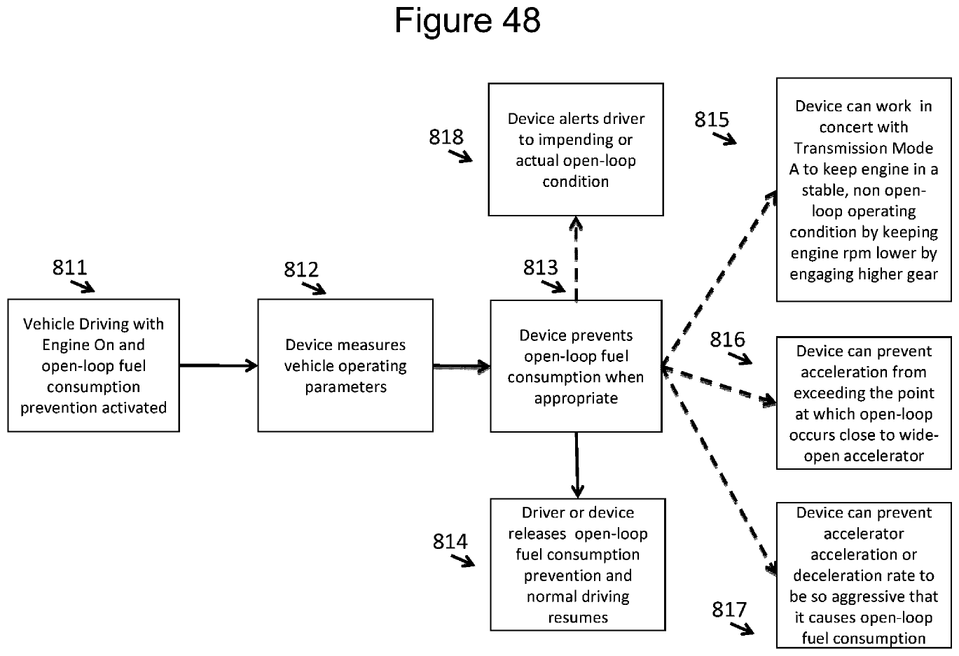

FIG. 48 illustrates a block diagram of a system that prevents open-loop fuel delivery. The vehicle is driving with engine on and open-loop fuel consumption prevention activated (811). The device gathers data to determine vehicle-operating parameters (812). The device prevents open-loop fuel consumption when appropriate (813). The device can optionally control acceleration to prevent open-loop fuel consumption that occurs close to 100% accelerator demand (816). The device continues to prevent open-loop fuel delivery until driver or device releases open-loop fuel consumption prevention and normal driving resumes (814). Optionally, the open-loop prevention may be used with Transmission Control Mode A (815). The device may keep engine RPM lower by engaging a higher gear (815). The device may prevent accelerator demand from exceeding the point at which open-loop occurs close to wide-open accelerator (816) or the device can prevent the acceleration or engine brake deceleration rate to be so aggressive that it causes open-loop fuel consumption (817). The device can also alert the driver to impending or actual open-loop condition (818).

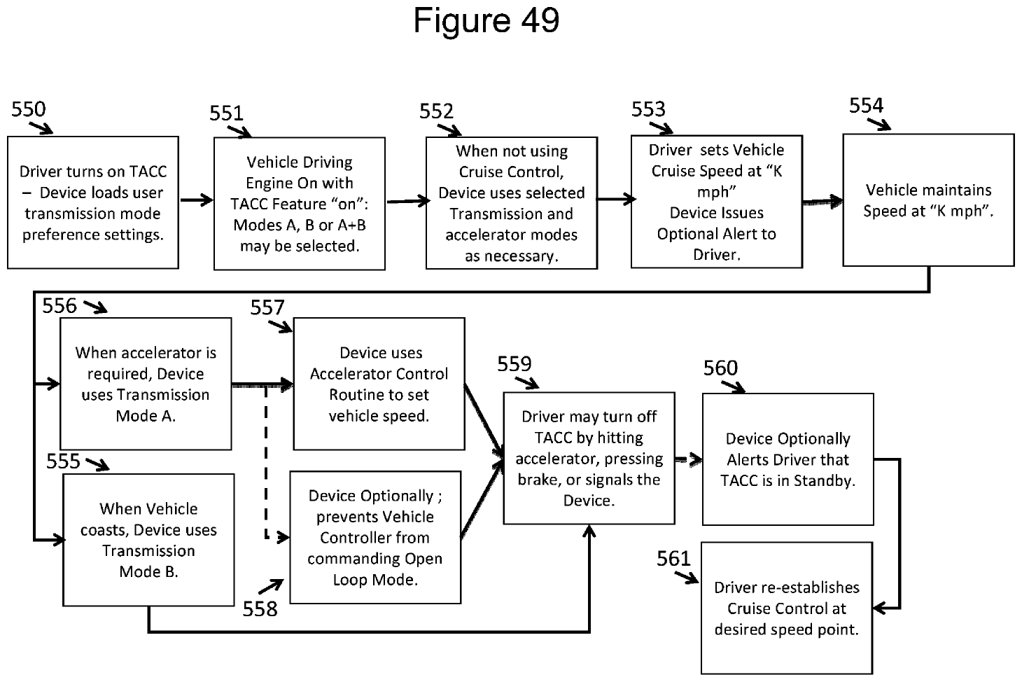

FIG. 49 illustrates a diagram of the transmission control and accelerator control used in a Cruise Control Mode that allows the vehicle to coast above a set speed. The driver activates the “Transmission and Accelerator Cruise Control for Mode B” (TACC-b) and driver preference settings are loaded (550). The vehicle is driving with Transmission Control Modes A and B activated (551) and each mode is used where necessary (552). The driver sets the vehicle cruise speed at K mph and the device optionally provides an alert that the cruise control has been set (553). K is a variable with a value typically between 10 mph and 90 mph. The device maintains vehicle speed at K mph (554). If the accelerator is demanded, the device uses Transmission Control Mode A to set the gear (556). If the accelerator is released, the device uses Transmission Control Mode B (555). The device uses the accelerator routine to maintain the speed (557). Optionally, the device prevents the vehicle computer from selecting the Open-Loop Mode (558). The driver may turn off TACC-b by pressing the accelerator pedal, the foot brake or uses another method to signal the device (559). The device provides an alert that TACC-b is in Standby Mode (560). The driver may re-engage the TACC-b by signaling the device at the desired speed (561).

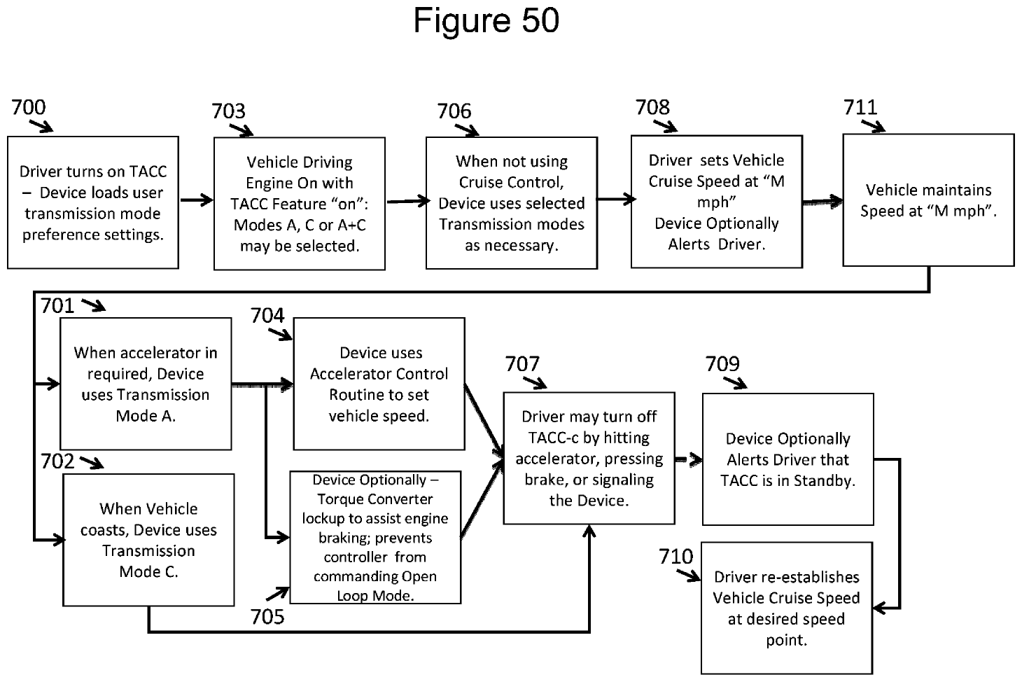

FIG. 50 illustrates a diagram of a transmission and Accelerator Control Mode with Cruise Control Mode in which engine braking is used to prevent coasting above a set speed. The driver activates “Transmission and Accelerator Cruise Control for Mode C” (TACC-c) and user preference settings are loaded (700). The driver selects Transmission Control application modules (703). When cruise control is not in use Transmission Control application modules are used (706). The driver sets the vehicle cruise speed at speed M mph (708). The device may provide an alert that the cruise control has been set (708). The device maintains vehicle speed as close as possible to M mph (711). When the accelerator is demanded, the device uses Transmission Control Mode A (701). The device uses the Accelerator Control Routine to maintain set vehicle speed (704). When the accelerator is released, the vehicle coasts with the device using Transmission Control Mode C (702). Optionally, the device prevents the vehicle computer from entering the Open-Loop Fuel Delivery Mode (705) and may command torque converter lockup to assist with engine braking (705). The driver may turn off TACC-c by pressing the accelerator pedal, foot brake, or uses other methods to signal the device (707). The device provides an optional alert that TACC-c is in Standby Mode (709). The driver may reestablish TACC-c at the desired speed (710).

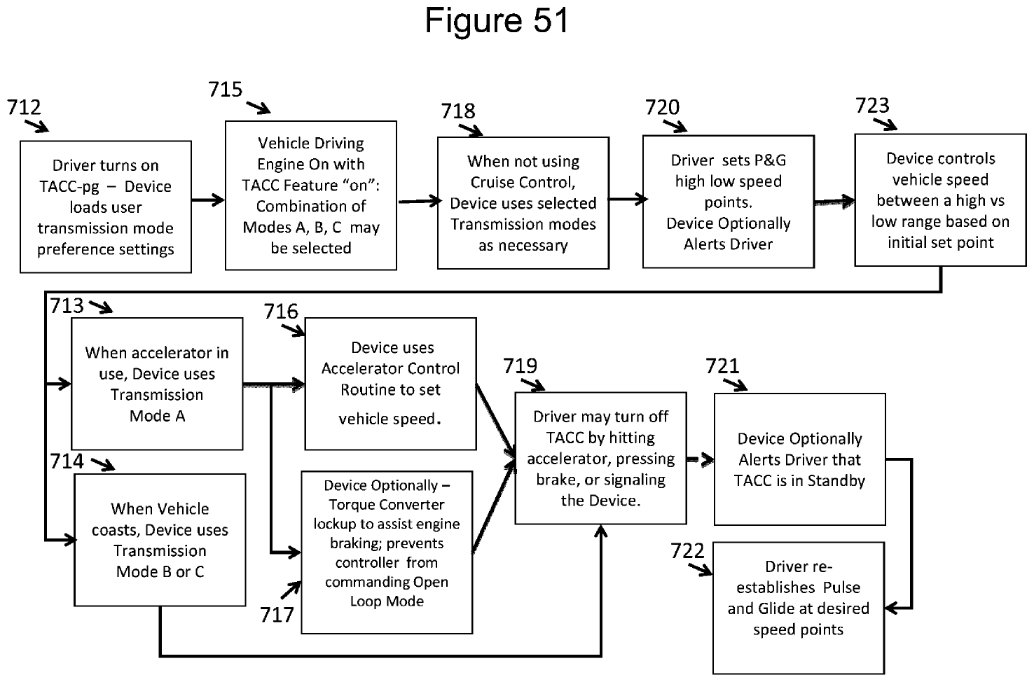

FIG. 51 illustrates a diagram of the system using an application for “Transmission and Accelerator Cruise Control used in the Pulse-and-Glide Mode (TACC-pg).” The driver activates TACC-pg (712). The driver selects Transmission Control application modules (715). When cruise control is not in use, Transmission Control application modules are used (718). The driver turns on the Pulse-and-Glide Mode and sets the upper and lower limits (720). The device provides an alert that the cruise control has been set (720). The device maintains vehicle speed between the pulse-and-glide upper and lower speed limits (723). If the accelerator is used, the device uses Transmission Control Mode A (713). When the accelerator is in demand, the device uses Accelerator Control Routine to set vehicle speed (716). When the accelerator is not in use, the device uses Transmission Control Mode B or C when the vehicle coasts (714). Optionally, the device prevents the vehicle computer from engaging the Open-Loop Mode and optionally may command torque converter lockup to assist in engine braking (717). The driver may turn off TACC-pg by pressing the accelerator, foot brake, or use other method to signal the device (719). The device provides an alert that TACC-pg is in Standby Mode (721). The driver reestablishes pulse and glide interval at desired speed points (722).

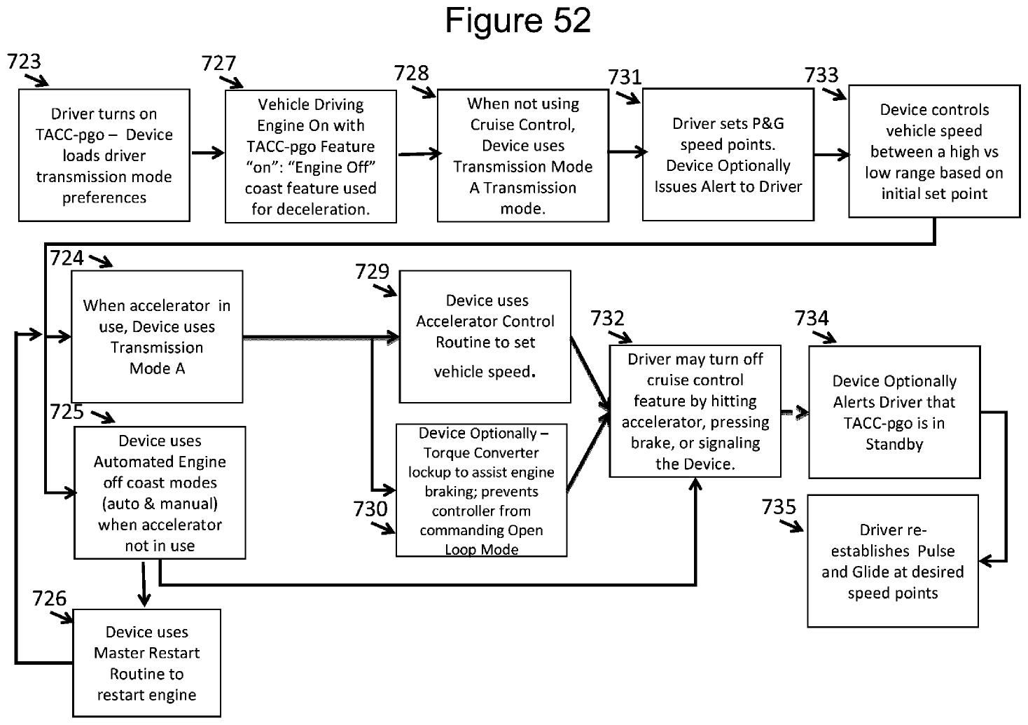

FIG. 52 illustrates a diagram of a “Transmission and Accelerator Cruise Control used in the Pulse-and-Glide Mode with Engine Off Coasting” (TACC-pgo). The driver activates TACC-pgo, and the device loads driver Transmission Control application module preference settings (723). The vehicle drives with engine on using Transmission Control Mode A (724) and “Engine Off” coast feature used for deceleration (727). When cruise control is not in use, Transmission Control application modules are used (728). The device uses the Accelerator Control Routine to maintain target vehicle speed as close as possible (729). The driver signals the device to enter the Pulse-and-Glide Mode (731). The pulse-and-glide upper and lower speed limits are set (731). The device optionally provides an alert that the cruise control has been set (731). The device maintains vehicle speed between the pulse-and-glide upper and lower speed limits (733). If the accelerator is used, the device uses Transmission Control Mode A (724) and uses the Accelerator Control Routine to maintain vehicle speed (729). When the vehicle coasts, the device uses Automated Engine Off Coast Modes (725). The device uses the Master Restart Routine to restart the engine after it has been turned off (726). Optionally, the device prevents the vehicle computer from selecting the Open-Loop Mode and may command torque converter lockup to assist in engine braking (730). The driver may turn off TACC-pgo by pressing the accelerator, foot brake, or using another method to signal the device (732). The device optionally provides an alert that TACC-pgo is in Standby Mode (734). The driver reestablishes pulse-and-glide at desired speed points (735).

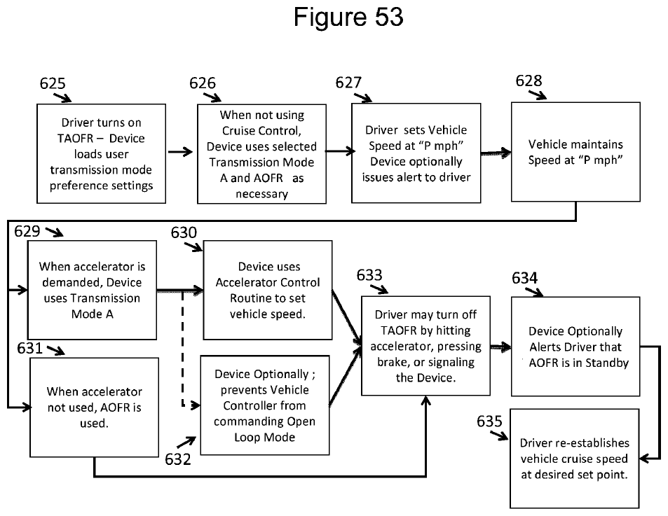

FIG. 53 shows a block diagram of a system that uses Transmission Control Mode A application module with the Acceleration Off Fuel Reduction (AOFR) with a Cruise Control Mode. The driver activates AOFR and user preference settings are loaded (625). When cruise control is not in use, Transmission Control application module and AOFR are used (626). The driver sets speed at P mph to set cruise control point (627). The device may provide an alert that the cruise control has been set (627). The device maintains vehicle speed at P mph (628). P is a variable with a value typically between 10 mph and 90 mph. When the accelerator is used, the device uses Transmission Control Mode A (629). The device uses the Accelerator Control Routine to maintain set vehicle speed (630). When the accelerator is not in use, the fuel is reduced to the engine by AOFR (631). Optionally, the device prevents the vehicle computer from entering the Open-Loop Fuel Delivery Mode (632). The driver may turn off AOFR by pressing the accelerator pedal, foot brake, or use other methods to signal the device (633). The device optionally provides an alert that AOFR is in Standby Mode (634). The driver may reestablish AOFR cruise speed at the desired speed set point (635).

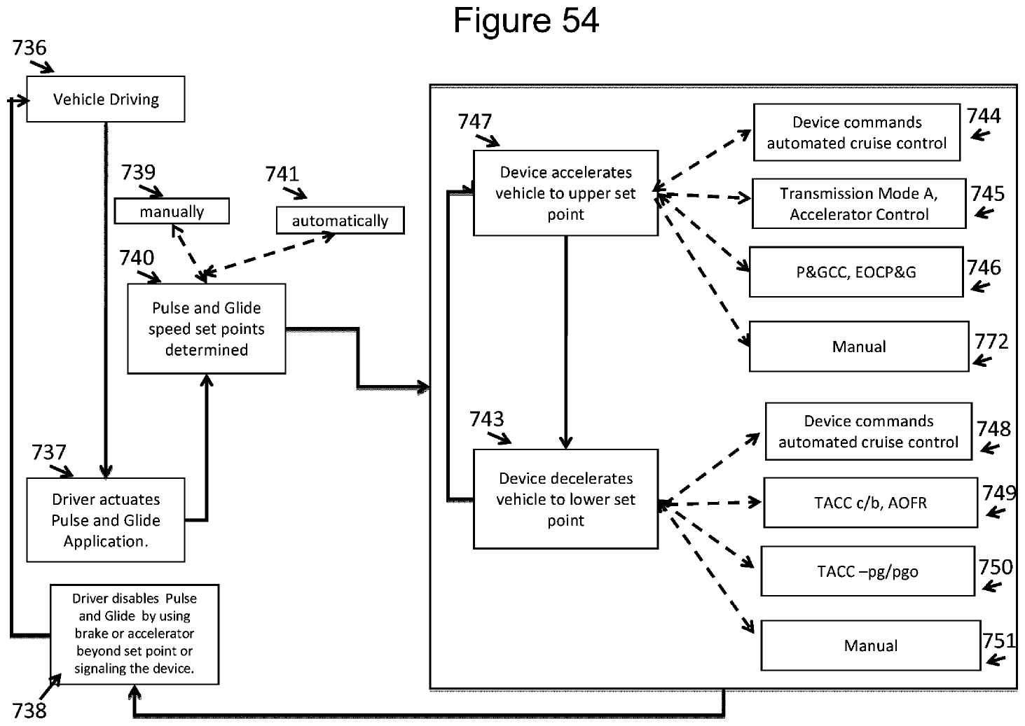

FIG. 54 illustrates a block diagram of a system that allows pulse-and-glide driving of an automatic transmission vehicle. The vehicle is driving (736). The driver activates Pulse-and-Glide Mode (737). The pulse-and-glide speed set points (740) may be set manually (739), or automatically (741). Once the pulse-and-glide set points are determined (740), the vehicle accelerates to the upper set point (747). The acceleration may be controlled using the vehicle cruise control, a combination of vehicle device cruise control or device based cruise control (744). In addition the device may use different modes during the acceleration phase including Transmission Control Mode A with Accelerator Control Routine (745) (see FIGS. 37, 38, 47), pulse-and-glide cruise control with engine on (TTAC-pg) or engine off (TTAC-pgo) (746), or manually controlled from the accelerator (772). When the upper set point is reached, the vehicle decelerates to the lower set point (743). The deceleration may be controlled using the vehicle cruise control, a combination of vehicle and device cruise control or device based cruise control (748). In addition, the device may use different control modes during deceleration including TACC-b (749), TACC-c (749), and AOFR (749), (TTAC-pg) (750) or (TTAC-pgo) (750) or manually controlled from the accelerator (751). At any time, the driver may disable Pulse-and-Glide Mode by signaling the device including depressing the foot brake or manually pressing the accelerator beyond the set point (738).

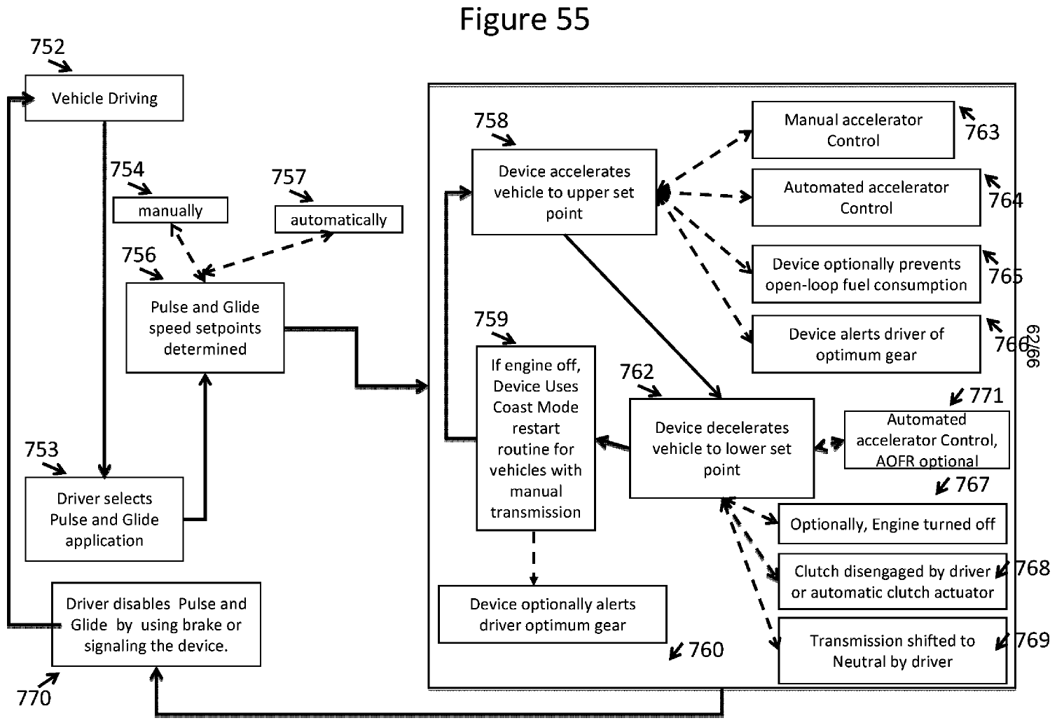

FIG. 55 illustrates a block diagram of a system that allows pulse-and-glide driving of a manual transmission vehicle. The vehicle is driving (752). The driver selects Pulse-and-Glide Application (753). The pulse-and-glide speed set points (756) may be set manually (754), or automatically (757). Once the pulse-and-glide set points are determined (756), the vehicle accelerates to the upper set point (758). The acceleration may be controlled using options for manual accelerator control (763) or automated accelerator control under the vehicle cruise control (764), or a combination of vehicle device cruise control or device-based cruise control (764). The acceleration (763, 764) can optionally be further controlled by the device preventing open-loop fuel consumption (765). Optionally, the device may alert the driver of the most fuel-efficient acceleration gear (766). When the upper set point is reached, the vehicle decelerates to the lower set point (762). Deceleration may be accomplished by the device allowing the vehicle to coast to the lower speed set point with the transmission in gear (771) or with engine on with clutch disengaged by the driver or automatic clutch actuator (768), or transmission is shifted to neutral by the driver (769), or with the vehicle in gear using AOFR (771). Alternatively, the vehicle can coast with engine turned off (767) using the coast for manual transmission routines (see FIG. 30). If the engine is off when the lower speed set point is reached, the device uses the Coast Mode Restart Routine for vehicles with manual transmission (759) (see FIGS. 28, 29, 30). Optionally, the device alerts the driver to the optimum gear (760). At any time the driver may disable pulse-and-glide by depressing the foot brake or commanding acceleration beyond the upper speed set point or otherwise signaling the device (770) according to driver preferences.

FIG. 56 shows a diagram of a transmission fluid pressure accumulator. The accumulator (795) is attached by a hydraulic line (788) to the transmission (794) preferably to an existing port (789). Transmission fluid under pressure flows into the accumulator's transmission fluid chamber (791). The fluid flows from the transmission to the accumulator through a check valve (787). If the device opens the restart valve (785) when the accumulator (795) is being recharged, transmission fluid can flow into the accumulator (795) through the restart valve (785) or both the restart valve (785) and check valve (787). Both the restart valve (785) and the check valve (787) are attached by hydraulic lines to the accumulator (783, 784). The chamber has a movable piston (782), an air chamber (790), and an optional air chamber reservoir (781), which is connected to the air chamber (790) by means of an air line (780). Pressure and flow sensors (786) can optionally monitor the flow rate, amount and pressure of fluid in the chamber (791). The device (792) can open the restart valve (785) and check valve (787) either wirelessly or by cable connection. Hydraulic fluid flowing from the accumulator (795) through hydraulic lines (788) pressurizes the transmission (794) through hydraulic lines (788) preferably into the transmission test port or another pre-existing fluid port (789). Transmission fluid delivered by the restart valve (785) is monitored by pressure and flow sensors (796).

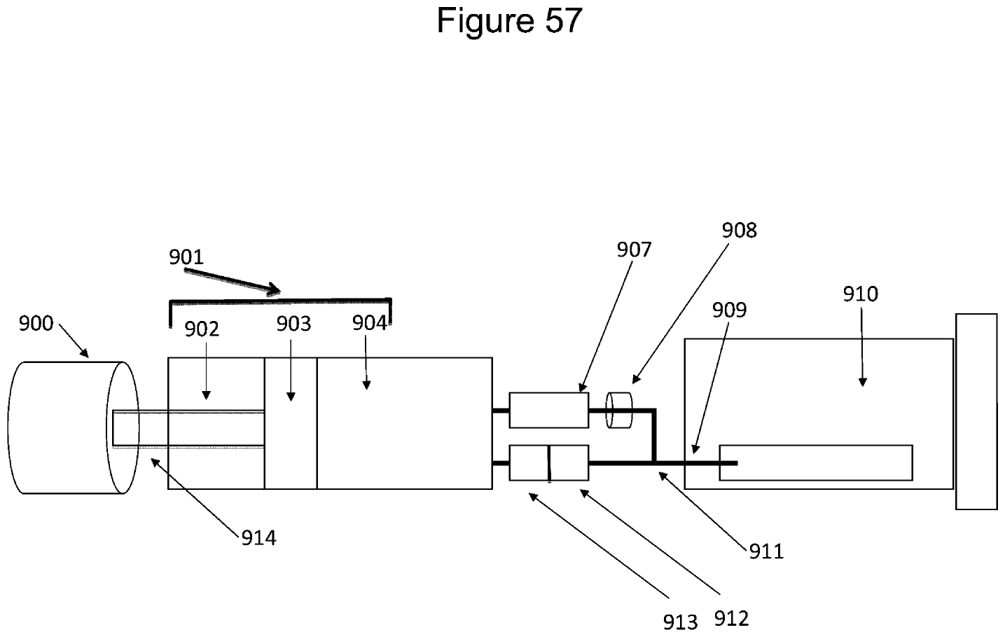

FIG. 57 shows a diagram of a motor actuated transmission fluid pressure accumulator. The accumulator (901) is attached by a hydraulic line (911) to the transmission (910) preferably to an existing port (909). Transmission fluid under pressure flows into the accumulator's transmission fluid chamber (904). The fluid optionally flows through a check valve (912) if more control over fluid flow is desired, although fluid flow can be controlled by the motor (900) alone. The device can optionally have a restart valve (907) to control when fluid exits the accumulator (901), although this can also be controlled by engaging the motor (900). The device can optionally open a restart valve (907) when the accumulator (901) is being recharged so that transmission fluid can flow into the accumulator (901) through the restart valve (907) or both the restart valve (907) check valve (912). The chamber has a movable piston (903), and an air chamber (902). Pressure and flow sensors (908) can optionally be used to monitor the flow rate, amount and pressure of fluid in the accumulator (901). The device can cause fluid to flow at a certain pressure and rate by commanding the motor (900) to move the piston to push fluid into the transmission (910) and the device can also open the restart valve (907) directly. The device can also control the motor (900) to move the piston (903) away from the transmission (910) to create negative pressure in the transmission fluid chamber (904) The motor (900) can also lock the piston in place, either electrically or with an electromechanical lock on the motor shaft (914). Hydraulic fluid flowing from the accumulator (901) through hydraulic lines (911) pressurizes the transmission (910) through hydraulic lines (911) preferably into the transmission test port or another pre-existing fluid port (909). Transmission pressure is measured by pressure and/or flow sensors (913, 908) or by using pre-existing transmission sensors that provide information over the vehicle computer port.

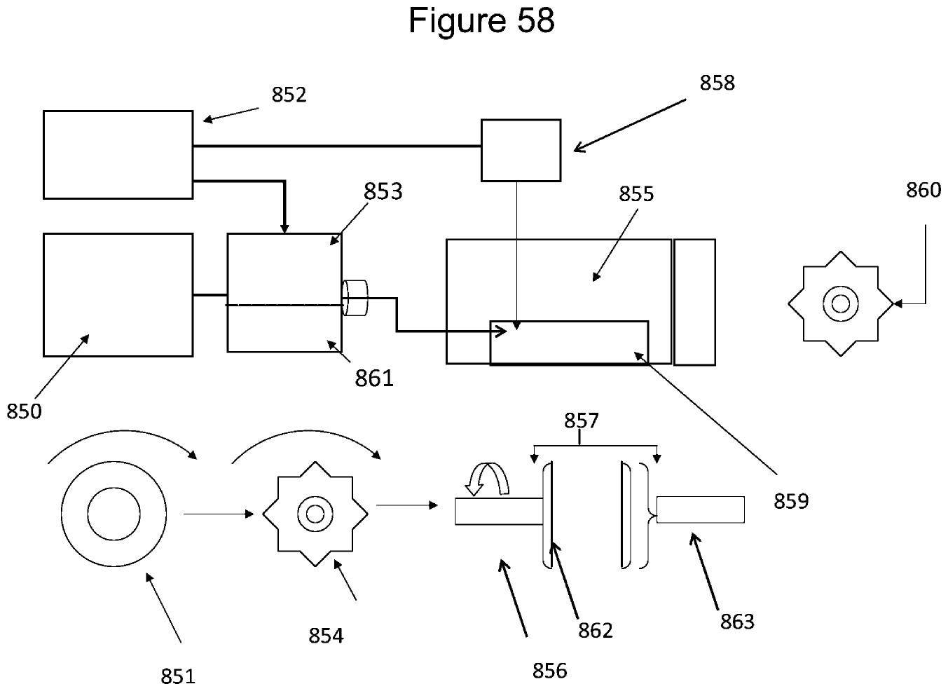

FIG. 58 illustrates a diagram of the Accumulator Restart Routine. The device (852) initiates the Engine Restart Routine (FIGS. 8, 9, 10). The restart valve (853) opens. The device (852) acquires data from the pressure and flow sensors (861) to control the restart valve (853). Fluid flows into the valve body (859) of the transmission (855). Concurrent to the delivery of fluid to the valve body (859), the device commands the transmission (855), or optionally through the vehicle controller or auxiliary electronics (858), to select the appropriate gear based on vehicle speed. The device (852) selects the solenoid position to make the appropriate fluid path active to engage the appropriate gear in the transmission (855) with the pressurized fluid from the accumulator. The presence of pressurized fluid in the appropriate fluid control circuit causes the appropriate clutch (854) to engage in the transmission (860) that engages the gear selected by the device (852) through the fluid control circuit. With the clutch (854) engaged, the turning wheels (851) rotate the transmission shaft (856), which causes the torque converter (857) turbine (862) to begin rotating. The rotating turbine (862) causes the crankshaft (863) to turn enabling an engine restart.

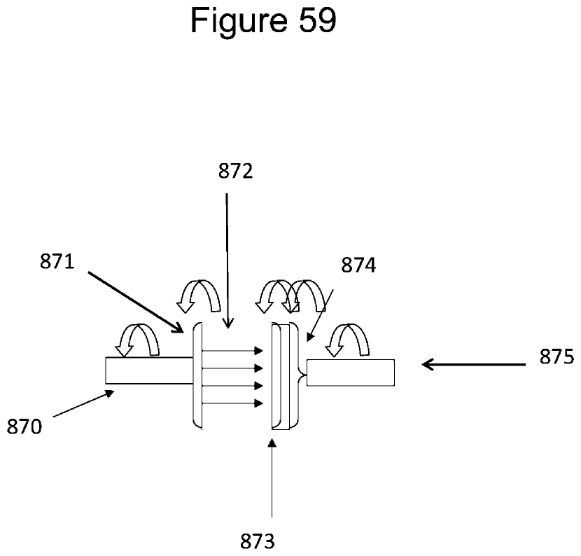

FIG. 59 illustrates a diagram of a torque converter starting the engine. The rotating transmission shaft (870) turns the torque converter turbine (871). Pressurized transmission fluid (872) flows into the torque converter pump/impeller (873). The torque converter pump/impeller (873) begins to rotate the torque converter outer housing (874). The rotation of the outer housing (874) turns the crankshaft (875), and the engine is restarted.

The invention provides for a System for increasing fuel economy in a motor vehicle. The System has the following components: a communicator, a logic device (device) and a computer program. A System Process is defined as a method by which all the primary components work in concert to carry out the functions of the invention. The communicator gathers information on the vehicle operating parameters which it relays to the device and transmits commands from the device back to the vehicle. The communicator is preferably attached to and exchanges information over the vehicle's computer port; however, it also communicates with other systems that may not report data over the vehicle computer port. Further the communicator can send commands to and receive data from additional components added to the system, such as an Actuator Board or pressure accumulator. The communicator can optionally receive information from external sources by using its own wireless communications chip set or by tethering to communications equipment such as a smart phone. External data may originate from one or a combination of sources such as from other vehicles and/or from an external data center. The second component is a logic device (or “the device”) that receives vehicle and other forms of information from the communicator. The device component can be attached or external to the vehicle or co-located with the communicator. The third component is a computer program embodying a set of algorithms, which runs on the device component and determines if the operation of the motor vehicle should be altered, and issues commands to the motor vehicle. Device commands are preferably forwarded to the communicator that transmits them to the vehicle using the vehicle computer port (or other appropriate connection). By working in combination, the three components of the system, the device can control the shut-off and restart of the engine, control the gear settings of an automatic transmission and control fuel delivery to the engine.

The system hardware is controlled by a software firmware that is comprised of software routines that enable the invention components to communicate with one another and to send and receive data and issue commands to the vehicle. In addition, the device runs separate application modules that have a defined set of features to enable additional capabilities. These application modules are capable of being separate products; however, the device can run several applications in parallel.

### The Hardware:

The System hardware: The hardware carries out the functions of the invention through a network consisting of the Device (934c), the Communicator (936c) and optionally the Switch (945c) and Actuator Board (920c) and may include other auxiliary components. The system is based around a programmable electronics, (i.e. the device) capable of running the system software. The device exchanges data and commands with the communicator, which is attached to the vehicle computer port (e.g. OBDII for passenger vehicles and J1939 for commercial vehicles) or other suitable networking connection. The system connections to the vehicle include the standards supporting and signal protocols to receive and transmit data for the Controller Area Network (CAN) bus, VAN, LIN, ISO 11783, MOST, Multifunction Vehicle Bus, D2B, Keyword Protocol 2000, DC-Bus, IDB-1394, SmartwireX, J1850, ISO-9141-I/-II, SPI, IIC, BEAN, FlexRay, SCI, SAE J1850, ISO 14223, and Ethernet protocol. In addition, the system can accommodate vehicles equipped with vehicle controller connections using any version of universal serial bus (USB) and wireless connections such as the Bluetooth and the wi-fi 802.11 standards.

The device and the communicator can either be separate components or co-located in the device/communicator package. In addition, the device and the communicator can run all or part of their respective software using shared electronic components to carry out their respective functions. If the device and communicator are not located in the same package, the two components can communicate wirelessly (e.g. Bluetooth, Wi-Fi, etc.) or by using a cable connection.

The Communicator: The communicator is a component, or series of components, of the system that obtains information from the vehicle and external sources, and sends this information to the device. In addition, the communicator receives commands from the device and relays them to the vehicle. It is important to note that the device may be located exterior to the vehicle. The communicator can obtain information from vehicle computer port(s) such as OBDII (i.e. On Board Diagnostic), J1939, EOBD (European On Board Diagnostics), JOBD (Japanese On Board Diagnostics), and ADR 79/01 (Australian Design Rule 79/01). The communicator may connect to the port through a cable connection such as the universal serial bus (USB). Alternatively, the communicator may communicate with the vehicle by wireless devices or methods such as Bluetooth or the Wi-Fi 802.11 standards as examples. The communicator obtains information from external sources by wireless means. In addition, the communicator may communicate with auxiliary devices such as an actuator board, brake pressure sensors, a pressure accumulator, a motor to automatically control the clutch of a manual transmission, or other aftermarket products that would benefit being automatically controlled by the system either by cable connections or wireless connections. The communicator may be located in a device which is not part of the vehicle, such as a smart phone.

Typically the programming to operate the communicator is found in the Firmware; however, the communicator's software and capabilities can be upgraded by a given software application module. The communicator regularly requests and receives operational data (e.g. vehicle speed, engine RPM, engine temperature, etc.) from the vehicle's controllers that it transmits to the device. In addition to receiving information over the computer port, the communicator can transmit commands, at the direction of the device, to the vehicle controllers and other vehicle systems that can execute software commands. The terms “computer,” “ECU” (Engine Control Unit), “TCM” (Transmission Control Mode), and “ECM” (Electronic Control Mode) refer to the vehicle controller or multiple controllers if the vehicle has more than one controller.

The communicator can also be configured to work with aftermarket components that do not communicate over the vehicle computer port or other standard connections. Many aftermarket components, such as brake pressure sensors or a pressure accumulator do not communicate over the computer port. The communicator preferentially communicates wirelessly (e.g. Bluetooth Wi-Fi, etc.) with these aftermarket components; however, connection by cable is also possible. A direct connection to the communicator makes the data from these systems available to the device and can bring aftermarket components under the control of the device.

The Device: The device is made up of electronic equipment needed to run the application software that carries out the functions of the invention. The device uses the communicator to receive and processes data originating from the vehicle, inputs from the driver and/or signals or commands from an external network. The device runs a given software application, which it uses in combination with vehicle data provided by the communicator, to determine if a command is to be issued. The device can be connected to the system as an independent component, or it can be co-located with another system component such as the communicator, the Actuator Board, or other hardware component. If the device and communicator are not co-located in the same package, the two components may communicate wirelessly (e.g. Bluetooth, Wi-Fi, etc.) or by using a cable connection. In some configurations, the device can be made up of distributed electronics located on two or more components. For instance, the device can be made up of microprocessors jointly operating on the communicator, the Actuator Board and a cell phone. The device can also be located on an external component, or components, such that the system transmits information to, and receives commands from, a component not directly connected to the vehicle. Examples of the device operating in this configuration include a program running on a smart phone or smart pad, a computer (e.g. laptop, note book, etc.) located in or proximal to the vehicle. Other examples of the device include an application running on a computer that is part of an external network that wirelessly communicates with the communicator attached to the vehicle. Alternatively, the device can be comprised of electronics that are part of the vehicle's original equipment if the vehicle electronics can load and run the appropriate software and communicate with the communicator.

The device communicates with the communicator that it uses to forward commands and exchange data with other components of the system such as the Actuator Board, the switch, or other auxiliary components. For instance, the communicator transmits data taken from both the computer port and the data provided by the Actuator Board from its connection to vehicle electrical systems (such as a fuse box). Working through the communicator, the switch can optionally be used to send driver inputs to the device while an auxiliary component such as an accumulator can provide measurements of transmission pressure. The device can be connected to the communicator either by electrical cable or use wireless communication methods. As the device receives the collective information provided by individual components that make up the system, it compares this information against the criteria and rules of the application software running on the device as well as to the user preferences and checklists. The device uses this aggregate data to determine when the criteria are such that issuing a command is permitted, the type of command to be issued and how such a command should be executed. For instance, the device can determine when to restart the engine and if a given restart should use the starter motor, the transmission accumulator or combination of the two for the engine restarts. Further, the device can use the same rules and criteria to disallow a command given a vehicle's operating, traffic or environmental conditions. For instance, the device may disallow a driver request to shutdown the engine if the device determines the vehicle battery power is too low.

The device uses the operational data taken from vehicle systems or auxiliary devices in determining if a given driver command will be permitted or denied or if the device will autonomously issue a command. These commands can be used to control vehicle systems such as turning the engine on/off, shifting the transmission, modulating fuel injectors, as well as operating other aftermarket devices. Manual and automatic transmissions are contemplated in this invention including conventional automatic transmissions, partially automated transmissions, double clutch transmission, transmissions with and without converters, semi-automatic transmissions, electronic gearbox systems, sequential manual gearboxes, electrohydraulic manual transmissions, continuous variable transmissions and the like.

The device can control accelerator demand and accelerator release. Accelerator demand is defined as the driver, the device, the vehicle systems, aftermarket systems or external network requesting more or less engine power. Typically, a driver adjusts accelerator demand by using the accelerator pedal. The device, vehicle system (such as cruise control) or aftermarket system adjusts engine power by issuing a command to the vehicle controller that controls the accelerator. Accelerator release occurs when the driver, the device, vehicle system, or aftermarket system requests no additional engine power beyond that needed to keep the engine at idle.

The device is programmed to be controlled by signals that originate from the driver, the vehicle or an external source. The device cross references these signals with the software applications being run on the device to determine what action, if any, is required. The device cross references its signal interpretation with the vehicle operating data and user preferences to determine if any action should be executed at any given moment. In this manner, signals are permitted to become commands issued by the device. Signals to the device may be input by a variety of methods including a hardware switch (such as illustrated in FIG. 3), or components that allow manual inputs such as a smart phone, smart pad, portable computer or a vehicle or custom monitor. The device can also interpret the manner in which the driver uses the vehicle systems, such as a foot brake or a turn indicator, as a signal to take action. Depending on the software application being run, the use of standard vehicle components such as a foot brake, accelerator pedal, turn indicator, clutch, automatic transmission shift lever, etc. can be used by the device as signals to issue a command. For instance, the device can interpret that a driver increasing pressure to the foot brake of a stopped vehicle as a signal to shut-off the engine, and the release of the foot brake as a signal to restart the engine. Further examples of stopped vehicles with the foot brake applied include shifting an automatic transmission to park being interpreted by the device as a signal to shutdown the engine while shifting from Park to Drive is used as a signal to restart the engine. The device can also monitor the vehicle operating data and use this data as a signal to issue a command. For instance, in the case of a vehicle with the engine shut-off, readings of low brake pressure reserve or low battery power can serve as a signal to issue a command for an engine restart.

The device can also receive signals and commands from an external network. For instance, the network might issue a command to the device to limit vehicle speed based on the type of road the vehicle is driving on or local traffic conditions. Alternatively, the external network could issue a signal to the device to shut-off the engine at a traffic light that is red, that is, set to stop traffic, with greater than a variable of Ml seconds remaining where the value of Ml is set by the driver, device, or by the network. Ml is a variable of time that may be set by the driver or device. It is generally between 10 seconds and 3 minutes. In this case, the device would check with the vehicle operating parameters and any applicable checklists before issuing the command for an engine shutdown. The device can also be controlled by voice commands collected by a microphone located on the system, the vehicle or a phone connected to the system. If the device and communicator are not co-located in the same package, the two components may communicate wirelessly (e.g. Bluetooth, Wi-Fi, etc.) or by using a cable connection.

The Switch: The communicator can optionally engage in one-way or two-way communication with a hardware switch (e.g. the switch) controlled by the driver. Wireless communication between the switch and communicator is the preferred method; however, communication by cable is also possible. A driver can input commands to the device using a switch mounted on the steering wheel, gearshift knob, or other convenient location. The switch allows the driver to signal the device with a command request (e.g. turn the engine on and off), select between different application modules (e.g. start stop, coast, etc.) and to input user preference settings. The device can optionally use the switch to communicate to the driver when a command is being executed or has been aborted due to incorrect vehicle operating parameters or system error.

The Actuator Board: In some cases, the vehicle systems cannot accomplish a task based on a software command sent over the vehicle computer port. By way of example, some vehicles cannot turn an engine on or off using a command over the computer port. In these cases, the system incorporates an “Actuator Board” (AB) that operates under the direction of the device. The Actuator Board is connected directly to vehicle circuitry and preferably replaces existing relays or fuses which act in their place. Under the command of the device, the circuitry on the Actuator Board performs all functions of the components they replace in addition to the other features needed to execute system commands. In the case of starting and stopping the engine, the AB can shut-off the engine by closing a circuit controlling power to the engine ECU or other engine system. To restart the engine, the device sends a command, routed through the communicator, to the AB to accomplish two tasks: it commands the AB to deliver an electric signal to the vehicle component, such as an electrical connection on the engine ECU, to bypass the neutral safety switch, or other systems used to regulate an engine restart. This step allows an engine restart to occur when the transmission shift lever is in any position such as Drive as opposed to Park or Neutral. The device also commands the AB turn on the power to the starter motor relay. The device monitors the progress of the engine restart and sends a separate command to the AB to cut power to the relay once the engine is on.

Plug and Play: The device, the communicator, the switch and Actuator Board are designed to connect to standard vehicle components and circuits. This feature allows a minimum number of hardware designs to work across a wide variety of vehicles. It also greatly reduces, if not eliminates, the need for custom installation. These four components are designed to “plug” into the vehicle and quickly become operational.

Auxiliary Hardware: The device uses the communicator to control other auxiliary components such as the transmission pressure accumulator for an automatic transmission vehicle, the automated clutch for a manual transmission vehicle. The device can also use the communicator to receive information from aftermarket sensors such as a brake pressure sensor. In the event necessary data is not available from the computer port, the communicator can receive information from components which use other connection methods. The communicator can be outfitted with a radio that enables data exchange with auxiliary components or it can be connected by cable (e.g. electric, fiber optic, etc.). The communicator then transmits the information from auxiliary systems to the device. The data from these auxiliary components can be incorporated into the methods by which the operating routines, checklist routines and application modules issue and execute commands. The system can use the communicator to link to a smart phone, smart pad, and portable computer or monitor using wireless methods or a cable. The information provided to the smart phone, etc. updates the driver on the status of the device and the vehicle. In addition, the smart phone and other such devices can use their touch screens or other buttons to provide driver inputs to the communicator and on to the device.

External Networks: In some embodiments, the communicator receives data from an external network that can be used to alert the driver or to serve as the basis for the device to issue commands. The communicator can also receive commands from an external network to be executed by the device and the system can have its firmware and software modules updated directly over an external network. The communicator can connect to the network by tethering to a secondary device (e.g. cell phone, portable computer, vehicle network system, vehicle satellite system, etc.) or use a telecommunication chip set included with the communicator such as cellular telephony or dedicated short-range communications radio. Alternatively, the device can reside on the external network. In this configuration, the communicator directs the transmission of vehicle data to the external network, which runs the device application software and programming and issues a command back to the communicator which forwards commands to the vehicle or auxiliary components for execution. The ability to exchange data allows the external network to update the system's preference settings as the vehicle's driving conditions change (e.g. city vs. highway). The communicator can also connect with the vehicle's computer systems (such as a GPS, mapping or, network systems), which enables the device to evaluate vehicle-operating parameters relative to a given driving location and conditions. The communicator can report this information from these vehicle systems back to the external network.

### The Software: Firmware

The system hardware runs on firmware developed for the system. The firmware typically resides on read only or programmable flash memory components and is responsible for the basic communication and information gathering across the system components, between the system and the vehicle and the system and an external network. The firmware manages system interactions with vehicle computer interfaces, auxiliary device communications, and other lower level housekeeping functions that the system must carry out for each software application module and its related operational routines and subroutines.

### The Software: Applications Modules

Software application modules are feature specific programs that enable a comprehensive series of specific tasks to be accomplished by the driver or the device. Each application module includes specific checklists and operational routines used to accomplish a specific activity including the control of vehicle hardware. The application module also takes into account user preference settings, and it translates driver inputs and signals into commands for the device. For instance, the Start-Stop Application might interpret an actuated switch, or other signal to the device, as a command to shut-off the engine while the Cruise Control Mode might see this as a command to set a cruising speed. Software modules have unique embedded routines that work with checklist and operational routines. For instance, the Start-Stop Application has a routine to check if the vehicle is stopped and foot brake engaged before stopping the engine where the Engine Off Coast Mode has no such requirement. A driver can elect to use an individual software module or can run several applications at the same time. In order to determine how signals from the driver or vehicle become the appropriate commands, the device uses operational routines that take into account real time vehicle operating data and user preferences to set command priorities and issue a given command.

Software modules operate either as standalone products or working bundled in combination with one another. Types of modules include: Start Stop—Driver Controlled, Start Stop—Automated, Engine Off Coasting, Clutch Actuated Engine Shut-off, Transmission Control, Idle Control, Cruise Control, in addition to other applications.

Other features of the software applications modules include:

“User Preference Settings”: As a microprocessor based system, the device can be programmed with user preference settings that the device takes into account when using software routines in processing vehicle data and issuing commands. For instance, a driver can elect not to have an engine shut-off while the vehicle is at an incline above X1 (where X1 is a programmable variable indicating the degree of incline, typically between 2.0 degrees and 20 degrees). When a command to stop the engine is issued, the device will use sensors to determine the vehicle's level of incline in determining whether the command is to be executed or not. The device may come with preloaded factory settings which the user can then modify according to their own preferences. The types of parameters that can be adjusted by the user are described in the description of FIG. 11.

“Vehicle ID and System Check”: Different vehicle models use different types of ECU's, software and components; therefore, the system requires vehicle specific programming to work correctly on a given vehicle model. As a safety check, the device confirms that the system can both communicate with and control necessary vehicle systems to safely operate the vehicle. As part of this initial check, the device runs through the “Vehicle and System Identification Checklist” in two parts: System Check 1 and System Check 2. In Check 1, the device requests the VIN which the communicator retrieves over the computer port. The device then decodes the VIN to confirm the vehicle is compatible with the software loaded on the system. Optionally, the device can reprogram the other system components to operate correctly for a given vehicle model. In Check 2, the device checks selected software modules (e.g. start/stop, coast, cruise control) and runs through a system check that confirms the installed software is valid and approved by the manufacturer. Next the device checks to confirm the required vehicle components (e.g. brakes, accelerator) are available to provide data to or take instructions from the device. When running Check 2, the protocol takes into account the user preference settings as to how a specific vehicle system should be used by the device. If the required systems are not available, an alert is issued, and the device goes into Standby Mode.

“Emergency Restart”: In the event that the Actuator Board (AB) loses its data link with communicator, detects that the device is not operating correctly, or the engine was shutdown erroneously (e.g. false shutdown signal or AB malfunction), the Actuator Board can autonomously restart the engine of an automatic transmission vehicle when the transmission shift lever is in a position other than park or neutral. This feature serves as a back up safety method to immediately make engine power available without intervention on behalf of the driver.

Expanded Communicator Functions: In some cases, a specific software application may carry instructions and programming which expand the functions of the communicator. Examples of increased communicator functionality include the inclusion and communication with a transmission pressure communicator, wireless data exchange with a remote network, and the ability to receive commands from a device not attached to the vehicle.

### Checklist Routines:

The invention's application software modules use a series of “Checklist” routines that are available across multiple application modules. To run a routine, the device directs the communicator to obtain necessary information and the device then compares the retrieved data to the requirements defined in the checklist. The system may ship with factory settings for the checklists; however, parameters can be turned on or off or have values changed according to user preference settings. The types of checklists available include:

Vehicle ID and System Check: Device confirms the system software is compatible with the vehicle model and that required vehicle components are available.

Engine Shutdown Checklist: (ES Checklist) Routine evaluates the vehicle operating parameters to determine if an engine shutdown is permitted.

Automatic Engine Restart—Device Input: (AERDI Checklist) Device uses data provided by the communicator from the computer port to monitor how the driver uses vehicle systems and to determine the need for engine power and automatically restart the engine. An example for the Start-Stop Application is a driver restarting the engine by releasing the foot brake of a stopped vehicle.

Automatic Engine Restart—Autonomous: (AERA Checklist) The device uses data provided by the communicator from the vehicle computer port to determine when it should autonomously restart the engine using criteria based on safety or performance considerations. An example in Coast Mode is the device detecting available brake pressure has dropped below a threshold level and restarts the engine to restore power brakes.

Coast Mode: Device uses vehicle data provided by the communicator to determine when the engine can be stopped or restarted. Example: Driver requests engine off. Device determines vehicle is at an incline that exceeds allowable values. The device optionally issues an alert and the engine stays on.

Other types of Checklists include: Transmission Look up Tables, Engine Restart, and Clutch Actuated Engine Shut-off. A more complete description of Checklists is provided in the description of FIG. 11.

### Operational Routines and Subroutines:

The device supports numerous operational software routines that are used to control vehicle systems. Where the “checklist routines” determine “if” a command will be permitted, the “operational routines” determine “how” a command is executed. Checklist and operational routines work in tandem with one another with the checklist routine generally preceding the implementation of its operational counterpart. How checklist routines are paired to operational routines is a function of the type of software application used by the driver.

Examples of operational routines include:

Routines to Restart an Engine using an Actuator Board: automatic and manual transmission.

Routines to Restart an Engine using the Device: automatic and manual transmissions.

Routine for Restarting an Engine in any gear: automatic transmissions using either the device or Actuator Board to restart the engine.

Routine for Selecting Restart Method: Used to determine if the vehicle will use the starter motor or a pressure accumulator or combination of the two to restart the engine. Used for automatic transmission vehicles. Supported by two subroutines.

Routine for Autonomous Restart of Engine and Permitting/Denying an Engine Restart Command for an automatic transmission.

Routine for Autonomous Restart of Engine and Permitting/Denying an Engine Restart Command for a manual transmission.

Routine for prioritizing commands when both Start-Stop Application and Coast Mode are running: automatic and manual transmissions.

The most important of the combined routines is the ability to start and stop a vehicle's engine while the transmission shift lever is in any gear including “Drive.” This feature is supported in routines and application modules that stop and restart an engine of automatic transmission vehicles.

The core architecture of the system is shown in FIG. 1. The communicator (2.b) can receive user input instructions and forward commands to the vehicle. The communicator (2.b) acquires information about the vehicle operation from the vehicle computer port (3). The computer port (3) may be an OBDII port, a J1939 port or similar port. The “system to vehicle” connections described include those supporting the Control Area Network bus standard as well as computer connections that can be accomplished wirelessly. The communicator (2.b) can gather a wide variety of vehicle information such as vehicle speed, engine rotation rate, whether or not the engine is on, whether or not the foot brake or accelerator is engaged, etc. The communicator (2.b) forwards information gathered from the vehicle to the device (2.a). The device (2.a) is generally a type of microprocessor and associated electronics needed to run the system software. In receiving vehicle data from the communicator (2.b), the device (2.a) can use this information to monitor vehicle systems (5), vehicle controller(s) (4), other system components such as switch (1), as well as data that is provided from an external network (7).

The device issues commands that are forwarded by the communicator to the appropriate component, (6) switch (1), vehicle controller(s) (4), vehicle systems (5), or display components. Commands issued from the device (2.a) through the communicator (2.b) over the computer port (3) can be used to control the vehicle controller(s) (4) in addition to other vehicle systems (5). The control over the vehicle controller(s) (4) enables commands to be issued to and executed by a wide variety of vehicle systems (5).

The communicator (2.b) connects to and communicates with other system components. The communicator (2.b) can optionally communicate with a switch (1) as well as send and receive data, and alerts to display components (6) such as a smart phone, smart pad, portable computer, the vehicle's monitor, audio or video equipment or an aftermarket market monitor display.

In addition, the communicator can connect to other types of display components (6), such as a GPS unit, which provide useful information on vehicle location as well as traffic and environmental conditions. The data received from these display components (6) can be relayed via the communicator (2.b) to the device (2.a) to issue commands for the vehicle controller(s) (4). These same display components (6) can function in a manner similar to the hardware switch (1) by communicating user inputs to request an action by the device (2.a). These same display components (6) can also be used to select and turn on or off the various device (2.a) features and to set user preferences for the device (2.a). The switch (1) and other networked display components (6) can be connected wirelessly or by cable to the communicator (2.b). Wireless communication can include protocols for Bluetooth, Wi-Fi, serial etc. The communicator (2.b) can receive audible commands issued by the driver and can provide audible notifications on the device (2.a) and vehicle status.

In addition to simple user inputs, the communicator (2.b) can receive data sent by the vehicle systems (5), display components (6) or over a wireless external network (7) that it sends to the device (2.a). The device (2.a) can analyze such data and use it to issue a command or, where required, transmit updated information. The communicator (2.b) can receive commands sent by the vehicle systems (5), the display components (6) or over a wireless external network (7) that links to systems externally located to the vehicle. The device (2.a) can evaluate these commands against real time vehicle operating parameters in determining if the command is to be executed or not. The device (2.a) may issue commands using information provided by the vehicle systems (5) to the communicator (2.b) such as mapping, GPS or other location system unit.

The communicator (2.b) may connect to an external network (7) either by using the communication capabilities of the vehicle systems (5) or that of a display component (6). Examples of vehicle systems (5) include satellite link or vehicles that are internet enabled and capable of networking with aftermarket devices. Examples of display components (6) include network enabled smart phones, smart pads, portable computers, or other types of equipment such as a GPS unit or a personal location device. The communicator (2.b) may also include cellular communication and GPS chip sets on its own circuit board to communicate with an external network (7) such that no intermediate system is required.

The types of data and commands exchanged between the communicator (2.b) and the external network (7) include those relating to vehicle operating parameters, internal and external environment, GPS location, traffic conditions, road conditions, and may also include transmission of voice and video data. The communicator (2.b) can connect to auxiliary audio or video display equipment (6) to allow users to communicate over the network using the communicator (2.b) as the mechanism for sending data to and receiving data from the external network (7). If the vehicle is equipped with audio and video communication vehicle system (5), the communicator (2.b) can connect and communicate using these systems.

FIG. 2 is an alternative embodiment of the system in which the device (13) is not physically attached to the vehicle. In FIG. 2, the device (13) is wirelessly connected to the communicator (9). The device (13) contains the necessary electronic components which run the software used to control the system and by extension elements of the vehicle's operations. Examples of the device (13) in FIG. 2 could include a smart phone or laptop computer that is located in the vehicle. Alternatively, in cases where the communicator (9) is equipped with the means to communicate wirelessly over long distances, an external network (7), such as a computer server (FIG. 1) running the system application can act as the device. Long distance communication can occur by tethering the communicator (9) to a communications capable auxiliary component (14) such as a cell phone, laptop, etc., by using systems that are part of the vehicle systems (12) or by including the necessary communication circuitry in the communicator (9) itself.

As in the case of FIG. 1, the system is different from a simple on off switch because it does not simply stop or restart the engine on command of switch (8). Instead the communicator (9) obtains information from the vehicle computer port (10) that it transmits to the device (13). The device (13) issues a command to the communicator (9) (e.g. an engine shut-off or restart) only if it is appropriate to do so. The device (13) controls the vehicle by issuing commands to the communicator (9) which forwards the command over the computer port (10) to a vehicle controller (11) which then executes a command to a given vehicle system. Alternatively, the communicator (9) can use other means to forward commands to vehicle systems (12), device (13), or auxiliary components (14) that are not available to receive commands over the computer port (10) including wireless signals and cable connection. In addition to controlling the vehicle, the device (13) may employ auxiliary components (14) such as electronic devices and sensors to gather information and issue commands. The communicator (9) can also connect with auxiliary components (14) that are attached to the vehicle's electric box using a plug adapter that allows the device (13) to control these auxiliary components (14). The ability to use auxiliary components (14) enables the device to control vehicle systems (12) that cannot be controlled over the computer port (10). An example of auxiliary components (14) includes the device (13) sending commands to the Actuator Board (auxiliary component (14)), via the communicator (9), to control the starter motor (vehicle systems (12)). Auxiliary components (14) can also include hardware such as a pressure accumulator to allow an automatic transmission vehicle to restart (see FIG. 56), in addition to valves, solenoids, and transmission “shift kits.” A shift kit is an aftermarket component for automobiles to modify how the car shifts between gears and can be used for both automatic and manual transmissions. Examples include those made by Transgo performance and B&M racing. Auxiliary components (14) can also include means to provide additional foot brake vacuum by using an additional electric vacuum pump attached with appropriate means (for instance using a check valve) to aid the brake booster when the engine is off. Additional brake vacuum can also be provided by attaching a rigid chamber to the vacuum line, thus increasing the volume of the vacuum space available for power braking. The device (13) can also alert the driver to necessary or helpful information through the use of auxiliary components (14) or by controlling vehicle systems (12) directly or indirectly. For instance, the device (13) can notify the driver that the engine is shut-off by issuing a visual alert displayed on a display component (e.g. the switch, smart phone, smart pad, monitor, laptop computer etc.), an audio alert or a haptic output. The device (13) can also use vehicle systems (12) to send alerts to the driver including the use of a vehicle monitor, flashing a light, or by controlling an existing indicator on the vehicle dashboard.

The communicator can optionally communicate with a switch that is placed within reach of the driver. The switch, illustrated in FIG. 3, may be placed in a convenient and natural location to receive driver input such as the steering wheel or gearshift lever. The switch (FIG. 3) has a rotating dial (400) and a button (404). The combination of the dial (400) and the button (404) enables a user to select device features to turn them on or off, to set user preferences and to actuate the device. The switch uses lights and sounds to indicate the status of a given application, the device, the communicator and the vehicle. As set forth more fully below, the user has a choice of several device-operating modes that may be selected using the switch. The switch may have a variety of shapes including round, triangular, square, or rectangular. It may be a polygon with a control mode at each vertex. The switch can utilize individual buttons for the various modes. Multiple buttons may be placed on the switch to provide different input commands to the device. For example, the switch may employ mechanical components such as push buttons or toggle controls, or electronic systems such as capacitance touch buttons. The switch may be wired directly to the communicator. Alternatively, the switch may be connected wirelessly to the communicator. If the switch is wirelessly connected to the communicator, it may derive power from the twelve-volt accessory socket in the vehicle, or it may have a battery of its own. A wireless connection and rechargeable battery in the switch are preferred. The switch need handle only the small power needed to support wireless communication. The administration of current is handled by the device, communicator, auxiliary electronics, or vehicle electronics. For example, if the vehicle's engine has been stopped, the heavy current required by the electric starter to restart the engine would not be handled by the switch.

A user may choose to use one or several application modules (401, 402) concurrently by turning the dial (400) to the select position marker (403) located on the button (404). Application modules include Start-Stop (e.g. SS) (402) or Coast (401). When the dial (400) is turned such that a given application module (401, 402) is turned to the select position marker (403), the user presses the button (404) located on the dial (403) to turn an application module (401, 402) on/off, to select different applications modes and user preferences for the application.

When the user turns the dial (400) such that the “Drive” label (405) is turned to select position marker (403), the device uses the selected application module (401, 402) to control the vehicle. When the driver presses the button (404), this action is received as a request to actuate the device and the application modules (401, 402) it is running. If the device approves the request, the communicator sends commands to the appropriate vehicle controller and auxiliary electronics. As described below, a press of the button (404) located on dial (400) can be used to direct the device to turn the engine on or off depending on the vehicle's given operating parameters. The button (404) is capable of emitting different color lights and emitting a pattern of flashes that inform the driver of the communicator, device and vehicle operating status. In addition, the device can provide updates and alerts on a given application module (401, 402). For example, an application module (401) that is turned on and operating correctly could be backlit in one color, for example green. A separate color, for example red, could be used when there is an error alert related to the application module (401). A color such as yellow could be used when an application module (401) is placed on standby. The dial (400) can also issue audio alerts including alerts made in combination with lights. For instance, if the device were to automatically restart the engine due to low brake pressure reserve, the communicator can issue an audible alert while commanding the button (404) to flash a colored light to alert the driver to a pending change in engine state.

In another embodiment of an alternative system hardware configuration shown in FIG. 4a, the electronic hardware and electronic components, which can be used to execute the various functions of this invention, are shown as block diagrams. The main components are: the Actuator Board (920), the device/communicator package (930), and an optional switch (945). In this embodiment, the one microprocessor (936) runs both the device and the communicator software programs. The Actuator Board (920) is connected directly to vehicle circuitry preferably replacing existing relays or fuses and acting in their place. The Actuator Board (920) can be a single circuit board or series of interconnected circuit boards. The Actuator Board (920) will perform all functions of the components they replace in addition to the additional features described here. The Actuator Board (920) is meant to intercept, control and send out signals over the vehicle's existing circuitry in a manner that is compatible with the vehicle electronics and computer.

The Actuator Board (920) and the microprocessor (936) running the device and communicator software work together to control the vehicle. In running the communicator software, the microprocessor (936) acts as an intermediary component that enables the Actuator Board (920) to provide information to and receive commands from the device software. The microprocessor (936) communicates with the Actuator Board microprocessor (924) by sending a signal through the communications port (935) to the communications port (926) on the Actuator Board (920). The microprocessor (936) uses the device and communicator programs to issue and transfer the commands over the computer port (931) to the vehicle systems. Alternatively, the microprocessor (936) running the communicator software can use other circuitry located in the device/communicator package (930) to communicate, either wirelessly or over an electric cable, with systems such as the Actuator Board (920) that do not communicate over the computer port (931). After a command has been issued, the microprocessor (936) then uses this information to issue commands to the Actuator Board (920) to send a signal or electric power through the vehicle's circuitry. In this manner, the microprocessor (936) running device and communicator software can control how and when the Actuator Board (920) provides power to the starter motor in an engine restart or to shut-off the engine. Information received by the Actuator Board (920) can be further processed by its own circuitry before sending data to the device or before executing a command issued by the device (936). The Actuator Board (920) may contain an input connection for programming, charging or data input/output (921). The Actuator Board (920) preferably will draw the power for its electronics directly from the vehicle circuitry that it is connected to without compromising the operation of those circuits. The data input/output (921) can be similar to a USB port and can be used for diagnostics or loading updated firmware and the like. The Actuator Board (920) has a series of circuits (922, 923, 925, 927, 928) connected to various vehicle electronics, which function under the control of the Actuator Board (920) Actuator Board microprocessor (924) and directly send power or signals to vehicle components. The Actuator Board (920) will typically replace original fuses or relays or computer connections and take command of those circuits with its own fuses, relays and electronic signals. The electronic signals can be voltages, analog, and digital, TTL, bit streams, digital communications and the like. The Actuator Board (920) can also provide electronic signals from circuit (927) or communications port (926) to vehicle control logic to mimic necessary control signals to circumvent normal vehicle operation such as the neutral safety switch of an automatic transmission vehicle. Depending on the particular vehicle, or circuit design, the circuits (925, 927, 928) for overriding the vehicle's control circuitry may have logic of their own, and the ability to sense and provide feedback. They can also communicate between each other and act in concert with each other such as between component (925), component (928), and AB microprocessor (924). In this way, commands to auxiliary devices can be brought under the central control of the microprocessor (936) running the device and communicator software. Using the microprocessor (936) as a central processing unit and as an intermediary communications hub, the Actuator Board (920) can communicate with the switch (945). Optionally, a temperature sensor (934) may be placed on the board to measure the ambient temperature. The microprocessor (936) and its programs may be calibrated differently at different temperatures based on this reading.

In FIG. 4a, microprocessor (936) runs the device and the communicator software and is located in the device/communicator package (930). By running the communicator software, the microprocessor (936) manages communications with other components of the invention, the vehicle, auxiliary components and external networks. By running the device software, the microprocessor (936) analyzes information, provided via the communicator software, which is use to issue commands to the system invention and the vehicle. The microprocessor (936), running the communication software, can make use of additional components located in the same device/communicator package (930) such as a battery voltage sensor (932). The battery voltage sensor (932) communicates with the vehicle electronics via the vehicle's computer port through a port connector (931). The device/communicator package (930) may contain an input connection for programming, charging or data input/output port (939). The device/communicator package (930) preferably will draw the power for its electronics directly from the vehicle circuitry or computer port that it is connected to without compromising the operation of those circuits. The data input/output port (939) can be similar to a USB (universal serial bus) port and can be used for diagnostics or loading updated firmware and the like. The device/communicator package (930) may contain circuitry (941) that enables communication with auxiliary devices such as the transmission fluid pressure accumulator. In this way, commands to auxiliary devices can be actuated under the central control of the microprocessor (936) running the device software. In running the communicator software, the microprocessor (936) can command an output to the driver via a light, haptic output or sound device (940). The signals to the driver can come from the device/communicator package (930) or the switch (945) or other component placed in a convenient location such as the dashboard. Expansion connectors (937) can be used to add additional components, such as a GPS chip, a temperature sensor or accelerometer, which add extra functionality to the system. A temperature sensor (934) can also provide information to the microprocessor (936) running the device and communication software to use, for instance, in determining battery state-of-charge. The microprocessor (936) can use the communicator software to connect to extra components such as GPS units or cell phones. Communication between the microprocessor (936) and the other system components can occur via wires using a communication port (935) or a wireless chipset. The microprocessor (936) communicates with the vehicle electronics via the vehicle's port connector (931) through a protocol interface (933). Additional memory, or other suitable storage device that can be used for programming or data storage can be interfaced with the microprocessor (936) in the form of standard memory cards, or other storage medium (938), which will allow the user to swap them as needed. These memory cards (938) can store vehicle computer data and device data to be used to visualize and understand the driver's behavior and maximize the use of the system.

The switch (945) is controlled by a microprocessor (949) and can communicate with the microprocessor (936) running the communicator software using a cable or wireless connection (950). The switch can output to the driver via a light, haptic output or sound device (940). The driver can issue commands via an input method such as a button (951). The switch may contain an input connection for programming, charging or data input/output (946). The battery (948) may be managed by circuitry and programmable software (947). If possible, the switch can draw power directly from the vehicle such as through the 12-volt power plug, this can also be used for recharging if necessary.

The microprocessors and other electronics in the system components, such as Actuator Board (920), device/communicator package (930), and switch (945) use firmware developed for the system. The firmware typically resides on read only or programmable flash memory components and is defined as a set of shared software routines that enable the basic communication and information gathering between the device and the vehicle in addition to the device and its networked components. The firmware manages device interactions with vehicle computer interfaces, auxiliary device communications, and other lower level housekeeping functions that the system must conduct in carrying out the functions of the invention and its application software modules.

In another embodiment, illustrated in FIG. 4b, the microprocessor (936) runs the communicator and device software to connect to the Actuator Board (661) and execute commands to the vehicle electric box (664) and vehicle systems (665). Some vehicles do not have the necessary systems that enable the device to issue commands to shutdown and restart the engine over the computer port. In these cases, the Actuator Board (661) functions as an intermediary system that can both receive commands issued by the device and then implement the execution of those commands with the appropriate vehicle system. As illustrated in FIG. 4a, the Actuator Board (661) contains circuitry (e.g. relays, mosfet chips, fuses, transistors, microprocessors etc.) that is used to send and receive signals and turn power on and off to select vehicle systems under the direction of the device.

The Actuator Board (661) is connected to electrical leads (663) through which it sends and receives electrical power and signals. The Actuator Board (661) can also use fiber optic cables to send and receive electromagnetic signals. The electrical leads (663) are typically fitted with lead adaptors (662) that enable the user to easily “plug” into the vehicle systems without the need to cut vehicle wires and otherwise minimize, if not eliminate, the need for custom installation. The electric leads (663) and their lead adapters (662) can vary by vehicle type in terms of cable length and the types of adapters used to connect to the corresponding vehicle sockets or equivalent connection method. The electrical cables use a standardized connection fixture to plug into the Actuator Board (661) and can be exchanged on a “plug and play” basis. Using this method, a standard Actuator Board can accommodate a wide variety of electrical cables and adapters and be used connect to a greater number of different vehicle types.

To connect the electrical leads (663) to the vehicle, the circuit components that control the selected vehicle system are removed from sockets (667, 668). By way of example, types of components that can removed and substituted by the Actuator Board (661) include relays and fuses located in the electric box (664) to control the starter motor, socket (666), the engine controller, socket (669), etc. The cable adaptors used by the Actuator Board (661) will have the compatible mechanical specifications to the components they replace. Different vehicles will have selected circuit components located in different positions, sockets (666, 667, 668, 669) of an electric box (664) or other vehicle systems (665). The combination of standardized vehicle sockets (667, 668) together with the standardized electrical leads (663) used by the lead adapters (662), enables one model of the Actuator Board (661) to be used on a number of vehicles types. One type of vehicle might have a starter motor relay socket (666) in position 1, and a different model may have the starter motor socket in position 2 (667). All other factors being equal, both types of vehicle can be fitted with the same Actuator Board (661) simply by inserting the lead adapter (662) into the appropriate socket (666, 667) for the given vehicle.

In another embodiment of an alternative system hardware configuration shown in FIG. 4c, the electronic hardware and electronic components, which can be used to execute the various functions of this invention, are shown as block diagrams. The four components are: the Actuator Board (920c), the communicator (936c), the device (934c) and an optional switch (945c). In this embodiment, the device (934c) and the communicator (936c) carry out their respective functions using the connected circuitry, device (934c) and communicator (936c), located in the same package (930c). The communicator (936c) communicates with the microprocessor (924c) by sending a signal through the communications port (935c) to the communications port (926c) on the Actuator Board (920c). The Actuator Board (920c) is connected directly to vehicle circuitry preferably replacing existing relays or fuses and acting in their place. The Actuator Board (920c) can be a single circuit board or series of interconnected circuit boards. The Actuator Board (920c) will perform all functions of the components they replace in addition to the additional features described here. The Actuator Board (920c) is meant to intercept, control and send out signals over the vehicles existing circuitry in a manner that is compatible with the vehicle electronics and computer. The Actuator Board (920c), the communicator (936c) and the device (934c) work together to control the vehicle. Using the communicator (936c) as an intermediary component, the Actuator Board (920c) receives commands from the device (934c) and the device (934c) receives information from the Actuator Board (920c). Commands issued by the device (934c) are forwarded by the communicator (936c) over the connector (931c) to the vehicle systems. Alternatively, the communicator (936c) can use other circuitry located in its device/communicator package (930c) to communicate, either wirelessly or over an electric cable, with systems such as the Actuator Board (920c) that do not communicate over the connector (931c). After a command has been issued, the device (934c) can wait for an update from the vehicle or system components via the communicator (936c) and then use this information to issue follow on commands to the Actuator Board (920c) to send a signal or electric power through the vehicle's circuitry. In this manner, the device (934c) uses the communicator (936c) to control how and when the Actuator Board (920c) provides power to the starter motor in an engine restart or shuts off the engine. Information received by the Actuator Board (920c) can be further processed by its own circuitry before sending data to the device or before executing a command issued by the device (934c). The Actuator Board (920c) may contain an input connection for programming, charging or data input/output port (921c). The Actuator Board (920c) preferably will draw the power for its electronics directly from the vehicle circuitry that it is connected to without compromising the operation of those circuits. The data input/output port (921c) can be similar to a USB port and can be used for diagnostics or loading updated firmware and the like. The Actuator Board (920c) has a series of circuits (922c, 923c, 925c, 927c, 928c) connected to various vehicle electronics that function under the control of the Actuator Board (920c) microprocessor (924c) and directly send power or signals to vehicle components. The Actuator Board (920c) will typically replace original fuses or relays or computer connections and take command of those circuits with its own fuses, relays and electronic signals and can circumvent normal vehicle operations. The electronic signals can be voltages, analog, and digital, TTL, bit streams, digital communications and the like. Depending on the particular vehicle, or circuit design, the circuits (925, 927, 928) for overriding the vehicles control circuitry may have logic of their own, and the ability to sense and provide feedback. They can also communicate between each other and act in concert with each other such as between circuit (925c), circuit (928c), and microprocessor (924c). In this way, commands to auxiliary devices can be brought under the central control of the device (934c) via the communicator (936c). Using the device (934c) as a central processing unit and the communicator (936c) as an intermediary communications hub, the Actuator Board (920c) can communicate with the switch (945c). Optionally, a temperature sensor may be placed on the Actuator Board to measure the ambient temperature. The electronic components on the Actuator Board (920c) may be calibrated differently at different temperatures based on this reading.

In FIG. 4c, the device (934c) and the communicator (936c) carry out their respective functions using different circuitry located in the same device/communicator package (930c). The communicator (936c) manages communications with other components of the invention, the vehicle, auxiliary components and external networks. The device (934c) analyzes information provided by the communicator (936c) that the device (934c) uses to issue commands to the system invention and the vehicle. The communicator (936c) can make use of additional components located in the same device/communicator package (930c) such as a battery voltage sensor (932c). The battery voltage sensor (932c) communicates with the vehicle electronics via the vehicle's computer port through a connector (931c). The device/communicator package (930c) may contain an input connection for programming, charging or data input/output connection (939c). The device/communicator package (930c) preferably will draw the power for its electronics directly from the vehicle circuitry or computer port that it is connected to without compromising the operation of those circuits. The data input/output connection (939c) can be similar to a USB port and can be used for diagnostics or loading updated firmware and the like. The device/communicator package (930c) may contain circuitry (941c) that enables communication with auxiliary devices such as the transmission fluid pressure accumulator. In this way, commands to auxiliary devices can be actuated under the central control of the device (934c). The communicator (936c) can output to the driver via a light, haptic output or sound device (940c). The signals to the driver can come from the device/communicator package (930c) or the switch (945c) or other component placed in a convenient location such as the dashboard. An expansion connector (937c) can be used to add additional components, such as a GPS chip, a temperature sensor or accelerometer, which add extra functionality to the system. The communicator (936c) can connect to extra components such as GPS units or cell phones. Communication between the communicator (936c) with the other system components can occur via wires using a communications port (935c) or a wirelessly chipset (935c). The device (934c) communicates, via the communicator (936c), with the vehicle electronics via the vehicle's connector (931c) through a protocol interface (933c). Additional memory can be used for programming or data storage can be interfaced with the device (934c) in the form of standard memory cards (938c), or other suitable storage device, which will allow the user to swap them as needed. These memory devices can store vehicle computer data and device data to be used to visualize and understand the driver's behavior and maximize the use of the system.

The switch (945c) is controlled by a microprocessor (949c) and can communicate with the device (934c) via the communicator (936c) over cables or wireless signals (950c). The switch can output to the driver via a light, haptic output or sound (952c). The driver can issue commands via an input method such as a button (951c). The switch may contain an input connection for programming, charging or data input/output (946c). The battery (948c) may be managed by circuitry and programmable software (947c). If possible, the switch can draw power directly from the vehicle such as through the 12-volt power plug, this can also be used for recharging if necessary.

The microprocessors and electronics of the system components (920c, 930c, 945c) use firmware developed for the system. The firmware typically resides on read only or programmable flash memory components and is defined as a set of shared software routines that enable the basic communication and information gathering between the device and the vehicle in addition to the device and its networked components. The firmware manages device interactions with vehicle computer interfaces, auxiliary device communications, and other lower level housekeeping functions that the system must conduct in carrying out the functions of the invention and its application software modules.

In another embodiment, the device works with an Actuator Board to stop and restart the engine using the “Actuator Board Routine” which is classified as an “operational routine.” This embodiment of a system process is illustrated in FIG. 5a. In some vehicles, the combination of the device and communicator may not be able to stop and restart the engine by issuing a command to the vehicle controller. The device can use the communicator to send commands to the Actuator Board and can to control the engine state by controlling power and electrical signals to vehicle systems. In the case of vehicles with automatic transmissions, the Actuator Board Routine also may issue a signal to bypass the neutral safety switch, dummy impedance load check or other regulating systems of the vehicle.

The Actuator Board Routine begins when the Actuator Board receives a command from the device via the communicator to turn the engine on or off. The Actuator Board can change the engine state by controlling power to the engine computer and starter motor in addition to other systems that are controlled by electrical signals or electrical power such as the fuel pump, fuel injectors, ignition system, etc. depending on the particular type of vehicle. To shut-off the engine, the Actuator Board cuts power to the target vehicle system such as the engine controller that in turn shuts off the engine. Once the engine is off (41), the Actuator Board can restore power, under the direction of the device via the communicator, to the designated system such that it is available for restart or in the case of the engine controller conduct any ancillary functions while the engine is off. The parameters of the Actuator Board Routine can be modified by the device to measure when RPMs have fallen below a certain level, or a set number of seconds have passed, before power is restored to ensure the engine has spun down and an auto-restart avoided (48). To restart the engine, the Actuator Board provides power to the starter motor (44). The device monitors the progress of the engine restart (46) via the communicator and once the engine is on, it commands the Actuator Board to shut-off power to the starter motor (46). In the event the engine does not restart in a predetermined period of time, the device can command the Actuator Board cut power to prevent damage to the starter motor. Absent the ability to monitor the engine restart parameters, the device can command power via the communicator to the starter motor for a predetermined period of time needed to ensure an engine restart.

Vehicles with automatic transmissions often have features, such as the neutral safety switch, which prevent an engine restart if the transmission shift lever is not in park or neutral. In order to bypass this system, as set forth in the description of FIG. 4a, the Actuator Board delivers a signal that mimics the neutral safety switch or other signals, such as the dummy impedance load to indicate that an engine restart is permitted (45). In these cases, the Actuator Board first sends the mimicry signal to the appropriate vehicle system, such as an electrical connection on the engine controller (45). As part of the Actuator Board routine, the circuit that commands the bypass signal is turned on. The bypass signal is sent along the appropriate lead and connector into a socket connected to the engine controller component that receives the neutral safety switch or other signals. The actions of the bypass signal allow the Actuator Board to provide power to the starter motor and the restart of the engine without interference or restrictions from vehicle systems. A similar bypass tactic using electrical signals can be used if the vehicle has features that disallow an engine shutdown. If required, a combination of methods can be used that involves sending software commands directly to vehicle systems using the computer port while commanding the Actuator Board to conduct other steps needed for an engine restart or shutdown. Other examples of vehicle systems that the invention can either control or send mimicry signals imitating include the ignition circuit interlock, the shift position indicator and the engine speed indicator. Control signals can be sent by the device via the communicator over the port connection or use direct connections provided by the Actuator Board in the case of vehicles with manual transmissions using a clutch interlock switch, a similar signal bypass strategy is required as the engine can typically only be restarted with the clutch disengaged.

A command to restart the engine (42) using the Actuator Board Routine can originate from several different methods. Examples include a driver directly signaling the device by which the communicator and device route to the Actuator Board. Alternatively, the signal to the Actuator Board can originate from the device via the communicator following automated routines supporting AERA, AERDI, Coast, Idle Restart, etc.

In another embodiment, the device works with an Actuator Board (AB) to stop and restart the engine using the “Actuator Board Routine” which is classified as an “operational routine.” This embodiment of a system process is illustrated in FIG. 5b and is applicable for vehicles with manual transmissions. In some vehicles, the device may not be able to stop and restart the engine by issuing a command via the communicator to a vehicle controller. Under the direction of the device via the communicator, the Actuator Board can be used to control the engine state by controlling power and electrical signals to vehicle systems. The Actuator Board Routine also may issue a signal to bypass the clutch interlock or other electrical signals.

The Actuator Board Routine begins when the Actuator Board receives a command from the device via the communicator to turn the engine on or off (1040). The Actuator Board can change the engine state by controlling power to the engine controller and starter motor in addition to other systems that are controlled by electrical signals or electrical power such as the fuel pump, fuel injectors, ignition system, etc. depending on the particular type of vehicle. To shut-off the engine, the Actuator Board cuts power to the target vehicle system such as the engine controller that in turn shuts off the engine. Once the engine is off, the Actuator Board can restore power to the designated system such that it is available for restart or in the case of the engine controller conduct any ancillary functions while the engine is off. The parameters of the Actuator Board Routine can be changed to measure that engine RPMs have fallen below a certain level, or a set number of seconds have passed, before power is restored to ensure the engine has spun down and prevent an auto-restart (1047). To turn the engine back on, the Actuator Board turns on the starter motor (1044). The device monitors the progress of the engine restart via the communicator and once the engine is on, it commands the Actuator Board to shut-off power to the starter motor. Alternatively, the device can be programmed to command power via the communicator to the starter motor for a set time to ensure engine restart.

Vehicles with manual transmissions often have features, such as the clutch interlock switch, which prevent an engine restart if the clutch is engaged. In order to bypass this system, the Actuator Board delivers a signal that mimics the clutch interlock signal (or other signals preventing engine restart) indicating that an engine restart is permitted. In these cases, the Actuator Board first sends the mimicry signal to the appropriate vehicle system, such as an electrical connection on the engine controller. The bypass signal is sent along the appropriate electrical lead and connector into a socket connected to the engine controller component that receives the clutch interlock signal. The actions of the bypass signal allows the Actuator Board to provide power to the starter motor (1044) and the restart of the engine. A similar bypass tactic using electrical signals can be used if the vehicle has features that disallow an engine shutdown (1047). If required, a combination of methods can be used that involves sending software commands directly to vehicle systems using the computer port while commanding the Actuator Board to assist in an engine restart or shutdown.

When a command is given to restart the engine (1042), the Actuator Board receives a signal commanding an engine restart (1043). The signal can originate from the switch that is sent to the device via the communicator which commands the Actuator Board. Alternatively, the signal to the Actuator Board can originate from the device via the communicator following the AERA, AERDI routines, Start Stop or Coast applications and the like.

In another embodiment, the device uses the Device Control Routine, which is classified as an “operational routine,” to shut-off and restart the engine, via the communicator, of a vehicle with an automatic transmission while the transmission gear shift lever remains in a position other than neutral or park (16). This embodiment of a system process is illustrated in FIG. 6a. The ability to restart the engine without the requirement to move the shift lever allows the driver to more conveniently shut-off and restart the engine either to reduce idling when stopped or when engine off coasting is desired. The Device Control Routine can be used to shutdown and restart the engine, via the communicator, when the transmission shift lever is in a position other than park or neutral. In many vehicles, the transmission shifts to neutral when the engine is turned off while the transmission shift lever is in a position other than park or neutral (16). The shift to neutral occurs when the loss of engine power results in a drop in transmission fluid pressure releasing clutches to disconnect the wheels from the engine.

The Device Control Routine begins with a command to shutdown (16), or restart (19) the engine when the transmission shift lever is in a position other than park or drive (16). The driver signaling the device, such as by actuating the switch, may initiate a command or use routines governed by AERDI, AERA, or the Coast Application or another application that turns the engine on or off. In the case of an engine shutdown, the device optionally issues a command, via the communicator, through the computer port to the appropriate engine systems to shut-off the engine depending on the vehicle model. Systems that can be shutdown include the engine controller, the fuel injectors, fuel pump or ignition system. The device overrides any vehicle safety features, via the communicator, that prohibit an engine shutdown in the current vehicle state (e.g. transmission shift lever is in drive) (17). As described previously, engine shutdown typically results in the automatic vehicle transmission going to neutral if the transmission shift lever is not already in neutral or in park. In some circumstances this may result in the vehicle shuddering and a noise being made when the clutch disengages. To minimize any physical sensations for the driver during engine shutdown, the device can optionally shift the transmission to neutral (17), via the communicator, just prior to commanding a power cut to the vehicle systems. Whether the transmission changes to neutral by a command from the device via the communicator or indirectly through engine shutdown, the shift lever remains in position in both circumstances (17, 18).

The parameters of the Device Control Routine can be selected by the user to enable electric power restoration to necessary vehicle systems shut-off as part of the engine shutdown sequence (23). In order to prevent an auto-restart that might result from restoring combustion supporting components to an engine that is still spinning, the device determines when it is safe to return electrical power to combustion supporting components (23). Alternative methods include measuring when RPMs have fallen below a threshold level or a set number of seconds have passed before power is restored. The vehicle now has the ignition on, engine off, transmission in neutral with the transmission shift lever in a position other than park or neutral (18). When the engine is commanded to restart (19), the device, via the communicator, commands power to be turned on to necessary engine systems for a restart (if these necessary systems are not already on) and then to the starter motor. The device monitors the engine restart via the communicator and then commands power is cut to the starter motor upon determining the engine is on. Alternatively, the device commands, via the communicator, that power is supplied to the starter motor for a predetermined period of time and then shuts off the starter motor. In the engine restart conditions illustrated in FIG. 6a, a vehicle's controller will typical return the transmission to the appropriate state indicated by the transmission shift lever and the vehicle's operating parameters (e.g. speed, engine load, etc.); however, if a particular vehicle model does not do so, this gear shift can be commanded by the device (20) via the communicator.

As illustrated in FIGS. 5a and 5b, many vehicles have a neutral safety switch or other equivalent features that prevent the engine from restarting when the shift lever is in a gear other than drive or park. In the engine start/stop routine, illustrated in the system process FIG. 6a, the device bypasses the circuitry to restart the engine from any transmission shift lever position (22) by sending an override command to the appropriate vehicle systems, such as the engine controller. The device can also issue commands that will minimize vehicle lurching that might occur when a transmission returns to gear following an engine restart (21). Examples include lowering the transmission oil pressure (21), and/or issuing a command to change the configuration of the transmission shift valve (21). Additional examples include sending a mimicry signal with higher than measured RPM values to cause the transmission control unit to re-engage the transmission at lower than normal engine speed. The ignition circuit interlock and the shift position indicator signals and/or functions can also be brought under the control of the device to provide a smoother engine restart. If a vehicle is equipped with a launch control feature, the device can use this system to minimize lurching when the transmission returns to gear. Launch control is a feature that enables vehicles to accelerate smoothly from a standing start while the engine is at high RPM. These methods by which these commands and signals are sent to vehicle systems are dependent on the type of vehicle involved, but can include the device using the communicator to connect over the vehicle computer port; the actuator board making direct connections to vehicle systems or a combination of the two.

In another embodiment, the device uses the Device Control Routine, which is classified as an “operational routine,” to shut-off and restart the engine of a vehicle with a manual transmission with the clutch disengaged (1016, 1020). This embodiment of system process is illustrated in FIG. 6b. This operational routine allows the driver to conveniently shut-off and restart the engine either to reduce idling when stopped or when vehicle coasting is desired. The Device Control Routine can be used to shutdown and restart the engine with the transmission lever in neutral or the clutch disengaged.

The Device Control Routine begins with a command to shutdown (1016), or restart (1019) the engine with the transmission lever in neutral or the clutch disengaged (1016). The driver signaling the device, such as by actuating the switch, may initiate a command or using routines governed by AERDI, AERA, or the Coast Mode or another mode that turns the engine on or off. In the case of an engine shutdown, the device optionally issues a command via the communicator through the computer port to the appropriate engine systems to shut-off the engine dependent on the vehicle model. Systems that can be shutdown include the engine controller, the fuel injectors, and fuel pump or ignition system. If required, the device can optionally issue commands via the communicator to override features blocking engine turn off (1017) just prior to commanding a power cut to the vehicle systems (1018).

The parameters of the device control routine can be selected by the user to enable power restoration to necessary vehicles systems shut-off as part of the engine shutdown sequence (1023). In order to prevent an auto-restart that might result from power restoration to an engine that has residual spinning, the device determines when it is safe to return power using information provided by the communicator. Alternative methods include measuring when RPMs have fallen below a threshold level or a set number of seconds have passed before power is restored. The vehicle now has the ignition on, engine off, transmission in neutral or clutch disengaged. When the engine is commanded to restart (1019), the device, via the communicator, commands power to necessary engine systems for a restart (if these necessary systems are not already on) and then to the starter motor. The device monitors the engine restart, via the communicator and then commands power is cut to the starter motor upon determining the engine in on. Alternatively, the device commands, via the communicator that power be supplied to the starter motor for a predetermined period of time and then shuts off the starter motor. In the engine restart conditions illustrated in FIG. 6b, the engine is then turned on (1020).

As illustrated in FIG. 5b, many vehicles have a clutch interlock or other equivalent features that can prevent the engine from restarting when the vehicle has the clutch engaged. In the engine start/stop routine, illustrated in FIG. 6b, the device bypasses the circuitry to restart the engine (1022) by sending an override command to the appropriate vehicle systems, such as the engine controller, to enable an engine restart. If required, a bypass command, or series of commands, can be used if the vehicle has features that disallow an engine shutdown. If the vehicle does not do so on its own, the device may turn off optional systems, via the communicator, that require a high degree of electrical power when the vehicle is restarting (1021). The types of systems that may be shutdown concurrent to a restart may be set in the user preference settings.

In another embodiment of a system process illustrated in FIG. 7a, the device uses an Actuator Board Control Routine which is classified as an “operational routine” to shut-off and restart the engine of a vehicle with an automatic transmission. The change in engine state occurs while the transmission gearshift lever remains in a position other than park or neutral. This routine is based upon the Actuator Board Routine illustrated in FIG. 5a but includes additional steps required to prepare a vehicle for driving during an engine shutdown or restart. The ability to control the engine without the requirement to move the shift lever allows the driver to conveniently shut-off and restart the engine to reduce idling time when stopped or when the vehicle is coasting. In the Actuator Board Control Routine, a command to shut-off (25) or turn on (28) the engine is controlled by the Actuator Board Routine. In the Actuator Board Control Routine, the device controls both the Actuator Board functions and any vehicle systems such as the transmission shift to neutral, etc. via the communicator.

The Device Command Routine begins with a command issued via the communicator to shutdown (25), or restart (28), the engine when the transmission shift lever is in a position other than park or drive.

The driver signaling the device, such as by actuating the switch, may initiate a command or using routines governed by AERDI, AERA, or the Coast Application or another application that turns the engine on or off. In the case of an engine shutdown, the device issues a command via the communicator to the Actuator Board, which begins the Actuator Board Routine to shut-off the engine (25). Systems that can be shutdown include the engine controller, the fuel injectors, fuel pump or ignition system. As illustrated in FIG. 6a, an engine shutdown will normally result in the vehicle transmission going to neutral; however, in some circumstances this may result in the vehicle shuddering and a noise being made. To minimize any physical sensations for the driver during engine shutdown, the device via the communicator can optionally shift the transmission to neutral (26) just prior to commanding a power cut to the vehicle systems. Whether the transmission changes to neutral from a command issued by the device via the communicator or indirectly due to engine shutdown, the shift lever remains in position in both circumstances (26, 27).

As illustrated in FIG. 7a, the parameters of the Device Control Routine can be selected by the user to enable power restoration to necessary vehicle systems shut-off as part of the engine shutdown sequence (32). In order to prevent an auto-restart that might result from power restoration to an engine that has residual rotation, the device determines when it is safe to return power (32). Alternative methods include measuring when RPMs have fallen below a threshold level or a set number of seconds have passed before power is restored. The vehicle now has the ignition on, engine off, transmission in neutral with the transmission shift lever in a position other than park or neutral. When the engine is commanded to restart (28), the device follows the Actuator Board Routine and commands power via the communicator to necessary engine systems for a restart (if the necessary systems are not already on) and then to the starter motor. The device monitors via the communicator the engine and once it has restarted, the device commands, via the communicator that power be cut to the starter motor. Typically, a vehicle's controller will return the transmission to the appropriate state, indicated by the transmission shift lever, when started under the conditions described in this case; however, if a particular vehicle model does not do so, this function can be commanded by the device via the communicator.

Many vehicles have a neutral safety switch or an equivalent feature to prevent an engine from restarting when the shift lever is in a gear other than drive or park. As illustrated in FIG. 5a, the device bypasses the circuitry to restart the engine from any transmission shift lever position by sending an override command to the appropriate vehicle system (31), such as the controller, enabling an engine restart. A similar bypass tactic using electrical signals can be used if the vehicle has features that disallow an engine shutdown. In the engine restart conditions illustrated in FIG. 7a, the vehicle's controller will typical return the transmission to the appropriate state indicated by the transmission shift lever and the vehicle's operating parameters (e.g. speed, engine load, etc.) (29). However, if a particular vehicle model does not do so, this gearshift can be commanded by the device via the communicator. The device can issue commands, via the communicator, that will minimize vehicle lurching that might occur when transmission returns to gear following an engine restart. To minimize lurching, the device can optionally issue a command via the communicator, for the transmission pump to lower transmission oil pressure, (30) and/or issue a command to change the configuration of the transmission shift valve (30) and/or send a mimicry signal with higher than measured RPM values to cause the transmission control unit to re-engage the transmission at lower than normal engine speed. If a vehicle is equipped with a launch control feature, the device can use this system via the communicator to minimize lurching when the transmission returns to gear 29). Launch control is a feature that enables vehicles to accelerate smoothly from a standing start.

In another embodiment of a system process, the device uses an Actuator Board Control Routine, which is classified as an “operational routine,” to shut-off and restart the engine of a vehicle with a manual transmission. This routine is illustrated in FIG. 7b. This routine is based upon the Actuator Board Routine illustrated in FIG. 5b but includes additional steps required to prepare a vehicle for driving during an engine shutdown or restart. In the Actuator Board Control Routine, a command to shut-off (1025) or turn on (1028) the engine is controlled by the Actuator Board Routine. In the Actuator Board Control Routine, the device sends commands via the communicator to the Actuator Board and those additional vehicle systems required to restart the engine.

The Actuator Board Control Routine begins with a command issued to shutdown (1025), or restart (1028) the engine. The driver signaling the device, such as by actuating the switch, may initiate a command or using routines governed by AERDI, AERA, or the Coast Application or other application that turns the engine on or off. In the case of an engine shutdown, the device issues a command via the communicator to the Actuator Board that begins the Actuator Board Routine to shut-off the engine. Systems that can be shutdown include the engine controller, the fuel injectors, fuel pump, ignition system, etc. As illustrated in FIG. 6b, the driver can optionally shift the transmission to neutral or disengage the clutch (1026) prior to commanding a power cut to the vehicle systems.

As illustrated in FIG. 6b, the embodiment in FIG. 7b can enable power restoration to necessary vehicles systems shut-off as part of the engine shutdown sequence (1032). In order to prevent an auto-restart that might result from power restoration to an engine that has residual spinning, the device determines when it is safe to return power (1032) using information provided by the communicator. Alternative methods include measuring when RPMs have fallen below a threshold level or a set number of seconds have passed before power is restored. The vehicle now has the ignition on, and engine off. When the engine is commanded to turn on (1028), the device follows the Actuator Board Routine and provides power to necessary engine systems for a restart (if the necessary systems are not already on) and then to the starter motor via the communicator. The device monitors the engine, using information provided by the communicator, and once it has restarted, the device commands via the communicator the Actuator Board to cut power to the starter motor (1029). The engine is now on (1024).

Many manual transmission vehicles have a clutch interlock or an equivalent feature to prevent an engine from restarting when the clutch is engaged. As illustrated in the Actuator Board Routine in FIG. 5b, the device via the communicator or the Actuator Board bypasses the circuitry to restart the engine by sending an override command to the appropriate vehicle system (1031), such as the engine controller, enabling an engine restart. The Actuator Board sends the bypass signal as in FIG. 5b. A similar bypass tactic using electrical signals can be used if the vehicle has features that disallow an engine shutdown. In the engine restart conditions illustrated in FIG. 7b (1029), the engine is commanded to restart.

The device has an “operational routine,” referred to as the “Device Engine Master Restart Routine,” which is used to select between an accumulator, starter motor or combination restart for an automatic transmission vehicle. This embodiment of a system process is illustrated in FIG. 8. All three methods can use either the “Device Control Routine” or the “Actuator Board Control Routine” to restart the engine on an automatic transmission vehicle. The device sends a command via the communicator to the computer port or to auxiliary electronic devices to start the engine (210). The device via the communicator gathers information from the computer port and optionally auxiliary equipment (211). The device uses information provided by the communicator to determine if the operating parameters are within limits (212) using the criteria of the restart subroutine 1 in FIG. 9. If the operating parameters are not within limits (212), the device may optionally issue an alert (213) via the communicator. If the operating parameters are within limits (212), the device may optionally issue an alert (214) via the communicator and select a starting method using subroutine 1, subroutine 2 or both (215, 218). After selecting the starting method (215, 218), the engine restarts (216). In automatic transmission vehicles equipped with a pressure accumulator, the device determines, using information provided by the communicator, if there is sufficient pressure available for an accumulator restart, or whether the starter motor should be used with the accumulator or the starter alone (215, 218). Once the engine is restarted (216), the transmission returns to appropriate gear (217) using the transmission controller or the device via the communicator. The vehicle is driving with the engine on. The device may optionally alert the driver via the communicator if operating parameters are out of limits (213, 214).

In another embodiment of a system process, the device uses the “Restart Subroutine 1” to select amongst several methods to restart the engine of an automatic transmission vehicle as illustrated in FIG. 9. This “Restart Routine” is classified as an “operational routine,” and it can implement either the “Device Control Routine” or the “Actuator Board Control Routine” to restart an engine. When the Restart Subroutine 1 is invoked (410), the device gathers information from the vehicle computer port via the communicator, and optionally from auxiliary electronics and sensors. If the ignition is not on (411), or the engine is on (412), the device takes no action and the command is aborted (414). If the engine is off (412) and the ignition is on (411) and the vehicle is not moving (413), the device, via the communicator, restarts the engine with the starter motor (418). If the vehicle is moving (413), the device determines, using information provide by the communicator if there is a transmission fluid pressure accumulator (415) which can restart the engine. (See FIGS., 56, 57, 58, 59 for details on an accumulator restart.) The accumulator restart of an automatic transmission vehicle is equivalent to a “bump start” in a vehicle with a manual transmission. If there is no transmission fluid pressure accumulator (415), the device commands via the communicator a restart of the engine using the starter motor (418). If there is a transmission fluid pressure accumulator (415), the device, using information provided by the communicator, evaluates a number of vehicle and accumulator parameters, as defined by the Accumulator Restart Checklist illustrated in FIG. 11, to determine if the transmission fluid pressure accumulator can be used to restart the engine (416). If these conditions are met (416), an accumulator restart routine is initiated (419). If the conditions are not met (416), the device, using information provided by the communicator, then evaluates the potential for a combined accumulator restart with an assist from starter motor (417) using the Accumulator Restart Checklist. In the case of a starter motor assist, the accumulator discharge has already caused the clutch or clutches to engage with the transmission and power is being delivered from the turning wheels to the torque converter. The starter motor can add additional force to complete the engine restart. A combined restart should require less power from the starter motor resulting in less wear on the starter motor components. As the transmission fluid pressure accumulator begins discharging fluid into the transmission, the device, using information provided by the communicator, takes interim measurements on a number of parameters including changes in accumulator pressure, transmission fluid flow rate, engine RPM, engine temperature, transmission oil temperature and changes in transmission pressure (422). If the interim measurements indicate a successful accumulator restart is unlikely within a defined period of time (422), the device, via the communicator, initiates a combined accumulator—starter motor assist restart routine (420). Following the interim measurements (422), the device, via the communicator, checks if the transmission fluid pressure accumulator has successfully restarted the engine after a programmable period of time (423). If it has not (423), a joint accumulator-restart routine begins (420). If the operating conditions are not correct for an accumulator restart or an accumulator starter motor assist restart, the device, via the communicator, initiates a starter motor restart (418). If yes (422), the device, via the communicator, continues with an Accumulator Restart Routine (424) and on to the master restart routine (421).

In another embodiment of a system process, as illustrated in FIG. 10 the device uses “Restart Subroutine 2” to prioritize between available restart methods. A vehicle equipped with an automatic transmission may be “bump started” like a vehicle having a manual transmission if it is equipped with a transmission pressure accumulator that can create hydraulic pressure in the transmission when the engine is shut-off. The device, using information provided by the communicator, can assess vehicle parameters and determine the best method for restarting the engine of such a vehicle. The device, using information provided by the communicator, initially assesses if an accumulator restart is possible (235) by using the Accumulator Restart Checklist as illustrated in FIG. 11 to measure operating parameters of the vehicle and charge state of the accumulator. If an accumulator restart is not possible (235), the device, using information provided by the communicator, next assesses if an accumulator restart with starter motor assist is possible (236), and finally whether a starter motor restart is required (237). In either case (e.g. accumulator restart (236) or combined accumulator starter motor restart (237), the device, using information provided by the communicator, determines the appropriate gear to use as fluid pressure becomes available in the transmission to restart the engine (240, 242) using the vehicle and accumulator operating parameters. In the event that a starter motor restart is used (239), the engine is restarted while the transmission is in neutral upon which either the vehicle controller (or optionally the device, via the communicator) selects the appropriate gear. All three types of restarts will preferably occur while leaving the transmission shift lever in a position other than park or neutral such as drive. The device can use either the “Device Control Routine” or the “Actuator Board Control Routine” to restart the engine using the starter motor, the accumulator or a combination of both methods. After a given restart routine has begun (239, 241, 243), it is completed by the Master Restart Routine (244).

In some embodiments, as shown in FIG. 11, the device uses a combination of checklists and operating routines to regulate commands for engine shutdown or restart by application modules. Checklist evaluations described in FIG. 11 can be used for both automatic and manual transmission vehicles. In determining whether to issue a command, the device uses information provided by the communicator, and monitors the vehicle operating parameters. The specific parameters and parameter values checked vary by vehicle type and can be dependent on the application module used by the device and the driver preference settings. Once a command has been issued, the device can use either the “Device Control Routine” or the “Actuator Board Control Routine” to stop and restart the engine. If the vehicle is operating within appropriate parameters (247) for the selected application module, the device takes no action (245) and continues to monitor vehicle parameters (246). If the vehicle is operating outside of appropriate parameters (247), the device gathers information provided by the communicator, to determine if the engine is on (248). If the engine is on (248), the device will place any application module commanding an engine shutdown into Standby Mode (249) until the vehicle is operating within appropriate parameters (249). The device may alert the driver, via the communicator, that the operating parameters are not within limits (250). If the engine is off (248), the device runs the Engine Restart Checklist (251) using information provided by the communicator. If the Engine Restart Checklist evaluation indicates that operating parameters are appropriate (252, 254), the device commands, via the communicator, an engine restart using the “Device Control Routine” or the “Actuator Board Control Routine” (254). If the Engine Restart Checklist evaluation indicates that operating parameters are not appropriate (252, 255), the engine remains off until vehicle parameters are correct (255). The device, via the communicator, optionally alerts the driver that the operating parameters do not permit an engine restart (256).

In evaluating whether a command to turn an engine on or off is to be issued and/or executed, the device uses “Look-up Checklists” for the application module(s) selected and compares it to relevant vehicle operating parameters at the time, as illustrated in FIG. 11. A checklist has values for each parameter as well as corresponding commands if the conditions are not within limits or otherwise not appropriate for a given command. Each checklist may be modified to reflect the driver's preferences in terms of defining parameter values and limits and the type of corrective action to be taken by the device. For instance, the device may refuse any command to turn off the engine if the vehicle is traveling above a speed limit as defined in the user preferences. In addition to the parameters listed in a given checklist, the device may request additional vehicle operating data via the communicator for a specific mode to determine if a command is to be executed or not. The device, via the communicator can also use standard OBD-II PIDs (on-board diagnostics Parameter ID's), which are diagnostic codes that can be used to request data from a vehicle or J1939 or other equivalent parameter. The OBD-II PID data can also be used to determine if necessary vehicle systems are operating correctly or if the vehicle controller has issued any error codes. For instance, the device may not execute a command to shut-off the engine if there is an error for the alternator or other vehicle component needed to restart the engine.

The parameters for the Engine Shutdown Checklist include: turn indicator status, cruise control status, steering wheel position, accelerometer data, vehicle speed, engine speed, brake vacuum or available brake pressure reserve (vacuum or positive pressure depending on the type of brakes), current braking, high beam flashing, emergency lights status, parking brake status, accelerator position, defroster status, horn status, battery charge, windshield wipers status, climate control status, cabin temperature, ambient temperature, ECU status, check engine light status, wheel speed, traction control status, stability control status, anti-lock braking system status, vehicle direction, vehicle location, accessory power usage, and battery status (246, 247). The Engine Shutdown Checklist can use data from an inclinometer such as those sold by US Digital Inc. or ASM Sensor Inc. or those embedded in cell phones to determine a vehicle's incline. Mercury switches, GPS readings coupled with geologic contour maps, or accelerometers that provide inclination data can also be used to determine vehicle tilt. A vehicle's own inclinometer or stability control systems can be used to provide incline data over the computer port if it is available. The user can also set preferences with the Engine Shutdown Checklist to include parameters that have data provided over a network or by vehicle mapping systems including GPS based location data, information on the type of road driven, whether a given road has stop lights or stop signs, as well as traffic and weather conditions. The Engine Shutdown Checklist can also include engine temperature, catalytic converter temperature, engine cumulative on-time since last engine start, door open (ajar) status, trunk open (ajar) status, variables relating to turbocharger operation, whether the driver seat is occupied or not, proximity to train tracks, intersections, parking structures, off-road and other dangerous places. The Engine Shutdown Checklist can also include parameters related to emissions control, such as forbidding engine shutdown for emissions reasons such as during a diesel particulate filter high temperature excursion or when a catalytic converter's temperature is too low to effectively remove emissions. The data can originate from sensors located on the system, the vehicle or in auxiliary components.

These parameters must be within defined limits or have permitted status in order for the device to allow the engine to be shut-off. The device, via the communicator, checks and confirms that the vehicle components such as the starter motor, the alternator and the battery are operating properly or it does not execute a command to shut-off the engine. The device and or specific application modules can also be configured to go into Standby Mode when a vehicle is using systems that require large amount amounts of power such as those often used by commercial vehicles. These systems include refrigeration systems, power lifts, hydraulic systems, or turbochargers that require additional engine “on” time to cool down when the vehicle is stopped.

As part of the Engine Shutdown Checklist, the device can use a matrix of user preference settings, and GPS data to match the vehicle position and direction with data and commands sent over a network to determine if an engine shutdown is permitted. Commands to forbid or permit an engine shutdown can be based on real time data on local traffic conditions, road data (including road inclination), local weather conditions, the presence or absence of traffic lights, traffic light information including traffic light timing for one or a series of lights.

As part of the Engine Shutdown Checklist, the device, via the communicator, also checks to determine if it can properly communicate with the switch, Actuator Board or other system selected in user preferences. To approve an engine shutdown, the device, via the communicator, checks that specific components have appropriate signal or battery strength above a threshold value. The device does not execute a command for engine shut-off if it detects a communication error with vehicle or its other network components. The device, with information provided by the communicator, can also use vehicle or other sensors to place itself or a specific application modules into Standby Mode and not shut-off the engine. For instance, if auxiliary sensors or vehicle sensors detect that the vehicle is in a very steep incline, the preference settings may be selected such that the device does not shut-off the engine. If the check engine light comes on or the vehicle controller reports a malfunction, the preference settings may be set such that the device does not shut-off the engine. Additional preference configurations include driver preference as whether the engine restarts as a function of vehicle speed when a turn is detected. Power steering is more useful at low speeds so according to driver preference settings the engine can remain off if turning above a certain speed.

Once the engine has been shutdown, the device, with information provided by the communicator, monitors the use of power by electrical systems. If power usage cannot be measured directly, it is estimated by the device, which monitors which electrical systems are in use and uses the estimated power rate for each system. Using this information, the device can prohibit an engine shutdown until the battery is sufficiently recharged or it can optionally autonomously restart an engine to prevent a deep battery discharge.

The parameters for the Engine Restart Checklist include: Manual transmission vehicles must be in neutral or have clutch disengaged. Automatic transmission vehicles must be in a gear other than reverse. If the vehicle sensors detect the vehicle is in a turn, the user preferences for AERA or AERDI operating routines can be set so the engine will not restart.

Accumulator Restart Checklist: When evaluating if an accumulator or combined accumulator/starter motor restart, is possible the device evaluates the following variables and parameters: type of vehicle, vehicle speed, engine speed, engine temperature, transmission oil temperature, vehicle acceleration, vehicle deceleration, foot brake status, accelerator position, emergency brake status, windshield wiper status, stability and traction control, ABS, vehicle incline (e.g. uphill vs. downhill) and accumulator pressure. In implementing an accumulator or combined accumulator/starter motor restart, the device, using information provided by the communicator, evaluates the following variables in addition to those mentioned above: crankshaft position, changes in accumulator pressure, transmission fluid flow rate to the transmission, and changes in transmission pressure.

The Idle Restart Checklist measures the following vehicle operating parameters and states: cabin temperature, transmission status of an automatic or manual transmission vehicle, parking brake status, foot brake status, available battery power, power use by accessories, engine temperature, time of day, GPS or other location data and data on local idling regulations.

The Transmission Control Mode A Checklist includes the position of the transmission shift lever, accelerator position, minimum speed, maximum speed, ABS and vehicle stability control status, vehicle incline, current vehicle speed, engine RPM and parameters related to engine load (such as air flow, exhaust temp, fuel usage).

The Transmission Control Modes B & C Checklists include measurements on the position of the transmission shift lever, minimum speed, maximum speed, ABS and vehicle stability control status, vehicle incline, wheel position to measure turning, accelerometer data to determine in the vehicle is in a turn.

The parameters for the Automatic Engine Restart-Driver Input (AERDI) Checklist include: accelerator position, turn indicator status for moving vehicle, steering wheel position, accelerometer data, current braking status, emergency lights status, defroster status, windshield wipers status. The device, using information provided by the communicator, monitors these systems and compares them to the user preference settings in order to determine if the engine should be restarted. For instance, in the case of engine off coasting, the device, using information provided by the communicator, can interpret an increase in accelerator position as a request for engine power and restart the engine. Additional conditions can be placed on whether the engine restarts such as current vehicle speed in combination with a detected turn. Power steering is more useful at low speeds, therefore according to driver preference settings, the vehicle can remain off if turning above a certain speed. Multiple parameters can be set to the driver preference settings to determine when a change in engine state is permitted or prohibited.

The parameters for the Automatic Engine Restart—Autonomous (AERA) Checklist include: low brake reserve which could be either low vacuum or positive pressure depending on the type of braking system, low battery charge, climate control status, cabin temperature, ambient temperature, engine temperature, ECU status, check engine light status, wheel speed, traction control status, stability control status, cruise control status, parking brake status, accelerator position, distance vehicle has coasted with engine off, vehicle speed, accelerometer data, and vehicle position and direction. The device, via the communicator, can also automatically restart the engine if the device loses communication with any of the auxiliary components or the switch. In the event the device loses communication with the key vehicle controllers, the device goes into Standby Mode until communication is reestablished and issues an error alert to the driver. These parameters are monitored by the device, using information provided by the communicator, to determine if an autonomous command is required to restart the engine. For instance, if the device, using information provided by the communicator, determines brake reserve is out of acceptable range, it can automatically restart the engine to restore the power brakes.

The parameters for the Clutch Actuated Engine Shut-Off (CAESO) Checklist include: minimum vehicle speed, maximum vehicle speed, engine speed, brake vacuum or available brake pressure reserve (vacuum or positive pressure, depending on the type of brakes), current braking, accelerator position, emergency lights status, parking brake status, accelerator position, battery charge, windshield wipers status, climate control status, cabin temperature, ambient temperature, ECU status, check engine light status, wheel speed, traction control status, stability control status, anti-lock braking system status, battery status, vehicle location and direction (246, 247). These parameters must be within defined limits in order for CAESO to be utilized. The device, using information provided by the communicator, checks if the vehicle components such as the starter motor, the alternator and the battery are operating properly, or it does not execute CAESO commands. CAESO can also be configured to go into Standby Mode when a vehicle is using systems that require large amount amounts of power such as those often used by commercial vehicles. These systems include refrigeration systems, power lifts, and hydraulic systems, air conditioners, or turbochargers that require additional engine “on” time to cool down when the vehicle is stopped. The device, using information provided by the communicator, also checks to determine if it can properly communicate with the device switch, the device's auxiliary components, the vehicle controllers and vehicle components, and that the device switch signal or battery strength is above a threshold value. The device does not execute CAESO commands for engine shut-off if there is any error in communication. The device, using information provided by the communicator, can also cross reference data from vehicle or other sensors, such as an inclinometer, with the user preference settings to place CAESO into Standby Mode and not shut-off the engine. If the check engine light comes on or the ECU reports a malfunction, the preference settings may be set such that the device does not shut-off the engine. The incline of the vehicle determined by the device using information provided by the communicator, vehicle or aftermarket sensors such as an inclinometer sold by US Digital Inc. or ASM Sensor Inc. or those embedded in cell phones, can be used to sense vehicle incline by interfacing to the device, using information provided by the communicator. Mercury switches or GPS readings coupled with geologic contour maps can also be used to determine vehicle tilt. A vehicle's own inclinometer can be read over the computer port if available. Vehicle tilt measurement can be used to determine whether CAESO will be used.

As part of the CAESO Checklist, the device can use a matrix of user preference settings, GPS data to match the vehicle position with data and commands sent over a network to determine if an engine shutdown is permitted. Commands to forbid or permit an engine shutdown can optionally use real time data on local traffic conditions, road data (including road inclination), local weather conditions, traffic light information, and whether a vehicle is approaching a stop sign or a traffic light.

The Coast Application allows the driver to shutdown and restart an engine while a vehicle is moving. The Coast Application uses routines based on the checklists for engine shutdown, AERDI, AERA and engine restart, and accumulator restart in determining whether an engine restart or shutdown is permitted. In addition, the Coast Application has other settings that can be set according to user preferences including: The engine shuts-off when the accelerator is released. This feature allows the driver to use the pedal or a Cruise Control Application to save fuel by shutting off the engine without using the switch. The Coast Application can restart the engine if the vehicle is stopped and the driver releases the foot brake. As a safety feature, the device can be set to prevent a command for engine restart if the vehicle is in a state of turning. In another setting, the device, using information provided by the communicator, makes use of residual engine spinning to restart the engine without having to use the starter motor or the accumulator.

The parameter measured for the Speed Rules Checklist include: type of road, time of day, speed limit for given road, status of stability and traction controls, ABS status, environmental conditions (rain, external temperature, etc.), emergency light status, headlight status, road inclination, accelerometer status, steering wheel sensors, wheel speed sensors, air bag sensors.

In another embodiment, the device uses operational routines based on checklists to regulate commands for engine shutdown or restart by application modules in a manual transmission vehicle. This embodiment of a system process is illustrated in FIG. 12. In this embodiment, the device can use either the “Device Control Routine” or the “Actuator Board Control Routine” to stop and restart the engine. The device, using information provided by the communicator, monitors the vehicle operating parameters (428) determines if the vehicle parameters are within limits (432) using the AERA Checklist (FIG. 11). If the vehicle is operating within limits (432), the vehicle continues (425) and the device continues monitoring (428) using information provided by the communicator. If the operating parameters are outside of limits (432), the device checks if the engine is running (434) using information provided by the communicator. If the engine is off (434), the device runs through the Engine Restart Checklist to determine if a restart is permitted (437). If yes, the device alerts the driver, via the communicator, to a pending engine restart (439) and commands an engine restart using the starter motor (439). This routine would be useful if the vehicle's reserve brake pressure or vacuum was too low and an engine restart is appropriate to replenish brake pressure. If the device determined that an engine restart was not appropriate (437), the engine would remain off until the restart parameters are correct (436) and an alert is issued to the driver (438). Circumstances in which the device may prohibit an engine restart can include if the vehicle is in mid-turn. Restart of the engine changes the status of the power steering and to do so mid-turn could lead to error. Instead the device continues to monitor vehicle operating parameters (432) and restart conditions (437) and restarts the engine when appropriate using information provided by the communicator. In this embodiment, the device also determines that the transmission is in neutral or the clutch disengaged before initiating the restart routine using information by the communicator. This check can be done by measuring vehicle speed and engine RPM and inferring that the vehicle is in neutral, or through a vehicle or auxiliary sensor.

In another embodiment, the system uses the Actuator Board to restart the engine when it detects a communication error with the device or communicator, or when the device issues an error alert, via the communicator, commanding an emergency restart. This embodiment of a system process is shown in FIG. 13. In certain circumstances, the device, communicator or the switch may malfunction or cannot communicate appropriately leaving the driver unable to restart the vehicle's engine on command. This situation may arise for example when the switch malfunctions, the switch's battery power is too low or when the device or communicator is knocked loose from the communications port. In addition, the device, via the communicator, may issue an emergency restart command to the Actuator Board if the device detects it cannot communicate with critical vehicle systems such as the engine controller. When the vehicle is driving with the communicator attached to the computer port, the Actuator Board is in communication with the device (650). If the Actuator Board detects a communication error with the device, looses communication with the device after a set period of time, or the device issues an emergency restart command via the communicator (651), the Actuator Board begins the Emergency Restart Routine (652). The Actuator Board first checks if the engine is on (653). If the engine is on (653), the engine remains on and the Actuator Board goes into Standby Mode until the device resets the Standby Mode (654) via the communicator. If the engine is not on (653), the Actuator Board provides power to the circuits for the engine computer and starter motor (655). An alert is issued to the driver (655). In some vehicles, a neutral safety switch prevents the engine from restarting if the transmission shift lever is not in park or neutral. If required, the Actuator Board sends a signal to the appropriate electrical connection on the starter motor circuit to mimic the signal indicating that the neutral safety switch is not needed (656) allowing the engine to be started from any gear. The Actuator Board detects when the engine has restarted and shuts off the starter motor by turning off the circuit (657). The engine and engine computer are on and the Actuator Board goes into Standby Mode until the device is reset (650).

In another embodiment, the device, using information provided by the communicator, checks to confirm that the device is being used on the appropriate type of vehicle and conducts a safety check. This embodiment is illustrated in FIG. 14. Different vehicle models use different types of controllers, software and components; therefore, the device requires programming for specific vehicle models. If used on the wrong model of vehicle, the device and or vehicle may not work properly which presents safety concerns. As a further safety check, the device confirms it can both communicate and control necessary vehicle systems to safely operate the vehicle. As part of this initial check, the device runs through the “Vehicle and System Identification Checklist” in two parts System Check Part 1 and System Check Part 2 (86 and 91). In FIG. 14, the engine is on and the communicator is connected to the vehicle computer port (86). The device begins System Check Part 1, using information provided by the communicator, by looking up the vehicle identification number (87) which the device then decodes to determine if it is connected to the appropriate vehicle make, model and year (88). If the device is not connected to an appropriate vehicle (88), an alert is sounded and the device goes into Standby Mode (94). If the device is connected to an appropriate vehicle (88), it makes an assessment of the available vehicle systems and aftermarket parts that it may need to monitor or control (89). The device next loads the driver preference settings for any relevant vehicle systems plus those that are minimum requirements to operate on any vehicle. The device next runs System Check Part 2, using information provided by the communicator, to determine if the necessary systems are available and functioning to safely use the device on the vehicle (91, 92). System Check Part 2 confirms if the software installed is valid and the version is approved by the manufacturer of the device (91, 92). The specific requirements are dependent on the type of application module selected and the driver preference settings. For instance, the Start Stop Modes require the ability to successfully take measurements for the parameters defined in the Engine Shutdown Checklist and the AERDI and AERA Checklists. The Coast Mode would require measurements for the preceding three checklists plus the Coast Checklist. If the driver has selected a preference to use an auxiliary device, System Check Part 2 will make sure those systems are available. Auxiliary devices may include a switch, a transmission pressure accumulator, a brake pressure sensor, a GPS unit, automated clutch actuator, inclinometer, cell phone, monitor display, and a system enabling communication between the device, communicator and a network. If System Check Part 2 is not passed by the device (92), an alert is issued via the communicator and the device goes into Standby Mode (94). If the System Check Part 2 is passed, the driver is notified via the communicator and the device becomes active.

In one embodiment, the device uses a start and stop application module for an automatic transmission vehicle. This embodiment of a system process is illustrated in FIG. 15. In this embodiment, the device can use either the Device Control Routine or the “Actuator Board Control Routine” to stop and restart the engine. Start Stop Modes provide a useful option for fuel savings and emission reductions in situations where the vehicle would simply idle. At a long stop, such as at a traffic light, the fuel which would be consumed in idling the engine can be saved by executing a command to stop the engine. In this embodiment, the device waits for the driver to provide a signal to turn the engine on or off. As a safety feature, the device requires the driver to keep the vehicle stopped (less than Threshold Speed 1 (TS1)) with the foot brake depressed. If the vehicle begins to move (81) or the foot brake is released (81), the engine will automatically restart (82b). When the driver signals the device to shut-off the engine (75), the device uses information provided by the communicator from the computer port to determine if the vehicle parameters are appropriate for shutting off the engine (76). The device, using information provided by the communicator, uses a relevant subset of parameters listed in the Engine Shutdown Checklist illustrated in FIG. 11 including status of battery power, alternator, starter motor, check engine light, stability safety systems, vehicle incline, antilock brake system, etc. The operating parameters of these variables must be in an acceptable range or permitted status for the device to proceed with the command to execute engine shut-off (76). The device, using information provided by the communicator, next determines if the vehicle speed is less than TS1 (78) and the foot brake is engaged (78). If yes, the device, via the communicator, proceeds with the Device Control Routine (FIG. 6) to shutdown the engine. Alternatively, if an Actuator Board is used, the device, via the communicator, proceeds with an engine shutdown using the Actuator Board Control Routine (FIG. 7a). Under either routine, the device, via the communicator, optionally shifts the transmission to neutral (79) and the engine is shut-off (79). While the engine is shut-off, the device, using information provided by the communicator, regularly checks to confirm that the vehicle speed is less than TS1 and the foot brake is engaged (81). If the vehicle speed is greater than TS1 or the foot brake is not engaged (81), the device, via the communicator, restarts the engine (82b) using the device control routine (FIG. 6) or the Actuator Board Control Routine (FIG. 7a). If the driver signals the device (80) while the vehicle is at a speed less than TS1 with the engine off and the brake engaged, the engine is restarted (82a) using the Device Control Routine (FIG. 6a) or the Actuator Board Control Routine (FIG. 7). Once the engine is restarted (82a), the vehicle is allowed to idle at a speed less than TS1 while the foot brake is engaged (83). To re-initiate engine off command, the driver signals the device again (75).

In one embodiment, the device uses an application module to provide a Start Stop Mode for an automatic transmission vehicle with a next stop pre-command feature. This embodiment of a system process is illustrated in FIG. 16. In this embodiment, the device can use either the “Device Control Routine” or the “Actuator Board Control Routine” to stop and restart the engine. This embodiment is similar to the Start Stop Mode for an automatic transmission vehicle discussed in FIG. 15. The additional feature enables the driver to send a pre-command by signaling the device (269) while the vehicles speed is greater than TS1 to shut-off the engine the next time the vehicle speed is less than TS1 and the foot brake is engaged. The command must be executed within a defined period of time or it expires (275). The advantage of this feature is one of convenience, allowing the driver to command the engine off in advance of a stop.

In another embodiment, the device provides a start and stop application module for a manual transmission vehicle. This embodiment of a system process is illustrated in FIG. 17. In this embodiment, the device can use either the “Device Control Routine” or the “Actuator Board Control Routine” to stop and restart the engine. This embodiment operates in the same manner as the start stop device for the vehicle having an automatic transmission illustrated in FIG. 15. The difference is that the device has the further requirement that the engine cannot be shut-off or turned on until the driver has either shifted to neutral, or disengaged the clutch (293a, 298a). In some vehicle models, the device may not be able to measure the clutch or transmission status. In this case, the device can infer that the vehicle is in neutral, using information provided by the communicator, because vehicle speed is less than TS1 and the engine is still running.

In another embodiment, the device provides a start and stop application module for a manual transmission vehicle, with the pre-command feature. This embodiment of a system process is illustrated in FIG. 18. In this embodiment, the device can use either the “Device Control Routine” or the “Actuator Board Control Routine” to stop and restart the engine. This embodiment is almost the same as the Start Stop Mode for a manual transmission vehicle, discussed above, with the exception that the device can optionally delay an engine shut-off when the driver signals the device (283, 288). Instead it sends a pre-command so that the next time the speed is less than TS1, the foot brake is on and the transmission disengaged, the device, via the communicator, shuts off the engine (290). The advantage of this feature is to allow the driver to command the engine off without having to wait for the vehicle to reach TS1 with the foot brake on. In the event, however, that the vehicle does not reach TS1 within a period of time, for instance 60 seconds, the pre-command is aborted.

In another embodiment, the device provides Automatic Engine Turn On and Shut-Off (AETSO) without driver input using an “application module.” This embodiment of a system process is illustrated in FIG. 19. This embodiment shuts the engine off when the vehicle with an automatic transmission is stopped with the foot brake engaged. In this embodiment, the device can use either the “Device Control Routine” or the “Actuator Board Control Routine” to stop and restart the engine. It achieves the same results as a shutdown commanded by the driver (FIG. 18) except that it is automatic and requires no driver input. When AETSO is enabled (180), the device, using information provided by the communicator, gathers information from the vehicle computer port to determine if the vehicle speed is less than TS1 (181). If this condition is not met, the vehicle continues driving with AETSO enabled (180). If the vehicle speed is less than TS1 (181), the device, using information provided by the communicator, gathers information from the vehicle computer port to determine if the engine is on (182). If the engine is on (182), the device, using information provided by the communicator, gathers information from the vehicle computer port to determine if the foot brake is engaged (183). If yes (183), the device, using information provided by the communicator, checks if the vehicle parameters, as illustrated by the Engine Shutdown Checklist (FIG. 11), are within limits (184). For instance, the device, using information provided by the communicator, checks if the battery has sufficient power to restart the engine before permitting an engine shutdown. If no (184), the device, via the communicator, allows the engine to remain on with AETSO monitoring the vehicle (180). The device, via the communicator, may optionally issue an alert to the driver in the event a shutdown is denied (190). If the parameters are correct (184), the device, via the communicator, optionally shifts the transmission to neutral while leaving the transmission shift lever in its initial position (e.g. “Drive”), and then shut-off the engine after a programmable delay (185). The engine remains off as long as the foot brake remains engaged (186, 187). When released (186), the device, via the communicator, commands an engine restart (189), and the transmission is returned to the appropriate gear (191) by the device via the communicator or the vehicle controller.

In addition, the device may cross reference GPS data with map data from a network, or the vehicle's mapping system, and amend the Engine Shutdown Checklist to account for user preference settings. For instance, a driver can elect to permit an engine shutdown at a stoplight but not in the case of a stop sign. The device can use network data sent to the communicator, to determine if the vehicle is stopped at a red light or not. The driver can select preferences settings to have AETSO remain in Standby Mode unless at a traffic light as opposed to a stop sign or other type of stop. The communicator can receive information about how long a light will remain red which is conveyed to the device. The device can then refer to user preferences to determine if enough time remains to issue a command for an engine shutdown and when to issue a command for an engine restart. The user may set preference settings to use GPS data and traffic data provided by a network. If the network reports the vehicle is in a location with stop and go traffic, the Start Stop Mode temporarily goes into Standby Mode until the network reports more favorable traffic conditions have resumed for using the application.

In another embodiment, the device provides Automatic Engine Turn On and Shut-Off (AETSO) with driver input and engine shut-off occurs after a programmable delay period with an “application module.” This embodiment is illustrated in FIG. 20. In this embodiment, the device can use either the “Device Control Routine” or the “Actuator Board Control Routine” to stop and restart the engine. In this embodiment, the device runs through the Automated Engine Shut-Off Routine (105, 106, 108, 109, 110, 111) illustrated in FIG. 19. Another feature of this embodiment of the device is that the driver can signal the device, via the communicator, with the engine off (115) which temporarily puts AETSO into Standby Mode (Standby Mode A) (116), and the engine is restarted (118). In particular, when the vehicle speed is less than TS1 or the vehicle is stopped (112), and the foot brake is engaged (112), the driver is able to start the engine without disengaging the foot brake. This feature is useful when the driver elects to restart the engine even though the vehicle is stopped with foot brake applied. Starting the engine pre-emptively could be desirable if the vehicle is stopped pointing up a steep hill and the driver wants the engine on before releasing the foot brake to avoid rolling backwards. When the driver selects this option, AETSO is temporarily placed into Standby Mode until the vehicle moves again. When the vehicle starts moving, AETSO automatically resumes (114) and stops the engine the next time vehicle speed is less than TS1 with the foot brake depressed. In all other respects, this embodiment of the device behaves like the device illustrated in FIG. 19.

In another embodiment, the device provides Automatic Engine Shut-Off and Turn On (AETSO) with driver input, having a Standby Mode using an “application module.” This embodiment of a system process is illustrated in FIG. 21. In this embodiment, the device can use either the “Device Control Routine” or the “Actuator Board Control Routine” to stop and restart the engine. In this embodiment, the driver signals the device to command, via the communicator, the device to put AETSO into a Standby Mode (Standby Mode B) (190). When the vehicle speed greater than TS1 (191), the driver may signal the device, such as by actuating a switch, to place AETSO into a Standby Mode (Standby Mode B) (192). The engine does not shut-off when the foot brake is engaged and the speed of the vehicle is less than TS1 (193). If the vehicle speed goes above TS2, the Standby Mode B is aborted and AETSO is also reengaged (194). Optionally, an alert may be issued to the driver (198). This embodiment is useful when the driver is going from a steady driving condition to stop-and-go driving. For example, a driver might use this mode if he is leaving an expressway and there is stop-and-go traffic at the exit ramp. If the driver signals the device while in Standby Mode B (195), AETSO is reengaged (196). The driver may receive an alert in the change of Standby Mode status (198).

In another embodiment, the device provides Automatic Engine Shut-Off and Turn On having Standby Mode B with a timer feature using an “application module.” This embodiment of a system process is illustrated in FIG. 22. In this embodiment, the device can use either the “Device Control Routine” or the “Actuator Board Control Routine” to stop and restart the engine. In this case, the driver can signal the device (200) while the vehicle is traveling at any speed less than TS1 (201). If the vehicle does not reach speed TS1 after time T1 (for example 60 seconds) (202), the Standby Mode B is turned off (204) and the vehicle resumes driving with AETSO on (199). An alert may be issued to the driver when the Standby Mode B expires (203). If the vehicle does reach speed TS1 with the foot brake applied within T1 seconds (205), AETSO leaves the engine on and the device stays in Standby Mode B (205) until the vehicle travels above TS2 (206) and AETSO (199) resumes active status. An alert may be issued to the driver when Standby Mode B is turned off (206).

In another embodiment of the device, the Automated Engine Turn On and Shut-Off (AETSO) is used in a vehicle with a manual transmission using an “application module.” This embodiment of a system process is illustrated in FIG. 23. In this embodiment, the device can use either the “Device Control Routine” or the “Actuator Board Control Routine” to stop and restart the engine. The AETSO for the manual transmission operates in a similar fashion to the AETSO for an automatic transmission as illustrated in FIG. 19. One important difference is that the embodiment for a manual transmission vehicle, illustrated in FIG. 24, has an additional Operating Parameter Check (54) to determine if the clutch is disengaged or the transmission is in neutral before shutting off or restarting the engine. The clutch transmission status can be inferred from vehicle speed and engine RPM as in previous examples or measured directly by sensors. Another difference with the manual transmission is that the driver selects the appropriate gear.

In another embodiment of the device, the Automated Engine Turn On and Shut-Off (AETSO) with Standby Mode A is used in a vehicle with a manual transmission using an “application module.” This embodiment of a system process is shown in FIG. 24. In this embodiment, the device can use either the “Device Control Routine” or the “Actuator Board Control Routine” to stop and restart the engine. The AETSO for the manual transmission operates in a similar fashion to the AETSO for an automatic transmission as illustrated for the FIG. 20. One important difference is that the embodiment in FIG. 24 has an additional Operating Parameter Check (63) to determine if the clutch is deployed or the transmission is in neutral before shutting off or restarting the engine this can be inferred from vehicle speed and engine RPM as in previous examples or measured directly by sensors. Further, the driver will select the appropriate gear.

In another embodiment, the device uses an application module to shut-off and restart the engine of a vehicle with an automatic transmission whether the vehicle is stopped or moving. Stopping the engine while the vehicle is moving allows it to coast with the engine turned off. This embodiment of a system process is illustrated in FIG. 25. Considerable amounts of fuel can be saved by Engine Off Coasting given appropriate vehicle parameters and driving circumstances. When engine power is not required such as coasting downhill or when a traffic light ahead is red and the vehicle must slow down. In this embodiment, the driver has both the “Coast Application” and the vehicle ignition turned on (295). In this embodiment, the device can use either the “Device Control Routine” or the “Actuator Board Control Routine” to stop and restart the engine. The driver signals the device while the vehicle is moving (296). The device next obtains information from the vehicle computer port, using information provided by the communicator, to determine if the engine is on (297). If the engine is on (297), the device, using information provided by the communicator, next checks if the vehicle parameters are appropriate for shutdown (298) using the “Engine Shutdown” and “Coast” Checklists. The purpose of this check is both for safety and vehicle operating considerations. If the parameter values are not correct (298), the device takes no action and optionally provides an alert (301). For instance, if the vehicle is traveling at too high a rate of speed, the device leaves the engine on and optionally issues an alert to the driver. If the engine is on and the vehicle parameters are within limits (298), the device, via the communicator, optionally shifts the transmission to neutral (299), and the device, via the communicator, provides a command through the computer port, or to the Actuator Board, to shut-off the engine (300). The option to shift to neutral (299) prior to engine shut-off minimizes additional noise or vehicle shuddering that can occur when a transmission goes from gear to neutral during an engine shutdown. During the engine shutdown and shift to neutral, the transmission shift lever remains in place (such as Drive). Alternatively, the device, via the communicator, may command an auxiliary device, such as the Actuator Board, to shutdown or restart the engine if a command cannot be issued through the computer port. The vehicle is now coasting with the engine off (302). To restart the engine, the driver signals the device (296). The device, using information provided by the communicator, again obtains information from the vehicle computer port to check if the engine is on or off (297). Having confirmed that the engine is off (297), the device uses the Engine Restart Checklist and restarts the engine while leaving the transmission shift in position (303). The transmission is shifted to the appropriate gear either by the vehicle controller or the device, via the communicator (304) and the vehicle continues driving (295). As in the previous cases where the engine with an automatic transmission is turned on or off, selection of the appropriate gear either by the device, via the communicator, or the transmission controller does not require the transmission shift lever to change its position. The shift lever can remain in drive as opposed to shifted to Park or Neutral as is typically required to restart the engine.

In another embodiment, the device uses the coast application module to shut-off or restart the engine of a vehicle with an automatic transmission whether the vehicle is stopped or moving. Stopping the engine while the vehicle is moving allows it to coast with the engine turned off. This embodiment of a system process is illustrated in FIG. 26. In this embodiment, the device can use either the “Device Control Routine” or the “Actuator Board Control Routine” to stop and restart the engine. The device uses the combination of AERDI (FIG. 11) and Coast Application (FIG. 26) Checklists and other coast module application commands illustrated in FIG. 25, to monitor the driver's use of vehicle systems and can interpret these actions as commands for an engine shutdown or restart. If an engine off command is ordered, the device, using information provided by the communicator, evaluates the vehicles operating parameters against the “Engine Shutdown” and “Coast” Checklists parameters to determine if it is appropriate to shutdown the engine. The device, via the communicator, allows the user to select preference settings as to which actions initiate an automated command for shutdown or restart. For instance, the driver may release the accelerator pedal to command an engine shutdown and press the accelerator pedal to command an engine restart. In all other respects, the embodiment, illustrated in FIG. 26, uses the same restart routines as the driver when the driver signals the device as illustrated in FIG. 25 including allowing the driver to stop or restart the engine by signaling the device such as by using the switch.

In another embodiment, the device uses the coast application module to monitor the vehicle operating parameters against the AERA Checklist to determine if it should issue an autonomous command to restart the engine of a vehicle with an automatic transmission. This embodiment of a system process is illustrated in FIG. 27. In this embodiment, the device can use either the “Device Control Routine” or the “Actuator Board Control Routine” to stop and restart the engine. In this embodiment, the device, via the communicator, can execute a command to restart the engine by comparing the criteria of the AERA Checklist to the operating parameters of the vehicle (316). By constantly measuring vehicle operating parameters using information provided by the communicator, the device can determine when it is necessary to restart the engine for safety or operational reasons. For example, the device, using information provided by the communicator, could take direct or indirect measurements to monitor brake pressure reserve and restart the engine when a threshold brake pressure reserve has been reached. If brake pressure cannot be measured with the existing vehicle systems, the device, using information provided by the communicator, can use an auxiliary sensor to take direct brake pressure measurements or can infer it from other available data such as the number of times and length of time the brake has been depressed. Alternatively, the device, using information provided by the communicator, could use a combination of indirect methods, such as an accelerometer algorithm detecting each braking event though deceleration, as a proxy measurement of the remaining brake pressure reserve. These measurements could include the number of times the brake has been used, the time duration of brake use, the position of the brake pedal or using data from vehicle or auxiliary accelerometers to determine when the brake pressure has reached a threshold level such that an engine restart is required. A second circumstance in which the device, via the communicator, may command an automatic engine restart is when the battery charge level falls beneath a threshold level of power. A third circumstance in which the device, via the communicator may issue an automatic engine restart is when the device, using information provided by the communicator, receives information from vehicle sensors, such as an accelerometer or steering wheel sensors, that the vehicle is turning. A fourth circumstance in which the device, via the communicator, may issue an automatic engine restart is when the vehicle has coasted with the engine off beyond a programmable distance to ensure proper lubrication of the transmission. In all cases, the device, via the communicator, may optionally issue an alert to the driver that an engine restart is initiating. When using the embodiment in FIG. 27, the driver has the option to signal the device (as illustrated in FIG. 25) or the vehicle systems (as illustrated in FIG. 26) to control the engine state. In all other respects, this embodiment operates in a similar method to FIGS. 25 and 26.

In another embodiment, the device, via the communicator, shuts off and restarts the engine of a vehicle with a manual transmission whether the vehicle is stopped or moving using an “application module.” This embodiment of a system process is illustrated in FIG. 28. In this embodiment, the device can use either the “Device Control Routine” or the “Actuator Board Control Routine” to stop and restart the engine. This embodiment is useful when the vehicle is coasting. The process for coasting with a manual transmission vehicle follows the same methods as the device illustrated in FIG. 25 other than those steps noted below. In executing commands, it uses the same checklists (e.g. “engine shutdown,” “coast” and “engine restart”) to evaluate operating parameters as the device illustrated in FIG. 25 other than those noted below. In the embodiment of a system process illustrated in FIG. 28, the driver selects the gear rather than the device or the vehicle controller. The device, using information provided by the communicator, checks if the driver has placed the transmission in neutral or has disengaged the clutch before shutting down or restarting the engine. If the driver requests a restart by signaling the device, the device, via the communicator, initiates a restart using the electric starter.

In another embodiment, the device uses the AERDI and Coast Checklists to shut-off or restart the engine of a vehicle with a manual transmission whether the vehicle is stopped or moving using an “application module.” This embodiment of a system process is illustrated in FIG. 29. Stopping the engine while the vehicle is moving allows it to coast with the engine turned off. In this embodiment, the device can use either the “Device Control Routine” or the “Actuator Board Control Routine” to stop and restart the engine. When used with AERDI, the Coast Application can execute commands to turn the engine on or off based on the driver's use of vehicle systems as illustrated in FIG. 26. In executing commands, it uses the same checklists to evaluate operating parameters as the device illustrated in FIG. 28 and also checks if the clutch is disengaged or the transmission is in neutral when turning the engine on or off. In addition, this embodiment supports a preference setting for the device to allow CAESO (FIG. 33) to conditionally shut-off the engine automatically, when the clutch is deployed or transmission is in neutral. Another difference between the embodiment represented in FIG. 28 is that driver is alerted, via the communicator, that the device is initiating an engine restart. In all other respects the embodiment in FIG. 29 is the same as FIG. 28.

In another embodiment, the device uses the AERA and Coast Checklists to shut-off or restart the engine of a vehicle with a manual transmission whether the vehicle is stopped or moving using an “application module.” This embodiment of a system process is illustrated in FIG. 30. In this embodiment, the device can use either the “Device Control Routine” or the “Actuator Board Control Routine” to stop and restart the engine. This embodiment is useful when the vehicle is coasting. In this embodiment, the device, using information provided by the communicator, monitors the vehicle systems and can compare the vehicle's operating parameters to the criteria of the AERA Checklist to execute an engine restart. This embodiment also allows the device, via the communicator, to control an auxiliary device (e.g. automatic clutch actuator) that can engage the clutch and return it to gear. When the device issues a command for Engine Off Coasting, it commands, via the communicator, the auxiliary device to disengage the clutch and shuts off the engine. Similarly, when the device, using information provided by the communicator, detects the conditions needed to restart the engine, it can command the motor to engage the clutch and bump start the engine. In all other respects, the embodiment in FIG. 30 behaves in a similar manner to embodiments in FIG. 27.

In another embodiment, the device uses both the AETSO, illustrated in FIGS. 19, 20, 21, 22, 23, and 24 and the Coast Application illustrated in FIGS. 25, 26, 27, 28, 29 and 30. This embodiment of a system process is illustrated in FIG. 31. In this embodiment, the device can use either the “Device Control Routine” or the “Actuator Board Control Routine” to stop and restart the engine. The figure illustrates the case where AETSO (821) and the Coasting Application (820) are both on when the driver signals the device (822). The device, using information provided by the communicator, then takes measurements to determine if the vehicle speed is above TS3 (e.g. 5 mph). If yes, the device operates in the appropriate Coast Application (825). In below speed TS3, the device operates in AETSO (824). The AETSO Standby Mode B feature is deactivated when vehicle speed is above TS3 (826).

In another embodiment, the device uses an “Operational Routine” to combine both the driver controlled Start Stop Modes, illustrated in FIGS. 15, 16, 17, and 18 and the applications for Engine Off Coasting, illustrated in FIGS. 25, 26, 27, 28, 29, and 30. This embodiment of a system process is illustrated in FIG. 32. In this embodiment, the device can use either the “Device Control Routine” or the “Actuator Board Control Routine” to stop and restart the engine. The same general rules as illustrated for FIG. 31 apply in this case. In this embodiment, the next stop pre-command feature of the Start Stop Mode is deactivated (832). If the vehicle is traveling above speed TS1 (835), the device operates in Coast Mode (837). Below speed TS1 (835), the device operates in Start Stop Mode (836).

In another embodiment, the device enables Clutch Actuated Engine Shut-Off (CAESO) using an “application module.” This embodiment of a system process is illustrated in FIG. 33. In this embodiment, the device can use either the “Device Control Routine” or the “Actuator Board Control Routine” to stop and restart the engine. The device, via the communicator, conditionally stops fuel use by the engine when the clutch is disengaged and can use the clutch pedal position as an input to command engine shut-off. Using the conditions set by the user in the CAESO Checklist, the engine can be shutdown when the clutch is disengaged. As described in detail in the description of FIG. 11, the CAESO Checklist includes such variables as vehicle speed, engine RPM, vehicle incline, accelerometer data, etc. In addition, this application uses the parameters defined by the “Engine Shutdown” Checklist in permitting or prohibiting an engine shutdown. Using CAESO, a driver can select settings to turn the engine off when the driver disengages the clutch including in the small amount of time spent shifting between gears. As soon as the engine is disengaged from the wheels (881) and the device, using information provided by the communicator, determines the parameters (891) are within limits by running the CAESO and Engine Shutdown Checklists, it turns the engine off. CAESO can be used to shut-off the engine when the transmission shift lever is in neutral. The driver can also set preferences to keep the engine on by maintaining their foot on the accelerator while the clutch is disengaged. To restart the engine, the driver can re-engage the clutch to bump start a moving vehicle or signals the device to command a starter motor restart. If the driver is just changing gears, cutting off the engine fuel consumption with each clutch action eliminates the parasitic fuel consumption that occurs when the engine is not in gear and delivering power to the wheels. As soon as the driver executes the gear change the engine turns back on. If it is a quick enough gear change, the engine's momentum prevents it from losing too much engine speed allowing a combination of engine auto-rotation (887) and “bump start” (890) to ensure a smooth gear change with no fuel use when the gear was not engaged. Over thousands of shifts, the fuel savings are significant. The vehicle can be allowed to coast with the engine off if the driver does not select a gear (884). The vehicle then behaves as a coasting vehicle illustrated in FIGS. 27, 28, 29. As defined in the description for FIG. 11, the user has a wide range of preference settings to select when CAESO shuts off the engine (891). Examples include having a programmable time delay by which the clutch must be disengaged or transmission is in neutral before the engine shuts off. This setting would prevent engine shut-off between quick gearshifts. Additionally, the driver may choose a setting such that the CAESO will not shut-off the engine when the vehicle is traveling below a threshold level of speed (e.g. 10 mph) or above a threshold level of speed (e.g. 70 mph). Some drivers may opt to have CAESO not shut-off the engine when the engine is travelling uphill, and the device, using information provided by the communicator, can use an inclinometer or accelerometer sensor to determine when specifications are exceeded and leave the engine on.

In another embodiment, the device uses the idle control application module for an automatic transmission vehicle. This embodiment of a system process is illustrated in FIG. 34. In this embodiment, the device can use either the “Device Control Routine” or the “Actuator Board Control Routine” to stop and restart the engine. The idle control application module can be used to stop an engine from idling excessively or alternatively, it can be used to restart the engine when vehicle systems require power beyond that provided by the battery alone. If a vehicle is in park with the engine on (354) the device, via the communicator, shuts off the engine after a programmable time delay (359). The user may adjust the time delay. Prior to the device shutting off the engine, an alert is optionally issued to the driver (356). If the driver signals the device (357) prior to engine shut-off, the device aborts the shut-off command and the vehicle continues to idle in park (354). The device, using information provided by the communicator, checks the vehicle parameters as defined by the “Engine Shutdown Checklist” (358) prior to the shutting off the engine (359). If the parameters are not within limits, an optional error alert is issued and the engine remains on (354). The device, using information provided by the communicator, returns to monitoring the engine idling but does not turn off the engine until the operating parameters are correct for doing so. If the engine is shut-off, the device may optionally be programmed to monitor vehicle parameters (361) as defined by the “Idle Restart” Checklist and use this data to periodically restart the engine (364). The first check (362) of the “Idle Restart” Checklist monitors environmental factors such as cabin temperature, battery power, battery use, external vehicle temperatures, engine temperature, etc. If the device, using information provided by the communicator, detects that operating parameters are within limits (362), the engine remains off and the device, using information provided by the communicator, continues monitoring the vehicle (361). If the device, using information provided by the communicator, detects that operating parameters are outside of limits (362), the device, using information provided by the communicator, evaluates the vehicle for a possible engine restart using other criteria in the “Idle Restart” Checklist (363). The second part of “Idle Restart” Checklist (see description in FIG. 11) evaluates if an engine restart is safe and when an engine shutdown is permitted. These variables include those listed in the “Engine Shutdown Checklist” in addition to evaluation of transmission status (automatic or manual transmission vehicle), parking brake status, fuel status, and engine temperature. Additional variables that can factor into a command being issued for an engine restart include time of day, GPS location and data and or rules based on local idling regulations. If the vehicle does not meet requirements of the “Idle Restart” Checklist (363), the engine remains off (367) and an alert is optionally issued (367). If the vehicle meets the “Idle Restart” Checklist requirements (363), the engine is restarted (364). The engine remains on until the vehicle operating parameters return within limits (365) and the engine is shut-off (365). The device, using information provided by the communicator continues to monitor the vehicle operating parameters (362).

In another embodiment, the device provides an anti-idle system for a manual transmission vehicle using an “application module.” This embodiment of a system process is illustrated in FIG. 35. In this embodiment, the device can use either the “Device Control Routine” or the “Actuator Board Control Routine” to stop and restart the engine. This system works in a similar manner to the system illustrated in FIG. 34; however, the transmission must be in neutral and the emergency brake must be on. If a vehicle is in neutral, with the parking brake on and with the engine on (370), the device, via the communicator, shuts off the engine after a time delay (374). The user may adjust the time delay. Prior to the device, via the communicator, shutting off the engine, an alert is issued to the driver (371). If the driver signals the device prior to engine shut-off (372), the device aborts the shut-off command and the vehicle continues to idle in neutral with the parking brake on (370). The device, using information provided by the communicator, checks the vehicle parameters as defined by the “Engine Shutdown Checklist” prior to the shutting off the engine (373). If the parameters are not within limits, an optional error alert is issued and the engine remains on (370). The device, using information provided by the communicator, returns to monitoring the engine idling but does not turn off the engine until it the parameters are correct for doing so.

In another embodiment, the device uses the vehicle location and operating parameters to act as a governor to limit the speed of the vehicle using an “application module.” This embodiment of a system process is illustrated in FIG. 36. In this embodiment, the system is enabled with, or has access to, location data such as provided by a GPS system (600), with access to mapping data (600) and speed limit data (600) for a given road position. In addition, this embodiment of the system is able to receive traffic data (600). GPS components can be included in the system or the capability can be accessed by connecting to a second (GPS enabled) system such as a cell phone, GPS handset, laptop computer or the GPS system of the vehicle. The mapping and speed data can be included in the system or it can be accessed by connecting to a second device with mapping capability such as a smart phone, portable GPS car navigation system, the mapping system of the vehicle or other storage medium such as a DVD player. The system and the secondary systems can be network enabled to receive and send data across the network. In this embodiment, the device uses the network capabilities of the communicator to look up the speed limit for the given vehicle position (601). The device uses driver preference settings for the Speed Rules Checklist (see description for FIG. 11) that has settings for the type of road, the time of day and the vehicle operating parameters (602). For instance, when traveling on a rural road the device may allow a vehicle to travel at 100% of the legal speed limit; however, the speed may be restricted to 90% of the legal limit on a freeway. Further, limits can be imposed using the time of day. In this case, a vehicle may be permitted to travel at 100% of a speed limit during daylight hours but restrict the speed to 90% of the limit during nighttime. In addition, the device can place restrictions on speed using vehicle operating parameters that may be indicative of road and driving conditions (603). Examples include using the windshield wipers (indicative of raining or limited visibility) or by accessing vehicle sensors that detect moisture. Another example is when the device, using information provided by the communicator, detects the use of the Electronic Stability Control by the vehicle, which can be indicative of hazardous road or driving conditions. Other vehicle operations or conditions related to sensor data that can be set to restrict vehicle speed include use of high beams, emergency lights, headlights, accelerometers, steering wheel sensors, wheel speed sensors, air bag sensors etc. The parameter data can be used in combination with one another to set the appropriate speed limit. For instance, a vehicle traveling on the highway may have no restrictions during the day, limited to 90% of the speed limit when traveling at night on the highway and further limited to 85% when driving on the highway at night when it is raining. Once the device, via the communicator, has set the restricted speed limit (603), it can display this figure on a connected smart phone or monitor (608). When the driver tries to exceed the speed set by the device (605), the device, via the communicator limits vehicle speed by commanding the vehicle controller to limit the vehicle speed and or engine power (606).

The communicator can also receive data sent by a network on upcoming traffic conditions that provide the driver with an early warning as to hazardous conditions (604). The user preferences can be set to determine at distance variable “AA” within which the device should monitor traffic data by the network (609). For instance, a driver can set the preferences to monitor traffic data within 0.25 miles, 0.5 miles, 1 mile, etc. The types of network data the communicator can receive includes data on average traffic speed, driving conditions (such as rain), vehicles using ABS or stability control, or information provided by other vehicle systems. The data can also include warnings and commands issued by the network that are transmitted to the communicator and the driver. When the communicator receives data that the vehicle is approaching hazardous driving conditions within the “AA” distance interval (610), the device, via the communicator, issues a warning to the driver (611). The warning includes the distance “BB” of the hazard (611) and the time “CC” to the hazard at the present driving speed (611). Optionally, upon having received a hazard warning, the device, via the communicator can disengage the vehicle cruise control or cruise control set by the device via the communicator (612).

In another embodiment, the device is required to select between application modules when the accelerator is demanded or has been released. This embodiment of a system process is illustrated in FIG. 37. When the accelerator is requested (450) with Transmission Control Mode A turned on (451), the device selects the appropriate gear, via the communicator, (452, 453) as illustrated in FIG. 38. Transmission Control Mode A, illustrated in FIG. 38 enables the vehicle to use a higher gear than what may typically be selected by the vehicle's computer. Driving in a higher gear can enable the use of greater accelerator demand at lower RPMs which is generally a more efficient engine operating point as defined by the properties of “brake specific fuel consumption.” When Transmission Control Mode A is selected, the device monitors, using information provided by the communicator, the accelerator demand (450). When the accelerator is demanded (451), the device looks up the driver's preference setting for Transmission Control Mode A (452) and uses the Transmission Control Mode A to select the gear (453). The device monitors, using information provided by the communicator, the use of the accelerator and makes additional gear selections when necessary. When the accelerator is released (454), the device refers to the user preference settings whether to return control to the vehicle controller or to allow Transmission Control Mode B, Transmission Control Mode C or AOFR to engage (455). When the accelerator is demanded again, Transmission Control Mode A re-engages (450). Based on the user preference settings, the device will alternate between the appropriate use of Transmission Control Mode A when the accelerator is demanded vs. Transmission Mode B, C or AOFR when the accelerator is released. The selection by the device between the Transmission Modes (or AOFR) applies whether the accelerator demand and release is controlled by the driver, the device or by vehicle systems such as cruise control.

In another embodiment of the device, the vehicle operates under Transmission Control Mode A as illustrated in FIG. 38. Transmission Control Mode A enables an automatic transmission vehicle to use a higher gear in automatic transmission than what may typically be selected by the vehicle's computer. Driving in a higher gear can enable the use of greater accelerator demand at lower RPMs that is generally a more efficient operating point for the engine as defined by the properties of “brake specific fuel consumption.” Settings for Transmission Control Mode A are “tunable” in that a driver can decide the degree to which increased fuel efficiency takes priority over vehicle performance. A maximum fuel efficiency setting keeps the transmission in the highest gear whenever possible. With this setting, the vehicle may provide less acceleration or power than what is typically experienced when the vehicle controller sets a gear for a given accelerator setting, engine load, etc. A “medium” setting for Transmission Mode A would be less restrictive in using a higher gear and provide a comparatively higher level of acceleration or power compared to the “high” setting.

When the accelerator is demanded (460) (by the driver, the device or the vehicle systems) and the Transmission Control Mode A is “on” (460), the device refers to the driver preference settings (461) (e.g. high, medium or low fuel efficiency). The device then measures, using information provided by the communicator, the vehicle operating parameters and compares these to a vehicle model specific look up table (461). The look-up table is comprised of several parameters including vehicle speed, engine RPM and parameters related to engine load (such as air flow, exhaust temp, fuel usage etc.) (See description in FIG. 11). Each gear is assigned acceptable ranges by parameters that can be used individually or in combination to select an acceptable gear. Parameter values overlap from gear to gear, and the user preference settings allow the device to select between a higher vs. a lower gear for a given vehicle's set of operating parameters at the time. The device continuously monitors, using information provided by the communicator, the vehicle's operating parameters and adjusts the gear settings as needed (463). If the device determines, using information provided by the communicator, that the vehicle cannot maintain the gear settings within acceptable operating limits (for instance engine RPM falls below a certain threshold), it allows the vehicle controller to set the appropriate gear (466).

In another embodiment, Transmission Control Mode A refers to a user's preference option to lock-up the torque converter when driving (470) using an “Operational Routine.” This embodiment of a system process is illustrated in FIG. 39. The torque converter connects an automatic transmission to the engine. The torque converter has the ability to multiply torque by allowing the engine to increase RPM into a higher power output at the cost of increased fuel consumption. The device can issue a command to the vehicle controller, via the communicator, causing the torque converter to lock temporarily thereby binding the engine to the transmission to avoid slippage and increase fuel efficiency. The torque converter can be commanded to lock-up over a much wider range of engine output to the transmission than is typically used by a vehicle controller; however, the vehicle may exhibit slower acceleration due to the loss of torque multiplication. When the device detects a change, using information provided by the communicator, in accelerator position (471), it checks if the user preference settings for torque converter lockup is “on” (472). If not (472), the vehicle controller (473) controls the torque converter. If it is “on” (472), the device (474) uses a look-up table with values of engine input/transmission output ratios to selectively “lock-up” the torque converter (474).

In another embodiment, the device, via the communicator, commands an automatic transmission to shift into neutral when the accelerator is released using the Transmission Control Mode B application module. This embodiment of a system process is illustrated in FIG. 40. Transmission Control Mode B can be used when the accelerator is released by the driver, the device or the vehicle systems. Typically, an automatic transmission vehicle will stay in gear when the driver takes his foot off the accelerator. Maintaining a connection between the wheels, the transmission and the engine creates drag referred to as “engine braking” which has a net effect of slowing the vehicle down when the accelerator is released and thereby increases fuel consumption. In Transmission Control Mode B (480), the accelerator is released (481), the device requests vehicle data via the communicator and runs through the “Transmission Control Mode B Checklist” (see description in FIG. 11) to determine if the vehicle operating parameters are within limits (482). If the operating parameters are not within limits (482), the transmission is not shifted to neutral (480). If the operating parameters are within limits (482), the device, via the communicator, shifts the transmission to neutral while leaving the transmission shift lever in position (483). This mode of transmission control can also optionally decrease fuel flow when reduction of engine power (484) is possible. User preference settings can be selected for Transmission Control Mode B to go into Standby Mode if the vehicle is equipped with and is using a Deceleration Fuel Cut Off (DFCO) feature. Installed by some manufacturers, DFCO is a fuel saving technique that cuts off the delivery of fuel to the engine when the vehicle is decelerating. Transmission Control Mode B can be combined with Transmission Control Mode A. When Transmission Control Mode B is used in combination with Transmission Control Mode A, Transmission Control Mode A is used when the accelerator is in demand (485). When the accelerator is released the device commands, via the communicator, the Transmission Control Mode B. When the two modes are used together, the driver, the device or the vehicle systems, increase the accelerator demand, a higher gear may be selected enabling a greater accelerator demand. When the driver, the device or the vehicle controller, releases the accelerator, the vehicle coasts in neutral under Transmission Control Mode B.

In another embodiment, the device, via the communicator, commands an automatic transmission to shift into neutral when the accelerator is released (by the driver, the device or the vehicle controller) using the Transmission Control Mode C. This embodiment of a system process is illustrated in FIG. 41. Transmission Control Mode C is similar to Transmission Control Mode B except that it selectively uses engine braking to prevent the vehicle from traveling above the speed (or a certain velocity over according to driver preferences) at the time the accelerator was released (491). This mode is useful when the vehicle is being driven in an area with significant downgrades where a coasting vehicle could gain too much speed. In Transmission Control Mode C, the driver, the device or the vehicle controller releases the accelerator while the vehicle is travelling at speed J (491). The device gathers information, via the communicator, from the vehicle computer port to determine if the vehicle operating parameters are within limits using the Transmission Control Mode C Checklist (492). If the operating parameters are not within limits, the transmission is not shifted to neutral (490). If the operating parameters are within limits, the device, via the communicator, shifts the transmission to neutral while leaving the transmission shift lever in position (493). Optionally, the device, via the communicator, may lower fuel delivery when reduced engine power is possible (494). As in Transmission Control Mode B, the user may select to place Transmission Control Mode C into temporary Standby Mode during moments that the vehicle is using a DFCO feature. When coasting, the device gathers information, via the communicator, from the vehicle computer port to determine if the vehicle speed is greater than J (495), that is, the vehicle has accelerated while coasting. If the vehicle speed is not greater than J (495), the vehicle coasts until the accelerator demand is requested. If the vehicle speed is greater than J (495), the device selects an appropriate gear (496) based on the transmission control application mode A look-up table and engages the transmission (preferably while leaving the transmission shift lever in position) (496). This step creates engine braking that slows the vehicle (497). In vehicles equipped with a compression release engine brake, this vehicle system can become active to aid engine braking. The device does not interfere with normal compression release engine brake in any mode. The device again gathers information from the vehicle computer port, via the communicator, to determine if the vehicle speed is greater than J (498). If the vehicle speed is not greater than J (498), the device commands, via the communicator, a shift to neutral (499) and may lower fuel delivery if engine power can be reduced (500). The cycle of coasting with engine braking on/off is repeated until the accelerator demand is requested (501).

In another embodiment, the Accelerator Off Fuel Reduction (AOFR) application module decreases the rate of fuel delivery while using engine braking to power the vehicle systems. This embodiment of a system process is illustrated in FIG. 42. When the accelerator is released with AOFR on (570), the device takes vehicle measurements, using information provided by the communicator, that are compared against threshold values to determine the level to which the engine fuel delivery can be reduced (571). The device first refers to a look up table with vehicle specific, baseline minimum values for engine RPM and vehicle speed. TS4 is the minimum speed above which AOFR can be used (571) given the type of vehicle, and its operating parameters. The device then assesses, using information provided by the communicator, the additional power requirements of the vehicle at that time (e.g. air conditioning, head lights, etc.) and makes the necessary adjustments to the threshold values for TS4 (572) and the minimum engine RPM requirement (576) to power vehicle systems. If the threshold values are not met, the device, via the communicator, does not moderate fuel delivery (570). If the threshold levels are within limits (572, 576), the device, via the communicator, reduces fuel delivery (574) by controlling the fuel injectors or uses other methods available for a given vehicle. Prior to reducing fuel delivery, the device, via the communicator, may optionally shift to the highest available gear (573) using Transmission Control Mode A. When the accelerator is demanded again (575), normal fuel delivery resumes either under control of the vehicle controller or the device, via the communicator, if Transmission Control Mode A has been selected.

In another embodiment, the device provides methods for overriding these transmission control application modules using an “operational routine.” This embodiment of a system process is show in FIG. 43. In an emergency situation holding the transmission to a higher gear than otherwise required, may not be appropriate. A device with Transmission Control Mode A “on” (510) monitors the accelerator pedal position to determine if the driver actuates the accelerator beyond a programmable percentage (e.g. Z) of accelerator demand (511). Z is a variable of accelerator deflection that may be set by the driver or device. It is generally between 20%-100% of maximum full pedal accelerator deflection. A greater than Z accelerator position signals the device, via the communicator, to temporarily turn off Transmission Control Mode A (512) and allows the vehicle controller (514) to select the appropriate gear thereby enabling greater acceleration of the vehicle. The device, via the communicator, optionally alerts the driver Transmission Control Mode A is in standby (515). Once the accelerator position returns to less than the programmable accelerator demand position (e.g. Z), (513) Transmission Control Mode A resumes (510).

In another embodiment of the device, the transmission control application modules include a manual override feature using an “operational routine.” This embodiment of a system process is illustrated in FIG. 44. If the vehicle is being driven with any Transmission Control Mode (A, B, C) or AOFR engaged (520), and the driver manually places the shift lever in gear other than “drive,” (521) the device places the Transmission Control Mode(s) and or AOFR into Standby Mode (522) and returns gear selection control to the vehicle controller (523). The Transmission Control Mode(s) (A, B, C) and AOFR may resume once the shift lever is placed in a drive position depending on driver preference (524).

In another embodiment, the Transmission Control Mode A Subroutine is used to assign transmission control to the vehicle controller or to Transmission Control Mode A. This embodiment of a system process is illustrated in FIG. 45. The Transmission Control Mode A Subroutine enables a method for allowing the driver to manually use the accelerator pedal position to select the higher gear when two gears meet the selection requirement. When the device has the subroutine turned on (530) and the driver depresses the accelerator foot pedal (531), the device uses driver preferences and a look up table for available gears given the vehicle's operating parameters (552). The device then runs the Transmission Control Mode A Checklist to determine if operating parameters are within limits (553). If no (553), the device allows the vehicle controller to select the appropriate gear (536). If yes (553), the device measures, using information provided by the communicator, if the accelerator pedal is between a programmable specified range (between E and F) (534). E and F are variables of accelerator demand which may be set by the driver or device. For instance, a setting for maximum fuel economy might allow the device to control gear selection from 0%-90% open accelerator while a more moderate setting might allow the device to control gear selection from 40%-80% open accelerator. If yes (534), the device then the selects the highest allowable gear allowed by the vehicle, taking into account the user preference settings (535). Outside of this range, the device allows the vehicle controller to select the appropriate gear (537). For instance, a setting for maximum fuel economy might allow the device to control gear selection from 0%-90% open accelerator while a more moderate setting might allow the device to control gear selection from 40%-80% open accelerator. The device can optionally alert the driver, via the communicator, when the accelerator position pedal is in or out of the range allowing for control by the device (535) or the vehicle controller (537).

In another embodiment, an operation routine is used to have Transmission Control Mode A used in combination with Transmission Control Mode C. This feature is illustrated in FIG. 46. When Transmission Control Modes A and C are engaged (840) and the driver, the device or the vehicle systems demand the accelerator (841), the device uses Transmission Control Mode A (842) to select the highest possible gear preferably leaving the transmission shift lever in the drive position. Optionally, the device may lock-up the torque converter, via the communicator, when using the accelerator (842). When the driver, the device or the vehicle system, releases the accelerator at Speed Q (844), (Speed Q is a variable with values between 10 mph and 90 mph) the device changes to Transmission Control Mode C allowing the vehicle to coast in neutral (844). If the vehicle increases speed to greater than Q, the device uses Transmission Control Mode C to re-engage the transmission, via the communicator, and create engine braking (845). When the driver depresses the accelerator (846), Transmission Control Mode A is re-engaged (842).

In another embodiment, the device uses the Accelerator Control Routine, in combination with the Transmission Control Mode A, as a cruise control method. This routine is illustrated in FIG. 47. In this embodiment of a system process, the driver turns on the Cruise Control Feature (540) and sets the vehicle cruising speed (541). The speed can be set by signaling the device such as by pressing the switch or inputting a command from a smart phone, smart pad, monitor, or laptop computer. Transmission Control Mode A selects the appropriate gear (542). The device then controls the accelerator, via the communicator, as needed to maintain the set target speed (543). Transmission Control Modes B or C or AOFR may be used when the accelerator has been released by the device, via the communicator, as may occur when the vehicle is going down hill. Alternatively, the driver can set the speed using the vehicle cruise control, and Transmission Control Mode A sets the gear when the accelerator is used (543) and Transmission Control Mode B, C or AOFR when the accelerator is released (539). The device continuously monitors, via the communicator, the vehicle operating parameters and when necessary, such as when there is a change in engine load, Transmission Control Mode A selects the appropriate gear and the Accelerator Control Routine compensates as required to maintain the vehicle set speed (544).

In one embodiment, the device prevents open-loop fuel delivery with an “operational routine.” This embodiment of a system process is illustrated in FIG. 48. The vehicle is driving with engine on and open-loop fuel consumption prevention activated (811). The device gathers data, via the communicator, to determine vehicle operating parameters such as engine speed, vehicle speed, acceleration, and accelerator position among others (812). The device prevents open-loop fuel consumption via the communicator when appropriate for instance when the driver requests the most fuel savings (813). The device can optionally control acceleration via the communicator to prevent open-loop fuel consumption that occurs close to wide-open acceleration (816). Optionally, the open-loop prevention may be used with Transmission Control Mode A (815). The device may keep engine RPM lower by engaging a higher gear or otherwise limiting RPM by enforcing a higher gear (815) via the communicator. The device can also optionally prevent the acceleration or deceleration rate to be so aggressive that it causes open-loop fuel consumption (817) via the communicator. The device, via the communicator, alerts the driver to the impending or actual open-loop condition by detecting open-loop fuel consumption via the computer port or by detecting conditions via the computer port or auxiliary electronics such as rapid engine acceleration that might lead to open-loop fuel consumption to warn the driver so that the driver can change the operating behavior of the vehicle to stop or prevent open-loop fuel consumption (818). These methods can be used alone or in conjunction with each other to make sure the engine's operating point does not enter into a region that the vehicle controller would allow open-loop fuel consumption. The device continues to prevent open-loop fuel delivery via the communicator until driver or device releases open-loop fuel consumption prevention and normal driving resumes (814).

In another embodiment, the device includes a cruise control application that includes Transmission Control Modes A and B. This method allows the vehicle to coast above a speed set by the driver and illustrated in FIG. 49. The driver activates transmission and accelerator cruise control using Transmission Control Mode B (TACC-b) (551, 552). The vehicle cruise speed can be set (553) by the driver signaling the device such as by using the switch, smart phone, smart pad, or other similar method. The periods of accelerator demand are controlled by Transmission Control Mode A (556), illustrated in FIG. 38, and the Accelerator Control Routine (557) illustrated in FIG. 47. Transmission Control Mode B (555), illustrated in FIG. 40 is used when the accelerator is released such as when the vehicle is going down hill. When the driver sets a vehicle speed of K mph, the device sets the cruise control speed point (554). The device, via the communicator, optionally provides an alert (553) that the cruise control has been set and allows for a programmable variance over and below the set speed when the accelerator is in use (554). The device, via the communicator, maintains vehicle speed at K mph using Accelerator Control Routine (557), illustrated in FIG. 47. When coasting, the vehicle may be allowed to increase speed above the speed set by the driver in this mode. Optionally, the device, via the communicator, prevents the vehicle computer from selecting open-loop fuel delivery during acceleration (558). The driver may turn off TACC-b by pressing the accelerator, or signaling the device (559). The device also turns the application module off, if the foot brake is used to decrease the vehicle speed below that set by the driver (559). When the device is turned off, it optionally provides an alert, via the communicator, that TACC-b is in Standby Mode (560). The driver may re-establish TACC-b by signaling the device at the desired speed (561). Alternatively, the driver can set the speed using the vehicle cruise control system and the device uses Transmission Control Mode A to set the gear, via the communicator, when the acceleration is used and Transmission Control Mode B when the accelerator is released.

In another embodiment, the device includes a cruise control application that includes Transmission Control Modes A and C. This embodiment of a system process is illustrated in FIG. 50. When the driver activates transmission and accelerator cruise control application using Transmission Control Mode C (TACC-c) (700, 703), the driver sets the vehicle cruise speed (708). The vehicle cruise speed can be set (708) by the driver signaling the device such as by using the switch, smart phone, smart pad, or other similar method. The periods of accelerator demand are controlled by Transmission Control Mode A (701) and the accelerator control (704). Transmission Control Mode C is used when the accelerator is released (702) such as when the vehicle is going down hill. When the driver signals the device at a vehicle speed of M mph to set the cruise control speed point (708), the device provides an optional alert via the communicator that the cruise control has been set (705). When coasting, it can use periodic engine braking to keep the speed within the limit set by the driver. Optionally, the device, via the communicator, prevents the vehicle computer from selecting open-loop driving during acceleration (705). Optionally, the device, via the communicator, may lock up the torque converter to assist the vehicle's engine braking in maintaining the set speed (705). The driver may turn off TACC-c by pressing the accelerator or using another method to signal the device (707). The device also turns the application module off if the foot brake is used to bring the vehicle speed below that set by the driver (707). When the device is turned off, it provides an optional alert that TACC-b is in Standby Mode (709). The driver may re-establish TACC-c to reset the cruise speed set point (710). Alternatively, the driver can set the speed using the vehicle cruise control system and the device uses Transmission Control Mode A to set the gear via the communicator when acceleration is used and Transmission Control Mode C when the accelerator is released.

In another embodiment, the device uses an application module with the Transmission and Accelerator Cruise Control and the Pulse-and-Glide Mode (TACC-pg). This embodiment of a system process is illustrated in FIG. 51. The driver selects Transmission Control Modes (712, 715). When cruise control is not in use, the selected Transmission Control Modes are used (718). The driver actuates sets the pulse-and-glide speed set point around which the vehicle accelerates and coasts (720). The vehicle pulse-and-glide speed intervals can be set by the driver signaling the device such as by using the switch, smart phone, smart pad, or other similar method. The device optionally provides an alert, via the communicator, that the cruise control has been set (720). The device maintains vehicle speed via the communicator between the pulse-and-glide upper and lower limits (723). If the accelerator is used, the device uses cruise control with Transmission Control Mode A illustrated in FIG. 33 (713) and the Accelerator Control Routine (716) to maintain the vehicle speed set point. When the accelerator is not in use, the device uses Transmission Control Mode B or C when the vehicle coasts (714). Optionally, the device, via the communicator, prevents the vehicle computer from engaging the open-loop fuel delivery (717) and may command torque converter lock up to assist in engine braking (717). The driver may turn off TACC-pg by pressing the accelerator, foot brake, or using another method to signal the device (719). The device optionally provides an alert via the communicator that TACC-pg is in Standby Mode (721). The driver may re-establish TACC-pg at the desired speed (722).

In another embodiment, the device uses an application module with a Transmission and Accelerator Cruise Control used in the Pulse-and-lide Mode with Engine Off Coasting (TACC-pgo). This embodiment of a system process is illustrated in FIG. 52. In this embodiment, the device can use either the “Device Control Routine” or the “Actuator Board Control Routine” to stop and restart the engine. The driver activates TACC-pgo (723) and the device loads driver Transmission Control Mode preference settings (723). The vehicle drives with engine on using Transmission Control Mode A (724) and “Engine Off Coast Mode” used for deceleration (725). When cruise control is not in use, Transmission Control Modes are used (728). The device uses the Accelerator Control Routine to maintain target vehicle speed (729). The driver sets the pulse-and-glide upper and lower limits (731). The vehicle pulse-and-glide speed intervals can be set by the driver signaling the device such as by using the switch, smart phone, smart pad, or other similar method. The device provides an alert via the communicator that the cruise control has been set (731). The device, via the communicator, maintains vehicle speed between the pulse-and-glide upper and lower limits (733). If the accelerator is used, the device uses cruise control with Transmission Control Mode A, illustrated in FIG. 38 (724). When the vehicle coasts, the device uses Engine Off Coast Modes to shut-off the engine and monitor the vehicle as illustrated in FIGS. 18 and 19 (725) via the communicator. The device uses the Master Restart Routine (FIG. 8) to restart the engine (726). The device uses the criteria in the “Engine Shutdown Checklist” before turning the engine off and restarts the engine if the driver uses the inputs illustrated in AERDI checklist (FIG. 11) or if the vehicle conditions illustrated in AERA Checklist (FIG. 11) occur. Optionally, the device, via the communicator, prevents the vehicle computer from activating open-loop fuel delivery (as illustrated in FIG. 48 and elsewhere) (730) during accelerator demand and may command torque converter lock up to assist with engine braking (730). The driver may turn off TACC-pgo by pressing accelerator, foot brake, or using another method to signal the device (732) at which time the device, via the communicator, provides an alert that TACC-pgo is in Standby Mode (734). The driver may reestablish TACC-pgo at the desired speed (735).

In another embodiment, the device includes a cruise control method that includes Transmission Mode A and Accelerator Off Fuel Reduction (AOFR) using an “application module.” This method AOFR is illustrated in FIG. 53. When the driver activates AOFR, the device loads the driver preference settings (625). Prior to the driver setting the cruise control on, the periods of accelerator demand are controlled by Transmission Control Mode A and the Accelerator Control Routine (626). AOFR is used when the accelerator is released such as when the vehicle is going down hill (626). When the driver sets the vehicle speed of P mph to set the cruise control speed point (627, 628), the device provides an alert via the communicator that the cruise control has been set (628). (P is a variable with a value typically between 10 mph and 90 mph.) The vehicle pulse-and-glide speed intervals can be set by the driver signaling the device such as by using the switch, smart phone, smart pad, or other similar method. To maintain the vehicle set speed, the device requires periods of accelerator demand (629). During these periods, Transmission Control Mode A is used to select an appropriate gear and accelerator control (630) to maintain the set speed limit (628). During the periods that the accelerator is not used, the device uses AOFR to cut fuel delivery to the engine and keeps the engine rotating through the use of engine braking (631). Optionally, the device, via the communicator, prevents the vehicle computer from selecting open-loop driving during acceleration. The driver may turn off AOFR by pressing the accelerator or using another method to signal the device (633). The device also turns the application module off if the foot brake is used to bring the vehicle speed below that set by the driver (633). When the device is turned off, it optionally provides an alert that AOFR is in Standby Mode (634). The driver may re-establish AOFR at the desired speed (635).

In the Pulse-and-Glide Mode the device provides alternative methods for setting the speed ranges and alternative methods for controlling acceleration and deceleration in a vehicle with an automatic transmission using an “application module.” This mode is illustrated in FIG. 54. When the driver signals the device (737), the device uses the vehicle speed as the set point (740). In the Automatic Mode, the high and low end of speed ranges can be determined by parameters programmed into the device (741). For instance, if the driver signals the device at 60 mph and the device is programmed with a 5% variance, the device commands a pulse-and-glide interval, via the communicator, accelerating up to 63 mph and then coasting to 57 mph. At 57 mph, the device again commands, via the communicator, the vehicle to accelerate to 6 mph and the intervals repeat accordingly. Alternatively, the driver can select preference settings that enable the speed ranges to be set manually by signaling the device using the switch or the accelerator (739). For instance, at a speed set point of 50 mph, the driver may accelerate up to 55 mph and release the accelerator. The high end of the speed range is set at 55 mph. The vehicle is then allowed to coast with the engine to 45 mph and the driver resumes use of the accelerator. The low end of the speed range is set to 45 mph and the device begins the pulse-and-glide cruise control sequence. In accelerating, the device may use an automated cruise control system controlled by the vehicle controller or the device via the communicator (744), Transmission and Acceleration Cruise Control-a″ (TACC-a) application (745), or Pulse-and-Glide Engine On (FIG. 52) or Engine Off (FIG. 53) (746). In this embodiment, the device can use either the “Device Control Routine” or the “Actuator Board Control Routine” to stop and restart the engine. Alternatively, the driver may control acceleration by manually using the accelerator (772) with the device alerting the driver via the communicator the upper speed limit has been reached. The deceleration phase may be controlled by the device via the communicator using a cruise control system controlled by the vehicle controller or the device (748), Transmission Control Mode B or C or AOFR (749), Pulse-and-Glide Engine On or Engine Off (750), or by manually releasing the accelerator (751). The driver can disable the pulse and glide feature by signaling the device such as by using the brake or accelerator or by accelerating beyond the set point if the manual acceleration/deceleration method is used (738).

Pulse-and-Glide driving with methods for setting the speed points and alternative methods for controlling acceleration and deceleration in a vehicle with a manual transmission are illustrated in FIG. 55 using an “application module.” In this mode, the driver signals the device to enter the Pulse-and-Glide Mode. The manual transmission version of Pulse-and-Glide Mode has similar properties to the system for automatic transmissions illustrated in FIG. 54. Both embodiments use the same methods to set speed points and speed interval ranges (754, 756, 757). Both embodiments can use manual accelerator control (763, 768, 769) or a cruise control system operated either by the vehicle controller or the device via the communicator (764,771) to control acceleration and deceleration intervals. The system for a manual transmission vehicle does not use Transmission Control Mode A, but may optionally prevent open-loop fuel delivery during acceleration (765). The device may also alert the driver via the communicator to the optimum gear for fuel efficiency based on engine speed, RPM and parameters related to engine load (760). The device, via the communicator, can control an auxiliary device to engage or disengage the clutch (768) so that the vehicle can coast with the engine on without engine braking or with engine off (767). In this embodiment, the device can use either the “Device Control Routine” or the “Actuator Board Control Routine” to stop and restart the engine. The device uses the Coast Application for manual transmission illustrated in FIGS. 28, 29 and 30 as the routine to restart the engine (759) which can be accomplished by using the starter motor or by the driver using the clutch or the device, via the communicator, using an auxiliary device (768) (e.g. automatic clutch actuator) to control the clutch to “bump start” the engine. If the driver is manually controlling the interval, the vehicle can be placed into neutral when coasting (769) and the driver can put the vehicle back into gear to bump start the vehicle. The driver may disengage manual pulse-and-glide by signaling the device such as by actuating the switch, foot brake, shifting gears or if not in manual mode, by using the accelerator (770).

In another embodiment, the device (792) uses a transmission fluid pressure accumulator to engage an automatic transmission to restart the vehicle. The embodiment is illustrated in FIG. 56. The restart method allows the power from rotating vehicle wheels to transfer power to actuate engine cranking and restart the engine. The accumulator (795) is refilled by using the pressure created by the vehicle's transmission pump (794). The accumulator check valve (787), and optionally the restart valve (787), allows fluid to flow into the transmission fluid chamber of the accumulator (791). This chamber has a movable piston (782) that slides into the adjacent air chamber (790) as the pressure builds in the transmission fluid chamber. The air chamber is connected to an optional air chamber reservoir (781). The device, via the communicator, monitors the accumulator pressure sensors (796) and once a threshold level of pressure is reached, the device, via the communicator, commands the check valve (787), and, if used, the restart valve (785) to close. The accumulator is charged and ready for engine restart. The state of charge, rate of charge and discharge can be measured by pressure and flow sensors (796, 786). Several types of accumulators may be used in the present invention. The main requirement is that the accumulator has sufficient capacity to accumulate transmission fluid at the pressure needed to engage a gear in the transmission under the control of the device via the communicator. In this embodiment, the device can use either the “Device Control Routine” or the “Actuator Board Control Routine” to stop the engine and to restart the engine in combination with the accumulator. The device, via the communicator, can communicate with the accumulator's controllers and sensors either using wireless methods or by a cable connection.

In another embodiment, the device, via the communicator, can use a motor actuated transmission fluid pressure accumulator to restart the engine of a vehicle with an automatic transmission. This embodiment of a system process is illustrated in FIG. 57. In this embodiment, the device can use either the “Device Control Routine” or the “Actuator Board Control Routine” to top the engine when using an accumulator to restart the engine. The accumulator (901) is attached by a hydraulic line (911) to the transmission (910) preferably to an existing port (909). Transmission fluid flows in and out of the accumulator's transmission fluid chamber (904). When the device, via the communicator, commands the accumulator to be filled, the electric motor (900) can retract the piston (903) and draw transmission fluid into the transmission fluid chamber (904). The fluid refill may be regulated by use of a check valve (912). This step pressurizes the air in the air chamber of the accumulator (902) so that the piston experiences an air spring force tending to push the piston (903) to expel the transmission fluid from the accumulator. The motor (900) or latch (914) can retard this force as long as the device, via the communicator, commands. Alternatively the air (902) behind the piston (903) can be contained in an open vessel so that it does not compress. When the device, via the communicator, commands a restart, and the air has been compressed in the air chamber (902), the force of the compressed air in the air chamber (902) can be combined with the force of the motor. Optionally if the air has not been compressed in the air chamber (902), the motor can act alone to force the fluid into the transmission at the appropriate flow rate and pressure to start the engine in the manner illustrated in FIGS. 58 and 59. The fluid optionally can flow through a restart check valve (907) if more control over fluid flow is desired. However, fluid flow can be controlled by the motor (900) alone. The motor (900) is capable of moving the piston so that it lowers the pressure in the accumulator and enables a faster refill by drawing transmission fluid from the transmission even when the transmission pressure is low for instance when a vehicle is idling. The device, via the communicator, can optionally open a restart valve (907) when the accumulator (901) is being recharged so that transmission fluid can flow into the accumulator through the restart valve (901) or both the restart valve (907) and the optional check valve (912). If a restart valve is installed, it can be controlled by the device (907) via the communicator. To ensure a smoother restart and minimize vehicle lurching, the device, using information provided by the communicator, uses sensor data (908) to regulate the flow rate and pressure of transmission fluid delivered to the transmission (910). The device, via the communicator, can regulate these parameters by commanding the motor (900) to move the piston to push fluid into the transmission (910) at a defined rate and pressure and by modulating the restart valve (907). Transmission pressure is measured by transmission pressure and/or flow sensors (913, 908) or by pre-existing transmission sensors of the vehicle over the vehicle computer. The device, via the communicator, can communicate with the accumulator's controllers and sensors either using wireless methods or by a cable connection.

A method of engaging a clutch in an automatic transmission using a transmission fluid pressure accumulator as illustrated in FIG. 58 using an “operational routine.” Using manual or automated commands, the device (852) initiates the Engine Restart Routine (FIGS. 8, 9, and 10). The device using information provided by the communicator, uses information from the accumulator pressure sensor (786) (FIG. 56) to determine if the accumulator is sufficiently charged for a full accumulator restart, less charged for a joint accumulator and starter restart, or insufficiently charged and therefore require a restart with the starter motor. The device, via the communicator, commands the restart valve to open (853) and uses data from the pressure and flow sensors (861) to control the valve (853) to regulate fluid delivery into the valve body (859) of the transmission (855). The control valve may be modulated by the device, via the communicator, in a pulse-width modulated or other fashion to control the amount and pressure of fluid delivered to the clutches inside the transmission. Modulating fluid delivery enables control in the amount of clutch slip and therefore the characteristics of the engine restart. For instance, reducing the amount and pressure of the fluid delivery could enable a smoother restart should the device, via the communicator, select a gear while allowing clutch slip. Concurrent to the delivery of fluid to the transmission, the device, via the communicator, commands the vehicle's transmission solenoid valves, or optionally the vehicle controller (858), to select the appropriate gear based on vehicle speed. This step opens the appropriate fluid path in the transmission valve body (859) and allows the pressurized fluid to engage the appropriate gear in the transmission. (855). Once the clutch or clutches (depending on vehicle model) are engaged, the following sequence of events takes place: the clutch or clutches engage the transmission (860) that in turn engages the gear (854) selected by the device via the communicator. The rotating wheels (851) are now connected to the transmission with the gear engaged (854) turning the drive shaft (856) that is connected to the torque converter (857). The spinning torque converter (857) causes the crankshaft (863) to rotate which in turn cranks the engine making it start. This embodiment is meant to be used when the ignition is on so that the fuel injectors and engine controller are available to participate in the engine restart process.

The turning of the crankshaft can power the torque converter to restart the engine. This embodiment of a system process is illustrated in FIG. 59. The rotating transmission shaft (870) turns the torque converter turbine (871). The rotation of the torque converter turbine (871) causes pressurized transmission fluid (872) to turn the torque converter pump/impeller (873). Once sufficient force is delivered to the torque converter pump/impeller (873), it begins to fluidically turn the torque converter unit that is connected to the engine crankshaft (874). Optionally, the device can issue a command through the communicator to command torque convertor lock up and create a faster connection between the turning wheels and the crankshaft. The rotation of the unit that is connected to the engine crankshaft turns (874) the crankshaft (875) and the engine is restarted.

### Operating Example 1: FIG. 4a

The following example is provided to describe, in stepwise fashion, the microprocessor (936) running the device and communicator software, the switch (945) and the Actuator Board (920) acting as a system, and how the system uses different software routines to shutdown and restart an engine of an automatic transmission vehicle. Using the Start Stop Application Module, the driver commands an engine stop by pressing the button (951) on the switch (945) while the transmission shift lever is in the drive position (application module). This action instructs the switch microprocessor (949) to send a command via the communications port (950) or wireless chip (950) to the microprocessor (936) via the communications port (935). The signal from the switch (945) is received by the communications interface (935) of the microprocessor (936), which sends the signal to the microprocessor (936). The microprocessor (936) uses the device software application, the Start Stop Application Module, which is preloaded on a storage medium such as a memory chip. As part of the device Start/Stop Application Module, the microprocessor (936) instructs the communicator program to request information from the vehicle's controllers over the vehicle's computer port connector (931) via the protocol interface (933). The microprocessor (936) uses the device Start Stop Application Module together with the gathered data to determine driver intent, whether the command is to be permitted and the methods by which the command is implemented. In this example, the vehicle has the engine on, at speeds less than TS1 with the foot brake engaged. The signal from the driver's act of pressing the button (951) is interpreted by the microprocessor (936) running the device software to command an engine shut-off.

During the engine shutdown sequence, the microprocessor (936) running the device and communicator software continuously requests or monitors information to assess any change in vehicle operating parameter status. Using the device software, the microprocessor (936) is also prepared to respond to further signals from the switch (945) or the Actuator Board (920) via the communications ports (950, 935, 926) looking for commands or updated data to abort the shutdown process. The microprocessor (936) next runs the device program for the Engine Shutdown Checklist evaluating those parameters identified by the Start Stop Application Module to determine if an engine shutdown is permitted. If the device software running on the microprocessor (936) determines that the driver command is valid and can proceed, the microprocessor (936) uses the communicator program acting in the capacity of the communicator to send the appropriate command, using wired or wireless communications, via the communications port (935) on to the communications port of the Actuator Board (920). The command is forwarded to the microprocessor (924) of the Actuator Board (920), which begins the engine shutdown routine for an automatic transmission vehicle.

The Actuator Board microprocessor (924) sends a signal to an amplifier (929) that controls relays (922, 923) located on the Actuator Board (920). To connect to the vehicle, the Actuator Board (920) uses conductors (FIG. 4b, 662) with adaptors (FIG. 4b, 663) that are connected to the vehicle's socket (FIG., 4b, 666) or equivalent connection point. In this example, the socket (FIG., 4b, 666) is the conduit passing power to the engine controller (engine control unit). In order to turn off the engine, the microprocessor (924) sends a command through the amplifier (929) to actuate the relay(s) (922, 923) to shut-off power to the engine controller, which causes the engine to shutdown.

Typically, the transmission of an automatic transmission vehicle will transition to neutral when the engine is shut-off while the vehicle is in gear. This event occurs when the transmission fluid pressure falls to zero after the engine shutdown, and the transmission clutches are no longer engaged. In some vehicles, this type of transition is accompanied by an audible and physical vehicle tremor. In order to avoid any tremor sensation, the microprocessor (936), running the device and communicator software, optionally commands the communicator to issue a signal over the computer port commanding the transmission to shift to neutral immediately prior to the engine shutdown. Depending on the vehicle type, the microprocessor (936) can effect a change in transmission by issuing a command to the appropriate vehicle controller (such as a Transmission Control Mode) or by sending commands directly to the transmission shift valves. The microprocessor (936), running the device and communicator software, monitors the engine shutdown (operating routine). After the microprocessor (936), running the device and communicator software, determines an engine auto restart is not possible, either by measuring an appropriate drop in engine rotation or that a predefined period of time has passed, it optionally sends a command to the Actuator Board (920) to restore power to the engine controller. The Actuator Board microprocessor (924) commands that the appropriate relay return power to the ECU Circuit (FIG. 4, 666) (operating routine). In this example, the vehicle now has its engine off, the foot brake engaged, the speed is less than TS1 and with the shift lever in Drive.

While the vehicle remains with the engine off, the microprocessor (936), running the device and communicator software, regularly requests data over the vehicle computer port to monitor any changes in the vehicle operating parameter. In this example, the microprocessor (936), running the device and communicator software, detects that the foot brake has been released and interprets this action as a command to order an engine restart. The microprocessor (936), running the device and communicator software, issues a command to begin the Engine Restart Routine by instructing and forwards a restart command to the Actuator Board (920). The microprocessor (924) on the Actuator Board (920) receives the restart command and begins to execute its part of the Engine Restart Routine (operating routine). The Actuator Board microprocessor (924) commands its relay (927) that is connected to vehicle's electrical socket or equivalent connection point (FIG. 4b, 669) to deliver an electrical signal to an electrical connection on the vehicle ECU (operating routine). The signal provided mimics a signal sent by the vehicle's neutral safety switch and allows the engine to restart while the transmission shift lever is in Drive (operating routine). Some vehicles have a fault checking mechanism to confirm that the required relay(s), or other circuit(s) is present and operational to start and run the vehicle. To confirm its (their) presence, the ECU sends an electrical signal to this (these) circuit(s) prior to starting the engine. If this check method is required, the Actuator Board (920) includes electrical components (926), such as a resistor, that create the appropriate dummy resistance or impedance load to mimic the presence of a relay coil or other circuit.

These signals can use different methods, depending on the vehicle circuitry, to override normal vehicle operations. A direct command or signal or impedance can be activated for instance through electronics (922, 923, 925, 928, 927) on the Actuator Board (920). The Actuator Board (920) can also monitor vehicle circuitry using electronics on the Actuator Board (928) and use feedback to activate a signal, command or impedance through electronics on the Actuator Board (925) or another circuit (928). These steps can be done under the control of the Actuator Board microprocessor (924) or by independent circuitry in (925, 928, 923) or can be activated by the Actuator Board microprocessor (924) to activate a vehicle circuit. These steps may be done with the aid of the amplifier (929). Electronics on the Actuator Board (922) can also control the vehicle circuitry under the direction of the Actuator Board microprocessor (924).

With the neutral safety switch bypassed, the Actuator Board microprocessor (924) continues with the command to restart the engine by turning on the relay connected to the electrical socket, or equivalent connection point, that delivers power to the starter motor. The starter motor begins to turn. The microprocessor (936) monitors RPM data over the vehicle computer port and the microprocessor (936), running the device and communicator software, uses this data to monitor the engine restart. Running the device and communication software, the microprocessor (936), can determine when the engine rotation is sufficient to restart the engine and sends a second command to the Actuator Board (920) commanding it to shut-off power to the starter motor. As a safety precaution, so as not to damage the starter motor, the microprocessor (936), running the device and communicator software, determines if the engine has not restarted after C seconds, where C is a programmable variable. C is a variable of time that may be set by the driver or device. It is generally between 0.1 second and 10 seconds. If the engine has not restarted, the microprocessor (936), running the device and communicator software, commands the Actuator Board (920) to cut power to the starter motor. This step prevents the starter motor from being damaged when the engine is unable to restart. Alternatively, the Actuator Board microprocessor (924) can use a timer that cuts power to the starter motor after C1 seconds. C1 is a variable of time, which may be set by the driver or device. It is generally between 0.1 seconds and 10 seconds. When the Actuator Board microprocessor (924) receives the command, it directs its relay (927) to shut-off power to the starter motor. The engine has been restarted with the transmission shift lever in the Drive position, and the microprocessor, running the device and communicator software, or the vehicle transmission system selects the appropriate gear.

Once the engine restarts, the vehicle controller or transmission control unit will normally command the transmission to engage the appropriate gear. The microprocessor (936), running the device and communicator software, optionally monitors the status of the transmission after engine restart by requesting information over the computer port. In the event the vehicle systems fail to control the transmission system, the microprocessor (936), running the device and communicator software, orders the transmission to change to the appropriate gear. The microprocessor (936), running the device and communicator software, can optionally send an RPM mimicry signal to the transmission control unit, or other appropriate vehicle controller, to command the transmission engage at a lower than normal RPM rate in order to enable a smoother engine restart. The vehicle now has the engine on with the transmission in the appropriate gear.

### Operating Example 2: FIG. 4c

The following example is provided to describe, in stepwise fashion, the device (934c), the communicator (936c), the switch (945c) and the Actuator Board (920c) acting as a system, and how the device uses different software routines to shutdown and restart an engine of an automatic transmission vehicle. Using the Start Stop Application Module, the driver commands an engine stop by pressing the button (951c) on the switch (945c) while the transmission shift lever is in the drive position. This action instructs the switch microprocessor (949c) to send a command via the communications port (950c) or wireless chip (950c) to the communicator (936c). The signal from the switch is received by the communications interface (935c) of the communicator (936c), which sends the signal to the device (934c). The device (934c) uses the Start Stop Application Module that is preloaded on a storage medium such as a memory chip. As part of the Start Stop Application Module, the device (934c) instructs the communicator (936c) to request information from the vehicle's controllers over the vehicle's computer port connector (931c) via the protocol interface (933c). The device (934c) uses the programs in the Start Stop Application Module together with the gathered data to determine driver intent, whether the command is to be permitted and the methods by which the command is implemented. In this example, the vehicle has the engine on, at speeds less than TS1 with the foot brake engaged. The signal from the driver's act of pressing the button (951c) is interpreted by the device (934c) as a command to shut-off the engine.

During the engine shutdown sequence, the device (934c) continuously requests or monitors information, via the communicator (936c), to assess any change in vehicle operating parameter status. The device (934c) is also prepared to respond to further signals from the switch (945c) or the Actuator Board (920c) looking for commands or updated data via the communications ports (950c, 935c, 926c) to abort the shutdown process. The device microprocessor (936c) next runs the Engine Shutdown Checklist evaluating those parameters identified by the Start Stop Application Module to determine if an engine shutdown is permitted. If the device (934c) determines that the driver command is valid and can proceed, the device (934c) sends the appropriate command to be transmitted by the microprocessor (936c) using wired or wireless communications via the communications port (935c) on to the communications port of the Actuator Board (926c). The command is forwarded to the Actuator Board microprocessor (924c) of the Actuator Board (920c), which begins the engine shutdown routine for an automatic transmission vehicle. The Actuator Board microprocessor (924c) sends a signal to an amplifier (929c) that controls relays (922c, 923c) located on the Actuator Board (920c). To connect to the vehicle, the Actuator Board (920c) uses conductors (FIG. 4b, 662) with adaptors (FIG. 4b, 663) that are connected to the vehicle's electrical socket or equivalent connection method (FIG., 4b, 666). In this example, the electrical socket (FIG. 4b, 666) is the conduit passing power to the engine controller (engine control unit). In order to turn off the engine, the Actuator Board microprocessor (924c) sends a command through the amplifier (929c) to actuate the relay(s) (922c, 923c) to shut-off power to the engine controller, which causes the engine to shutdown.

Typically, the transmission of an automatic transmission vehicle will transition to neutral when the engine is shut-off while the vehicle is in gear. This event occurs when the transmission fluid pressure falls to zero after the engine shutdown, and the transmission clutches are no longer engaged. In some vehicles, this type of transition is accompanied by an audible and physical vehicle tremor. In order to avoid any tremor sensation, the device (934c) optionally commands the communicator (930c) to issue a signal over the computer port commanding the transmission to shift to neutral immediately prior to the engine shutdown. Depending on the vehicle type, the device (934c) can effect a change in transmission by issuing a command to the appropriate vehicle controller (such as a Transmission Control Mode) or by sending commands directly to the transmission shift valves. The device (934c) via the communicator (930c) monitors the engine shutdown. After the device (934c) determines an engine auto restart is not possible, either by measuring an appropriate drop in engine rotation or that a predefined period of time has passed, it optionally sends a command to the Actuator Board (920c) to restore power to the engine controller. The Actuator Board microprocessor (924c) commands that the appropriate relay return power to the ECU Circuit (FIG. 4, 666). In this example, the vehicle now has its engine off, the foot brake engaged, the speed is less than TS1 with the shift lever in Drive.

While the vehicle remains with the engine off, the device regularly requests data over the vehicle computer port to monitor any changes in the vehicle operating parameters. In this example, the device (934c) detects that the foot brake has been released and interprets this action as a command to order an engine restart. The device (934c) issues a command to begin the Engine Restart Routine by instructing the communicator to forward a restart command to the Actuator Board. The Actuator Board microprocessor (924c) on the Actuator Board (920c) receives the restart command and begins to execute its part of the Engine Restart Routine. The microprocessor (924c) commands a relay (927c) on the Actuator Board (920c) that is connected to vehicle's electrical socket or equivalent connection method (FIG. 4b, 669) to deliver an electrical signal to an electrical connection on the vehicle ECU. The signal provided mimics a signal sent by the vehicle's neutral safety switch and allows the engine to restart while the transmission shift lever is in Drive. Some vehicles have a fault checking mechanism to confirm that the required relay(s), or other circuit(s) is present and operational to start and run the vehicle. To confirm its (their) presence, the ECU sends an electrical signal to this (these) circuit(s) prior to starting the engine. If this check method is required, the Actuator Board includes electrical components (926c), such as a resistor, that create the appropriate dummy resistance or impedance load to mimic the presence of a relay coil or other circuit.

These signals can use different methods, depending on the vehicle circuitry, to override normal vehicle operations. A direct command or signal or impedance can be activated for instance through electronics on the Actuator Board (927c). The Actuator Board (920c) can also monitor vehicle circuitry using electronics on the Actuator Board (928c) and via a feedback loop activate a signal, command or impedance through electronics on the Actuator Board (925c) or another Actuator Board (928c). This step can be done under the control of the Actuator Board microprocessor (924c) or by using independent Actuator Boards (925c, 928c) on the Actuator Board such as a relay (923c). In this manner, the Actuator Board microprocessor (924c) can close a vehicle circuit. This function may be done with the aid of the amplifier (929c).

With the neutral safety switch bypassed, the Actuator Board microprocessor (924c) continues with the command to restart the engine by turning on the relay connected to the vehicle's electrical socket or equivalent connection method that delivers power to the starter motor. The starter motor begins to turn. The communicator (936c) monitors RPM data over the vehicle computer port and the device (934c) uses this data to monitor the engine restart. When the device (934c) determines that the engine rotation is sufficient to restart the engine, the device (934c) sends a second command, via the microprocessor (936c), to the Actuator Board (920c) commanding it to shut-off power to the starter motor. As a safety precaution, so as not to damage the starter motor, the device (934c) determines if the engine has not restarted after C seconds. C is a variable of time, which may be set by the driver or device. It is generally between 0.1 second and 10 seconds. If the engine has not restarted within time C, the device (934c) commands the Actuator Board (920c) to cut power to the starter motor. This step prevents the starter motor from being damaged when the engine is unable to restart. Alternatively, the Actuator Board microprocessor (924c) can use a timer that cuts power to the starter motor after C1 seconds. C1 is a variable of time that may be set by the driver or device. It is generally between 0.1 seconds and 10 seconds. When the Actuator Board microprocessor (924c) receives the command, it directs its relay (927c) to shut-off power to the starter motor. The engine has been restarted with the transmission shift lever in the Drive position, and the device (934c), via the microprocessor (936c), or the vehicle transmission system selects the appropriate gear.

Once the engine restarts, the vehicle controller or transmission control unit will normally command the transmission to engage the appropriate gear. The device (934c) optionally monitors the status of the transmission after engine restart by requesting information over the computer port via the microprocessor (936c). In the event the vehicle systems fail to control the transmission system, the device (934c) orders the transmission to change to the appropriate gear. The device (934c), via the microprocessor (936c), can optionally send an RPM mimicry signal to the transmission control unit or other appropriate vehicle controller, to command the transmission engage at a lower than normal RPM rate in order to enable a smoother engine restart. The vehicle now has the engine on with the transmission in the appropriate gear.

Any numerical range recited herein is intended to include all sub-ranges subsumed therein. For example, a range of “1 to 10” is intended to include any and all sub-ranges between and including the recited minimum value of 1 and the recited maximum value of 10, that is, all sub ranges beginning with a minimum value equal to or greater than 1 and ending with a maximum value equal to or less than 10, and all sub ranges in between, e.g., 1 to 6.3, or 5.5 to 10, or 2.7 to 6.1.

While the invention has been shown and described with respect to the particular embodiments, it will be understood by those skilled in the art that various changes and modifications may be made without departing from the scope of the present invention as defined in the following claims.

1-50. (canceled)

51. A system for controlling motor vehicle components comprising:
a device/communicator operably connected to the vehicle's computer port that gathers information from a motor vehicle data bus and that runs a computer program to determine when the conditions are such that issuing a command is permitted, the type of command to be issued, and how the command should be executed;
an actuator board connected directly to vehicle circuitry replacing the vehicle's fuse(s) and acting in their place;
where the actuator board sends and receives signals and turns power on and off to the vehicle circuitry;
the actuator board contains electrical components that create an appropriate resistance or impedance load to mimic the presence of a relay coil or other circuit;
wherein the communicator receives the command from the logic device and transmits the commands to the actuator board to:
perform all functions of the fuse(s) it replaces, and directly send power or signals to vehicle components by closing and opening a circuit on the actuator board, and sending electronic signals and/or impedance loads to vehicle control circuits to mimic necessary control signals to circumvent normal vehicle operation.

52. The system for controlling motor vehicle components as claimed in claim 51 further comprising control of the vehicle engine restart and shutoff.

53. The system for controlling motor vehicle components as claimed in claim 51 wherein the system controls the gear settings of an automatic transmission.

54. The system for controlling motor vehicle components as claimed in claim 51 wherein the system controls the fuel delivery to the engine.

55. The system for controlling motor vehicle components as claimed in claim 51 wherein the device/communicator package is connected directly to vehicle circuitry.

56. The system for controlling motor vehicle components as claimed in claim 51 wherein the device/communicator package draws power for its electronics directly from the vehicle circuitry or computer port that it is connected to without compromising the operation of those circuits.

57. The system for controlling motor vehicle components as claimed in claim 51 wherein after a command has been issued, the device/communicator package can wait for an update from the vehicle or system components and use this information to issue follow on commands to the actuator board.

58. The system for controlling motor vehicle components as claimed in claim 51 wherein the actuator board further processes information received from the communicator before executing a command from the logic device.

59. The system for controlling motor vehicle components as claimed in claim 51 wherein the actuator board draws power for its electronics directly from the vehicle circuitry that it is connected to without compromising the operation of those circuits.

60. The system for controlling motor vehicle components as claimed in claim 51 wherein the communicator communicates with other aftermarket systems that may not report data over the vehicle computer port.

61. The system for controlling motor vehicle components as claimed in claim 51 wherein the communicator engages in one-way or two-way communication with a hardware switch controlled by the driver.

62. The system for controlling motor vehicle components as claimed in claim 51 wherein the communicator controls other auxiliary components such as the transmission pressure accumulator for an automatic transmission vehicle or the automated clutch for a manual transmission vehicle.

63. The system for controlling motor vehicle components as claimed in claim 51 wherein the communicator receives data from an external network that can be used to alert the driver or to serve as the basis for the device to issue commands.

64. A system for controlling motor vehicle components comprising:
a device/communicator package operably connected to the vehicle's computer port that gathers information from a motor vehicle data bus that runs a computer program to determine when the conditions are such that issuing a command is permitted, the type of command to be issued, and how the command should be executed;
an actuator board connected directly to vehicle circuitry replacing the vehicle's relay(s) and acting in their place, where the actuator board contains electrical components such as relays, fuses, and transistors that are used to send and receive signals and turn power on and off to the vehicle circuitry;
where the actuator board contains electrical components comprising resistors and amplifiers that create the appropriate dummy resistance or impedance load to mimic the presence of a relay coil or other circuit;
wherein the communicator receives the command from the logic device and transmits the commands to the actuator board to perform all functions of the relay(s) it replaces, directly sends power or signals to vehicle components by closing and opening a circuit on the actuator board, and sends electronic signals and/or impedance loads to vehicle control circuits to mimic necessary control signals to circumvent normal vehicle operation.

65. The system for controlling motor vehicle components as claimed in claim 64 further comprising control signals to shut off the vehicle engine or control the vehicle engine restart.

66. The system for controlling motor vehicle components as claimed in claim 64 further comprising the system which controls the gear settings of an automatic transmission.

67. The system for controlling motor vehicle components as claimed in claim 64 further comprising the device/communicator package which draws power for its electronics directly from the vehicle circuitry or computer port to which it is connected.

68. The system for controlling motor vehicle components as claimed in claim 64 wherein after a command has been issued, the device/communicator package waits for an update from the vehicle or system components and uses this information to issue/follow on commands to the actuator board.

69. The system for controlling motor vehicle components as claimed in claim 64 wherein the actuator board further processes information received from the communicator before executing a command from the logic device.

70. The system for controlling motor vehicle components as claimed in claim 64 wherein the actuator board draws power for its electronics directly from the vehicle circuitry that it is connected to without compromising the operation of those circuits.
